(19) United States
(12) Patent Application Publication
(10) Pub. No.: US 2026/0270530 A1
(43) Pub. Date: Sep. 10, 2026

(54) USER INTERFACES FOR GENERATING COLLECTIONS OF MEDIA CONTENT

(71) Applicant: Apple Inc., Cupertino, CA (US)

(72) Inventor: Andrew J. LEUNG, Los Angeles, CA (US)

(21) Appl. No.: 19/629,398

(22) Filed: Mar. 26, 2026

Related U.S. Application Data
(63) Continuation of application No. PCT/US2025/032798, filed on Jun. 7, 2025.
(60) Provisional application No. 63/657,908, filed on Jun. 9, 2024.
(60) Provisional application No. 63/699,624, filed on Sep. 26, 2024.
(60) Provisional application No. 63/819,279, filed on Jun. 6, 2025.

(51) Int. Cl. H04N 21/81; H04N 21/472

(52) U.S. Cl. CPC H04N 21/8113; H04N 21/47217

(57) ABSTRACT

In some embodiments, an electronic device presents a transition effect between media content in accordance with some embodiments of the disclosure. In some embodiments, an electronic device displays search user interfaces for media content according to some embodiments. In some embodiments, an electronic device displays a selectable option that is selectable to generate collections of content items according to some embodiments. In some embodiments, an electronic device generates collections of content items using machine learning and/or artificial intelligence.

### CROSS REFERENCE TO RELATED APPLICATIONS

This application is a continuation of International Application No. PCT/US2025/032798, filed Jun. 7, 2025, which claims the benefit of U.S. Provisional Application No. 63/819,279, filed Jun. 6, 2025, U.S. Provisional Application No. 63/699,624, filed Sep. 26, 2024, and U.S. Provisional Application No. 63/657,908, filed Jun. 9, 2024, the contents of which are herein incorporated by reference in their entireties for all purposes.

### FIELD OF THE DISCLOSURE

This disclosure relates generally to an electronic device presenting user interfaces for media player applications.

### BACKGROUND OF THE DISCLOSURE

User interaction with electronic devices has increased significantly in recent years. These devices can be devices such as computers, tablet computers, televisions, multimedia devices, or mobile devices. In some circumstances, users may wish to display a user interface for a media player application. The user may therefore desire efficient ways of interacting with the media player application.

### SUMMARY OF THE DISCLOSURE

Providing efficient ways of displaying views of a user interface for a media player application enhances user interactions with the electronic device by reducing the time and inputs needed to view information represented by the user interface. Providing efficient ways of transitioning between media content items enhances user interactions by reducing the time and inputs needed to select and transition between the media content items. Providing efficient ways of representing search user interfaces for identifying media content and generating collections of media content user enhances interactions with the electronic device by reducing time and inputs needed to search for and identify such media content. Providing efficient ways of generating collections of content items and browsing collections of content items enhances user interactions with the electronic device by reducing time and inputs needed to discover new content.

The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6CC illustrate exemplary ways in which an electronic device presents a transition effect between media content in accordance with some embodiments.

FIG. 7 illustrates a flow diagram illustrating a method in which an electronic device presents a transition effect between media content in accordance with some embodiments.

FIGS. 8A-8R illustrate exemplary ways in which an electronic device displays search user interfaces for media content in accordance with some embodiments.

FIG. 9 illustrates a flow diagram illustrating a method in which an electronic device displays search user interfaces for media content in accordance with some embodiments.

FIGS. 10A-10M illustrate exemplary ways in which an electronic device generates collections of content items and presents representations of generated collections of content items in accordance with some embodiments.

FIG. 11 illustrates a flow diagram illustrating a method in which an electronic device generates collections of content items and presents representations of generated collections of content items in accordance with some embodiments.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used, and structural changes are optionally made without departing from the scope of the disclosed embodiments.

Providing efficient ways of displaying views of a user interface for a media player application enhances user interactions with the electronic device by reducing the time and inputs needed to view information represented by the user interface. Providing efficient ways of transitioning between media content items enhances user interactions by reducing the time and inputs needed to select and transition between the media content items. Providing efficient ways of representing search user interfaces for identifying media content and generating collections of media content user enhances interactions with the electronic device by reducing time and inputs needed to search for and identify such media content.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch. Providing efficient ways of generating collections of content items and browsing collections of content items enhances user interactions with the electronic device by reducing time and inputs needed to discover new content.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### EXEMPLARY DEVICES

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

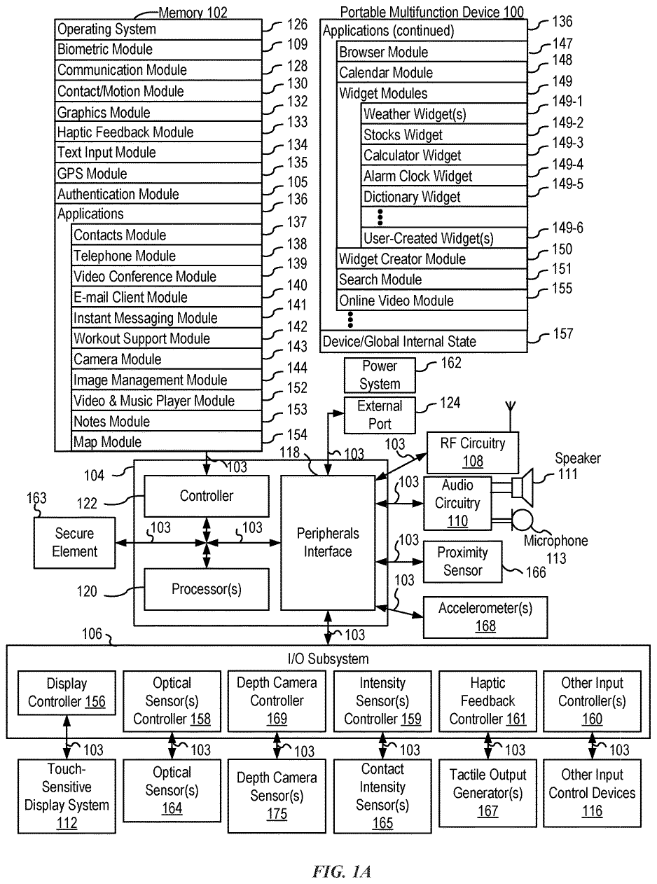

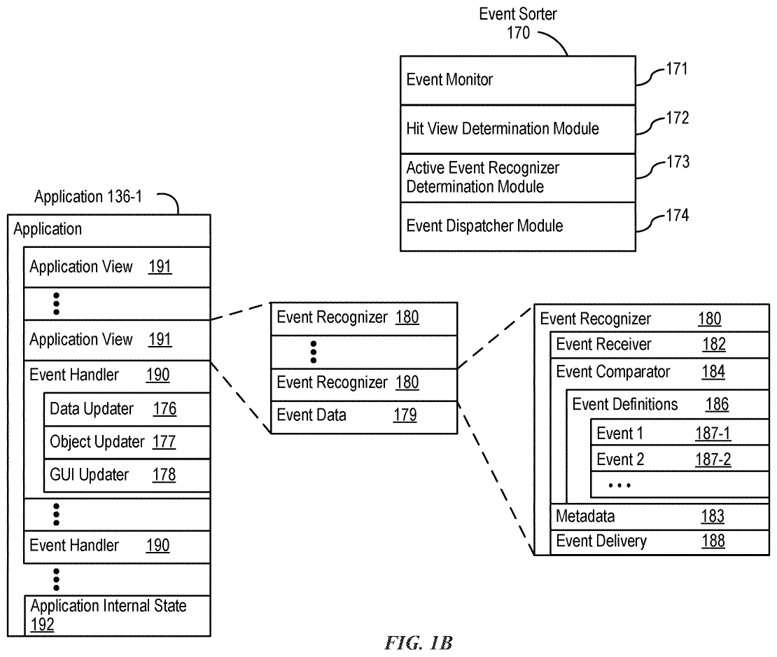

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to one or more processing units 120 and memory 102. The one or more processing units (e.g., processor(s)) 120 run or execute various software programs and/or sets of instructions stored in memory 102 to perform various functions for device 100 and to process data.

In some embodiments, peripherals interface 118, one or more processing units 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

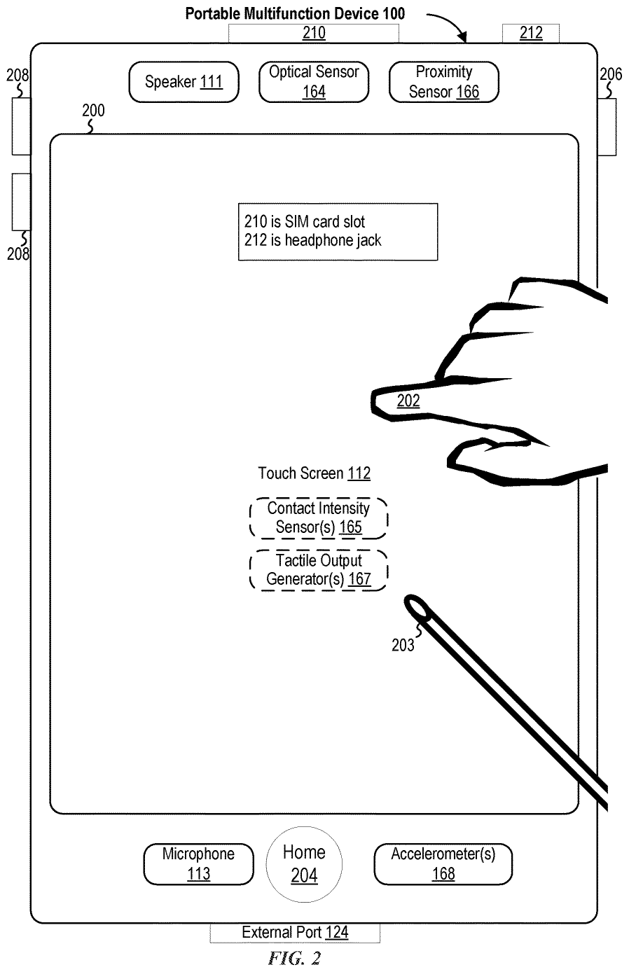

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. Nos. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/48,264, “Gestures For Touch Sensitive Input Devices,” filed Jan. 31, 2005; (5) U.S. patent application Ser. No. 11/38,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. Nos. 11/241,839, “Proximity Detector In Handheld Device”; 11/240,788, “Proximity Detector In Handheld Device”; 11/620,702, “Using Ambient Light Sensor To Augment Proximity Sensor Output”; 11/586,862, “Automated Response To And Sensing Of User Activity In Portable Devices”; and 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

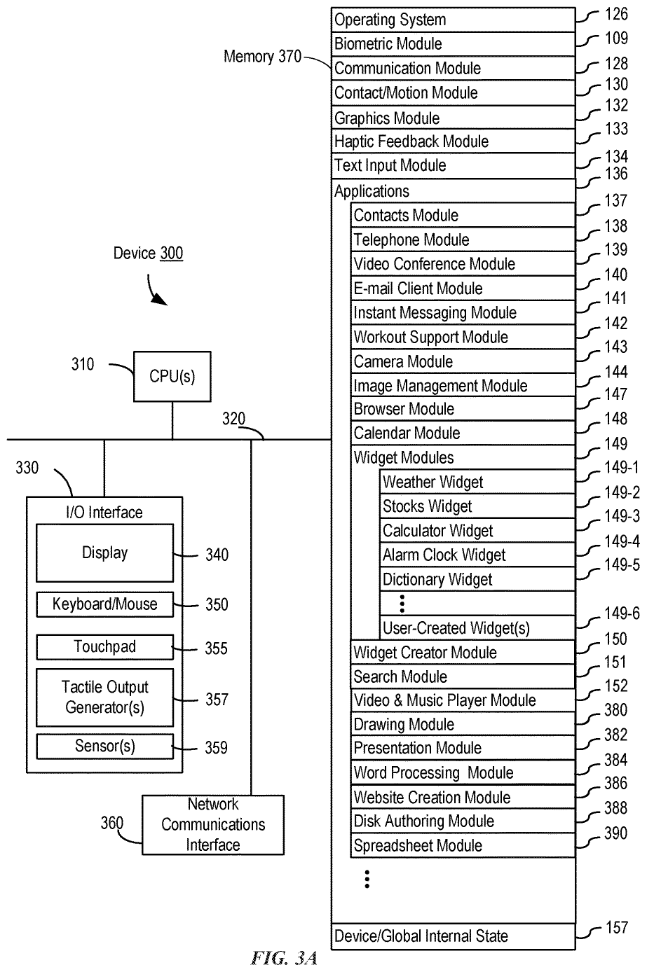

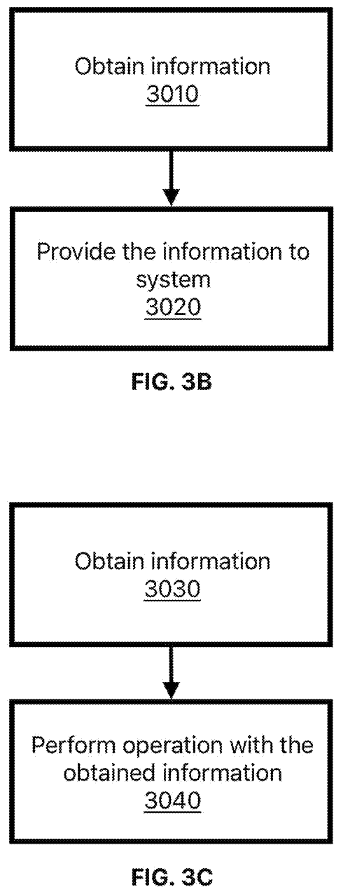

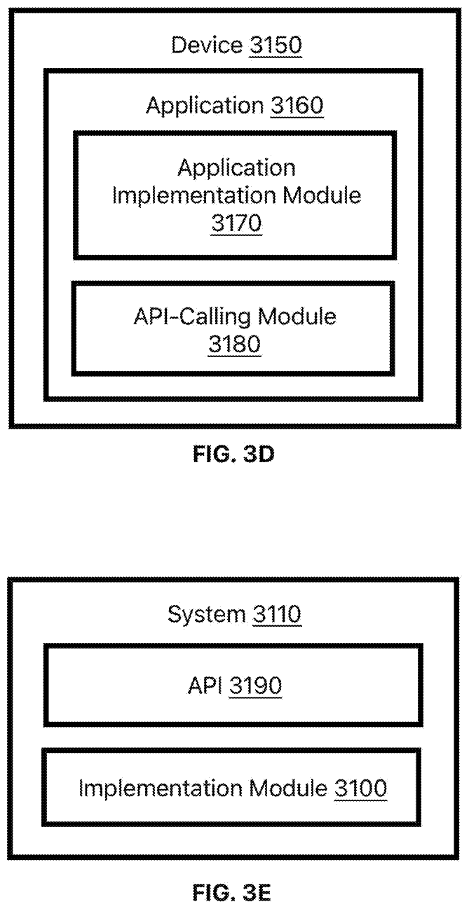

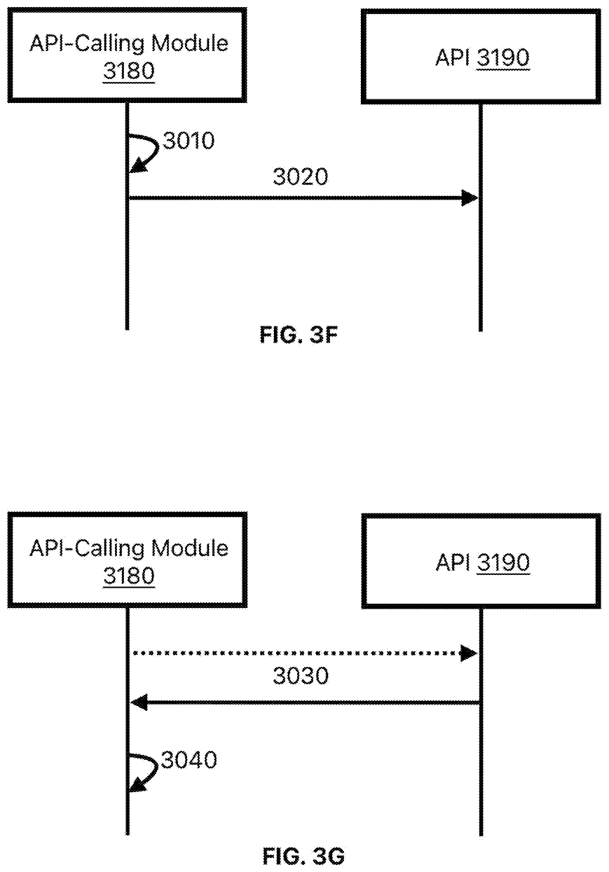

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM module 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,67, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from one or more processing units (CPU's) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

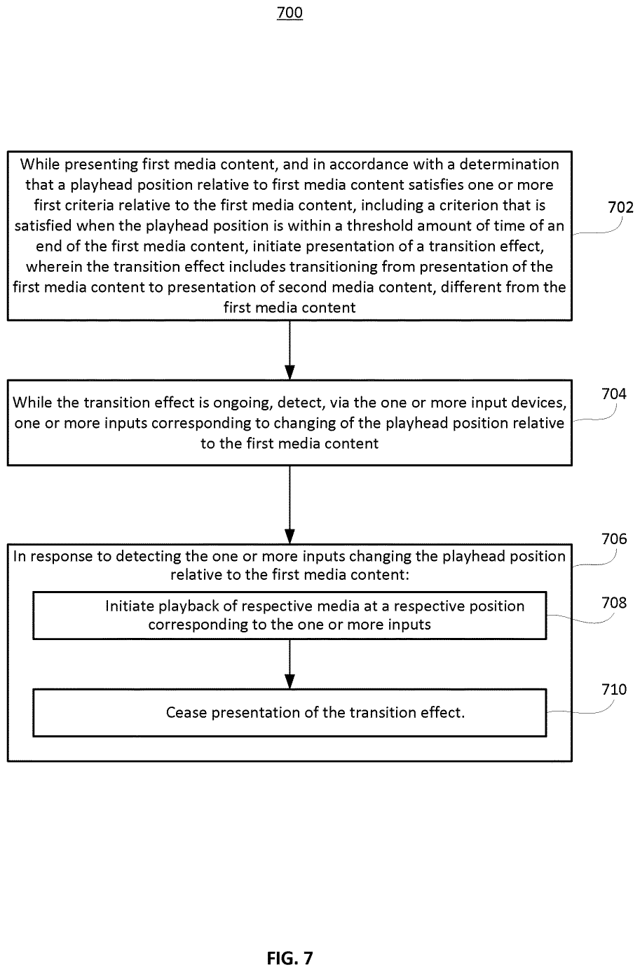

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) and/or method 900 (FIG. 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

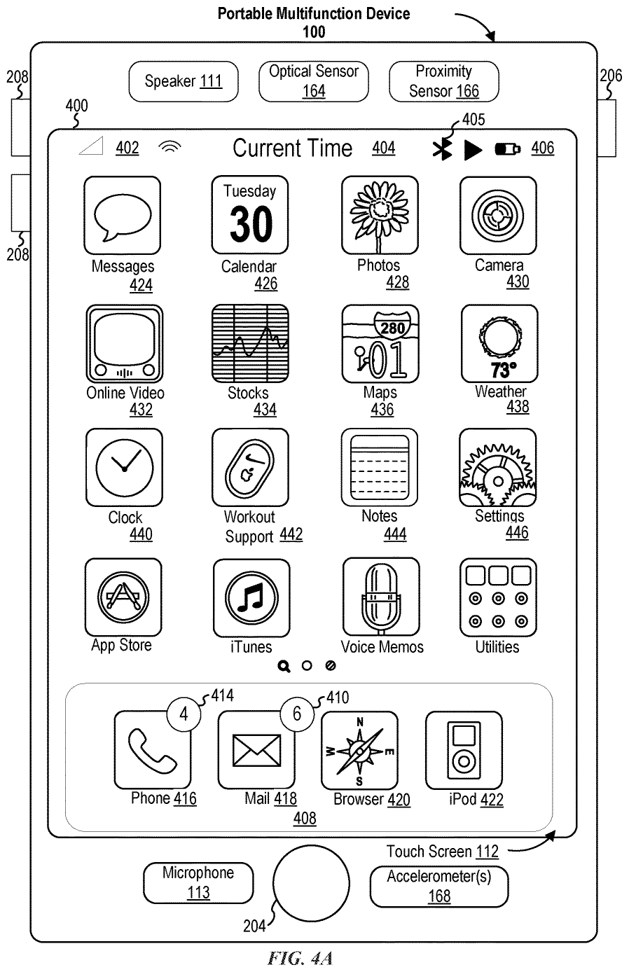

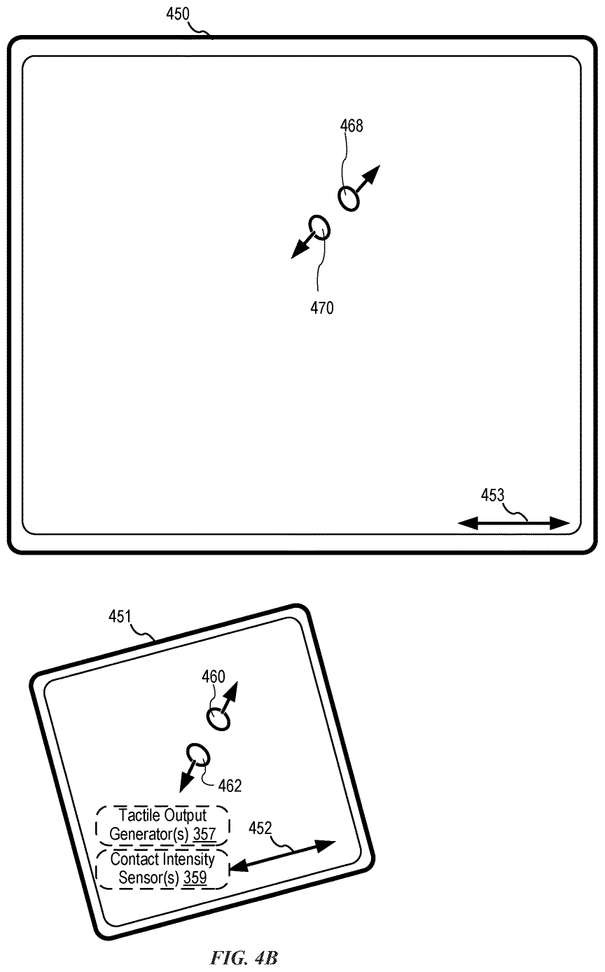

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIGS. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

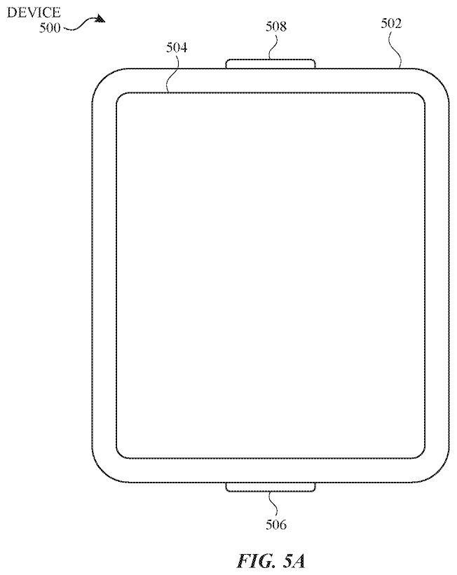

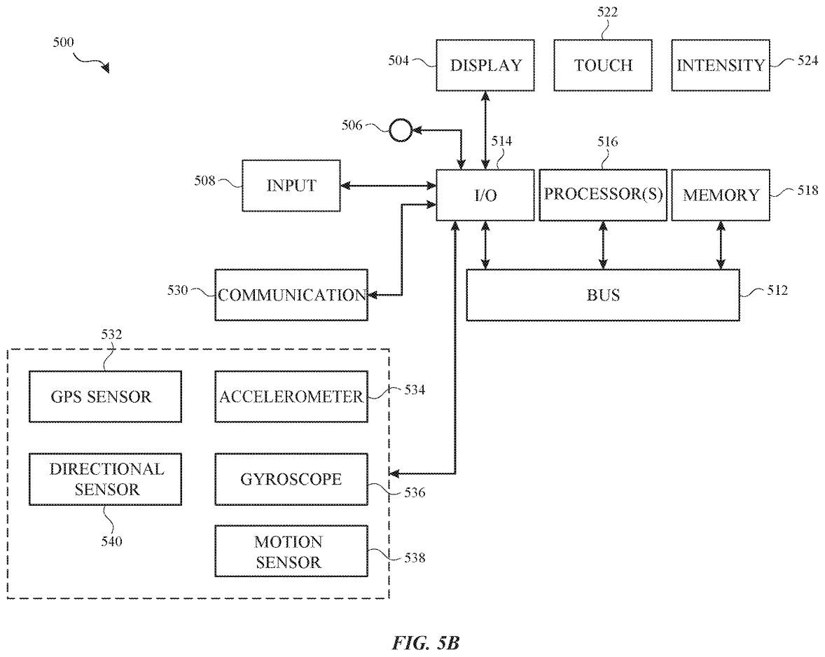

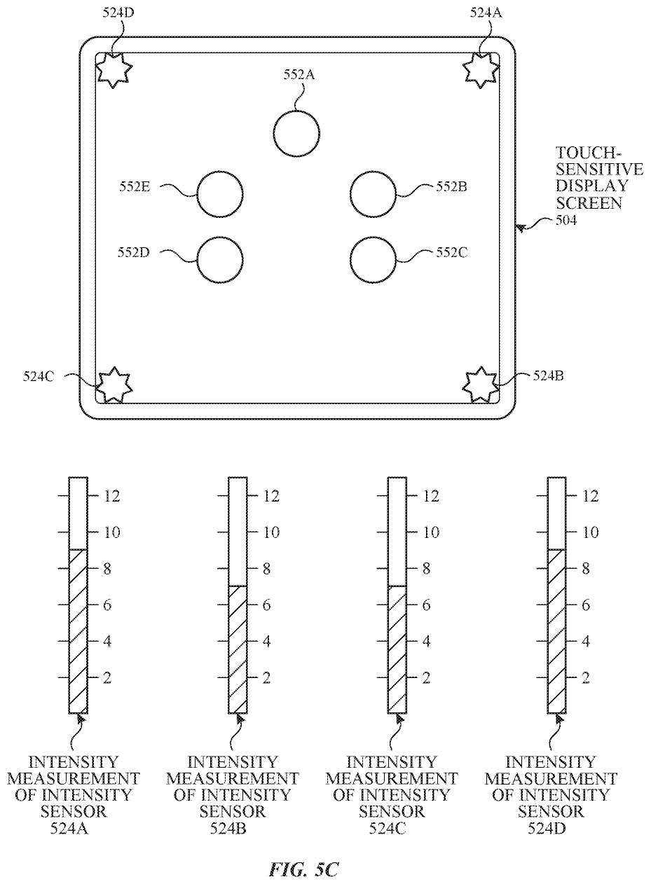

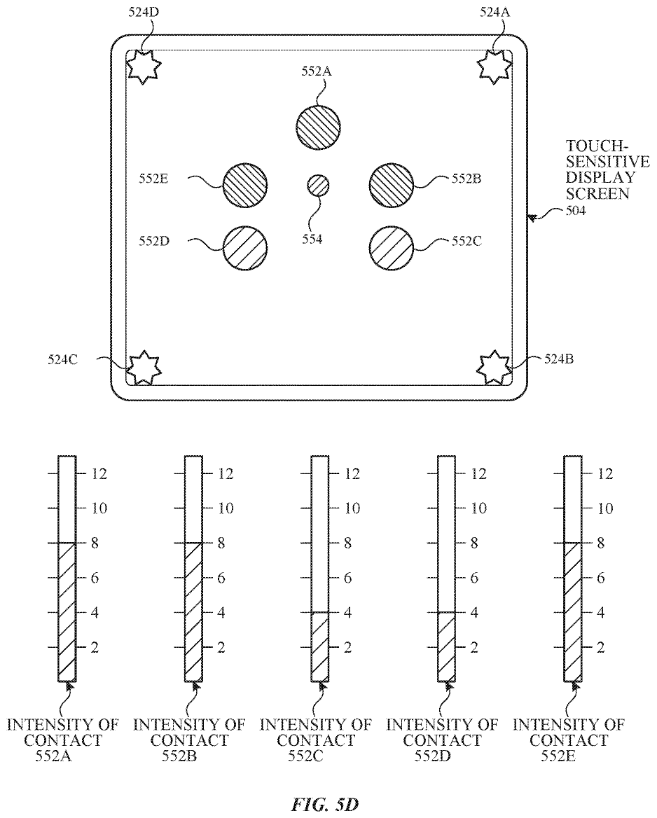

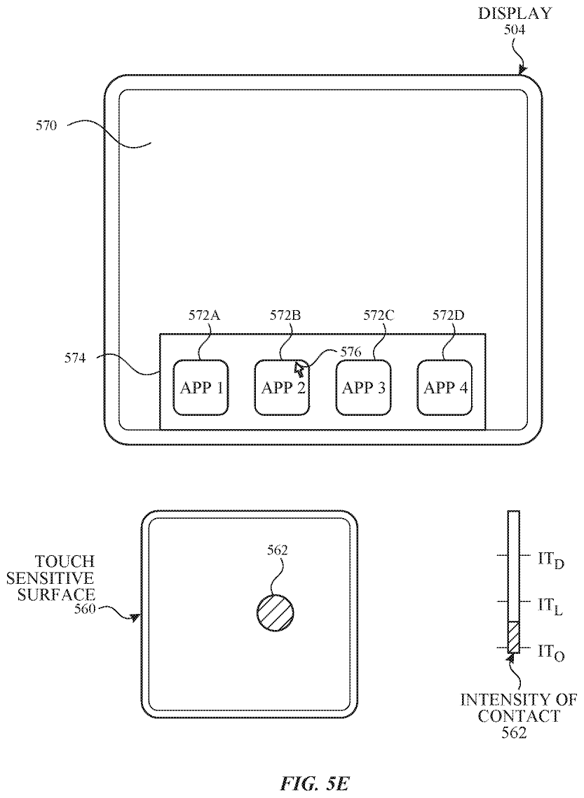

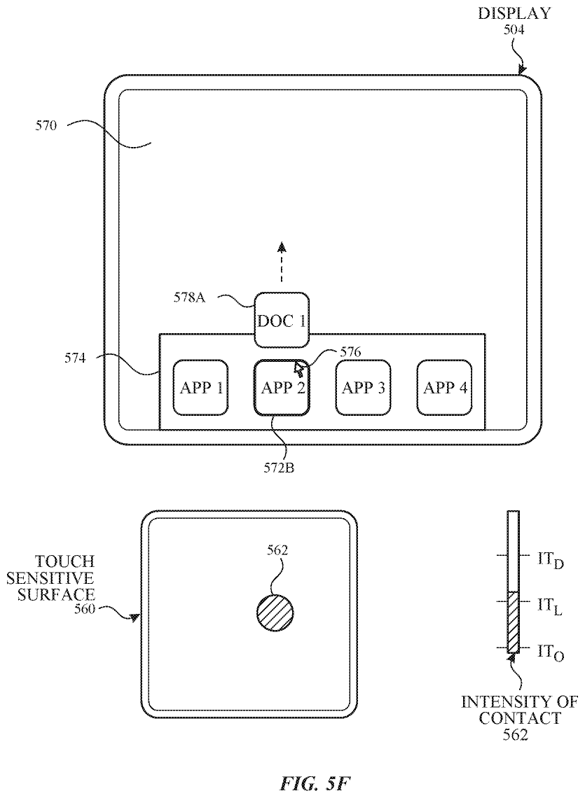

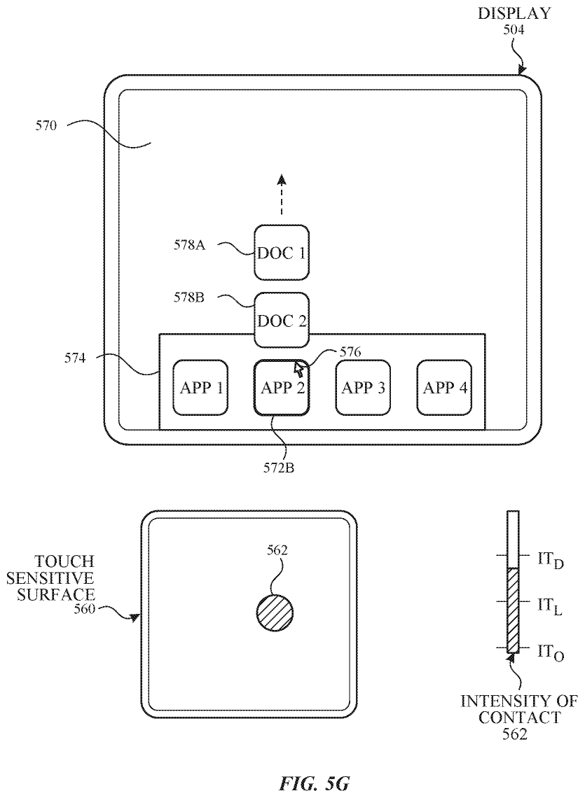

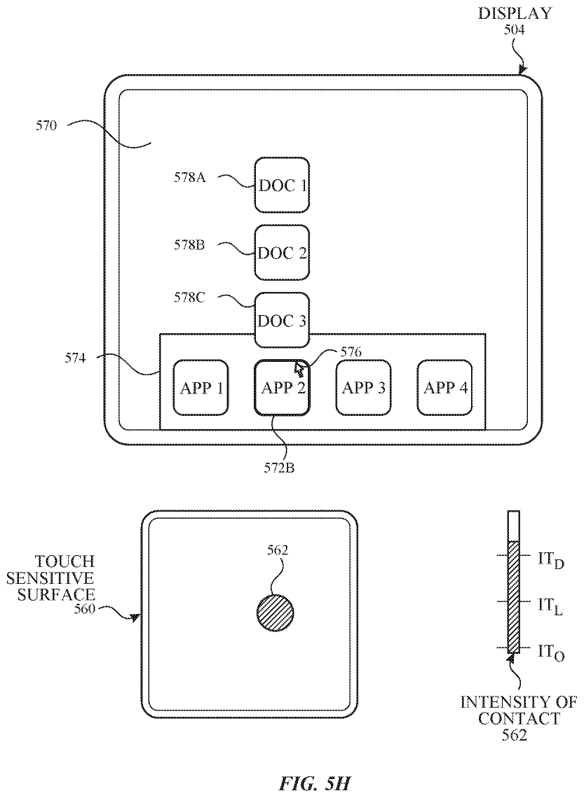

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 516 optionally execute any number of programs stored in memory 506 or storage, which optionally includes instructions to perform one or more of the methods and/or processes described herein (e.g., methods 700, 900, and/or 1100). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above application icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

Users interact with electronic devices in many different manners. In some embodiments, an electronic device is in communication with one or more input devices, a display generation component, and wireless circuitry. In some embodiments, the electronic device presents a user interface associated with a media player application. The embodiments described below provide ways in which an electronic device presents transition effects when playing media content. Presenting the transition effect reduces user input otherwise required to consume the media content and/or change characteristics of the media to cause the transition. It is understood that people use devices. When a person uses a device, that person is optionally referred to as a user of the device.

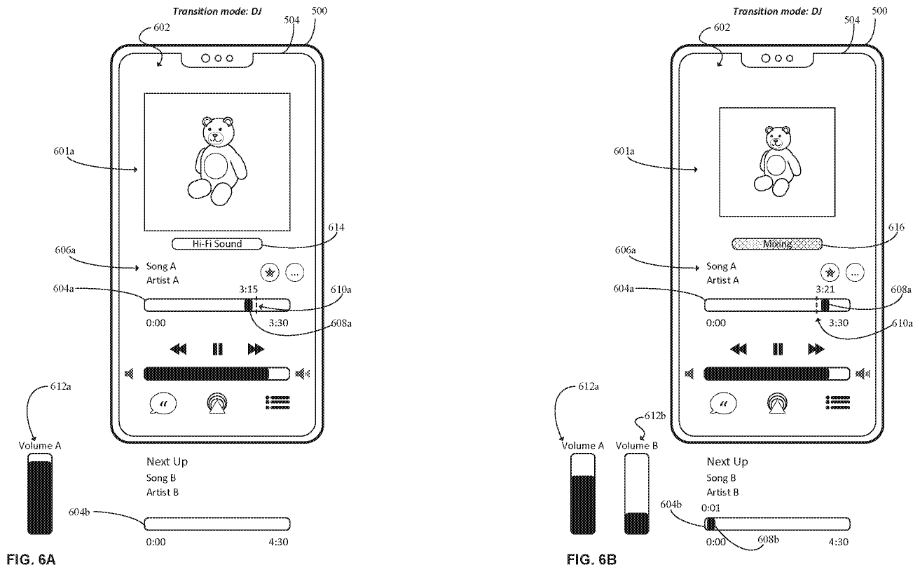

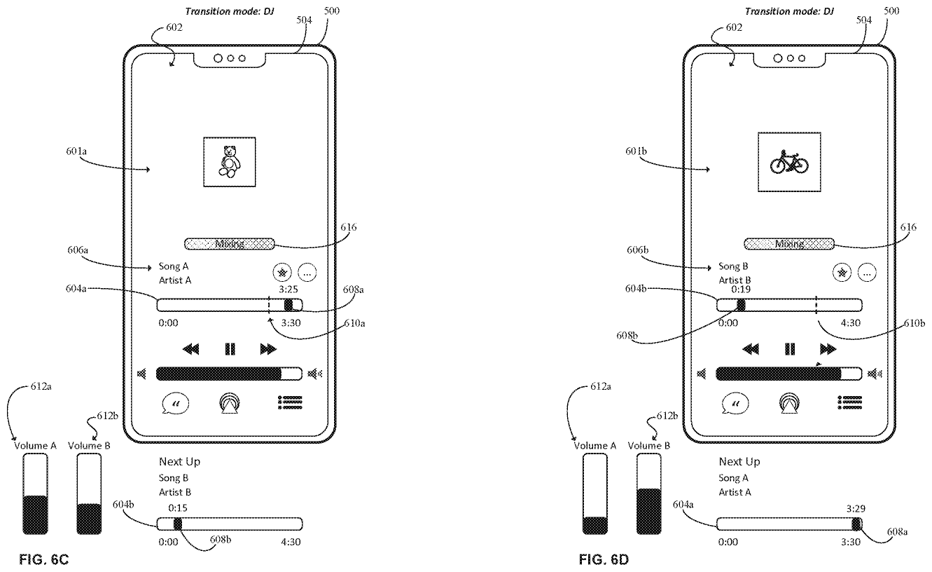

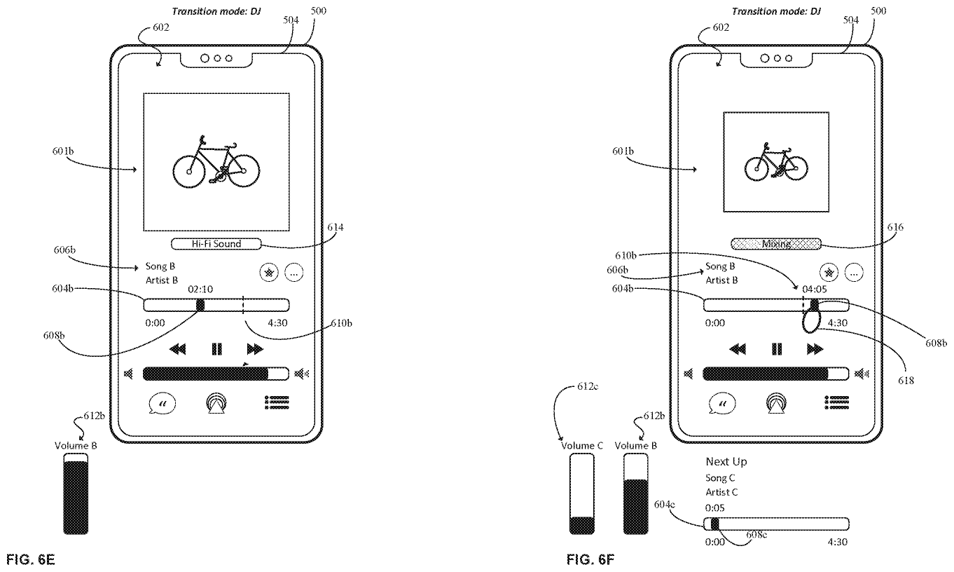

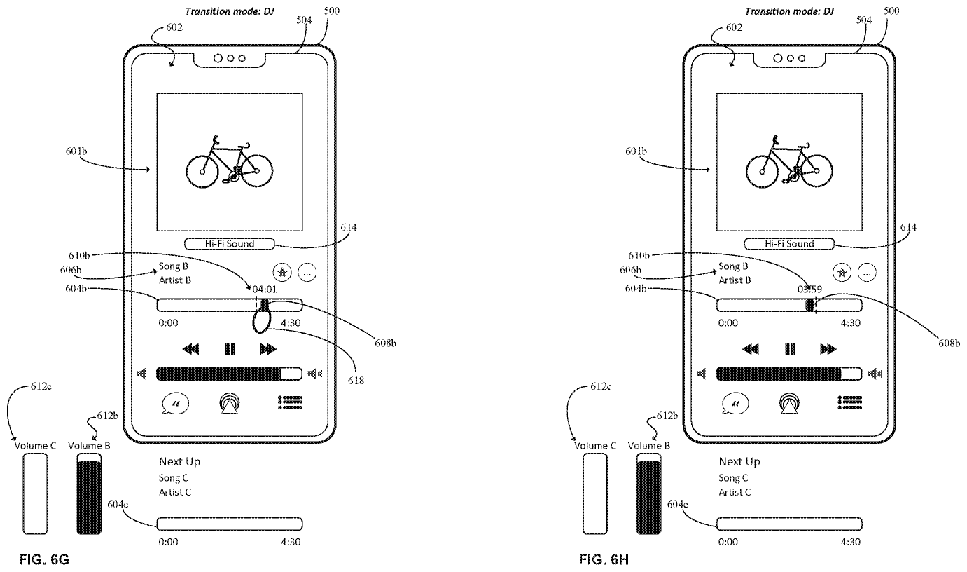

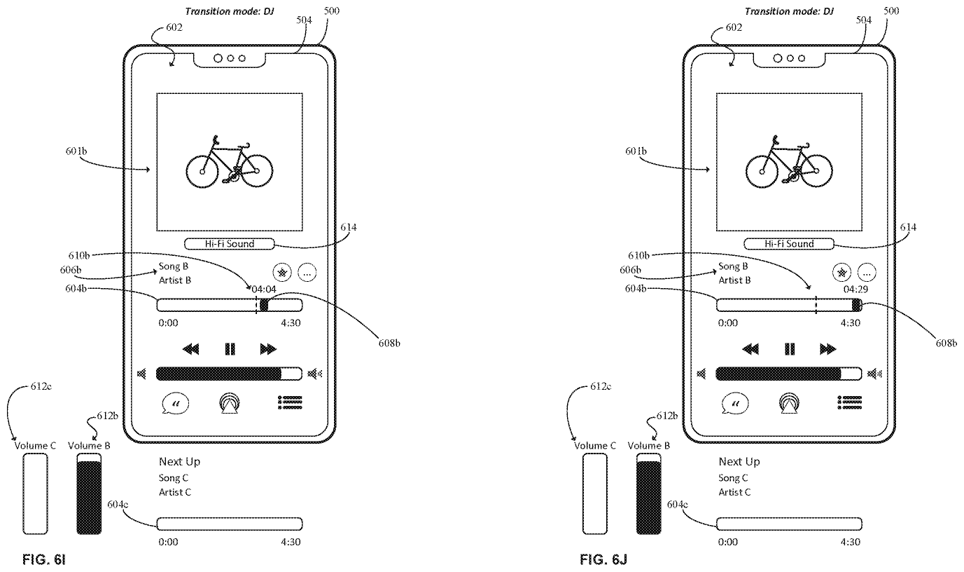

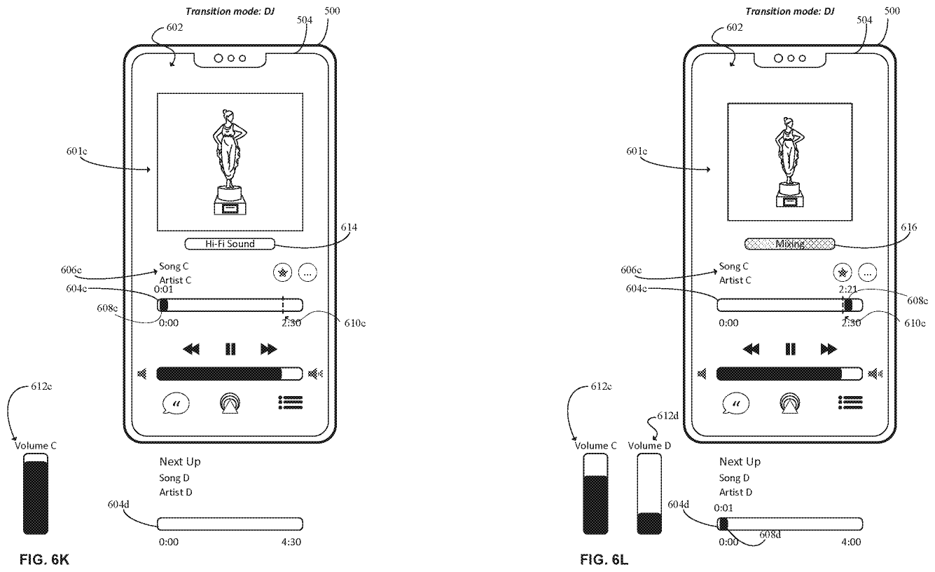

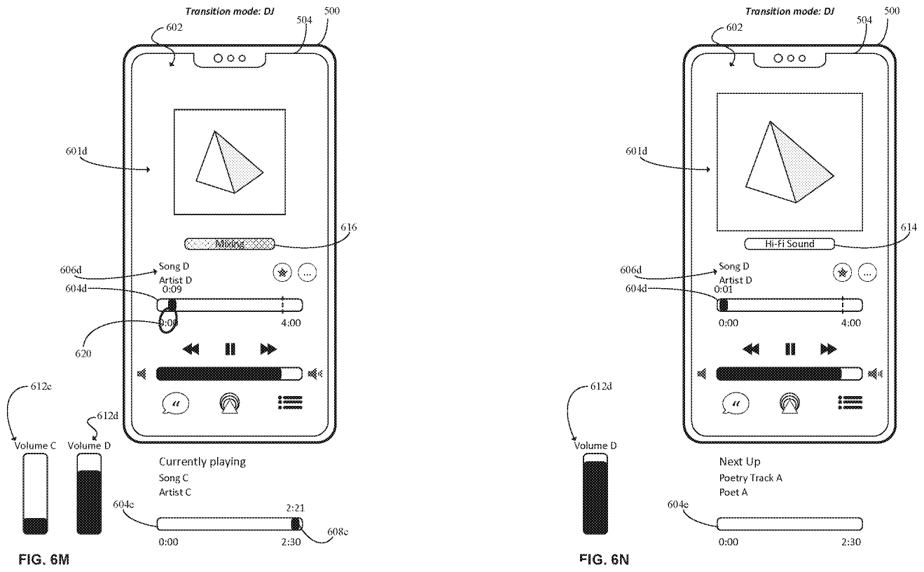

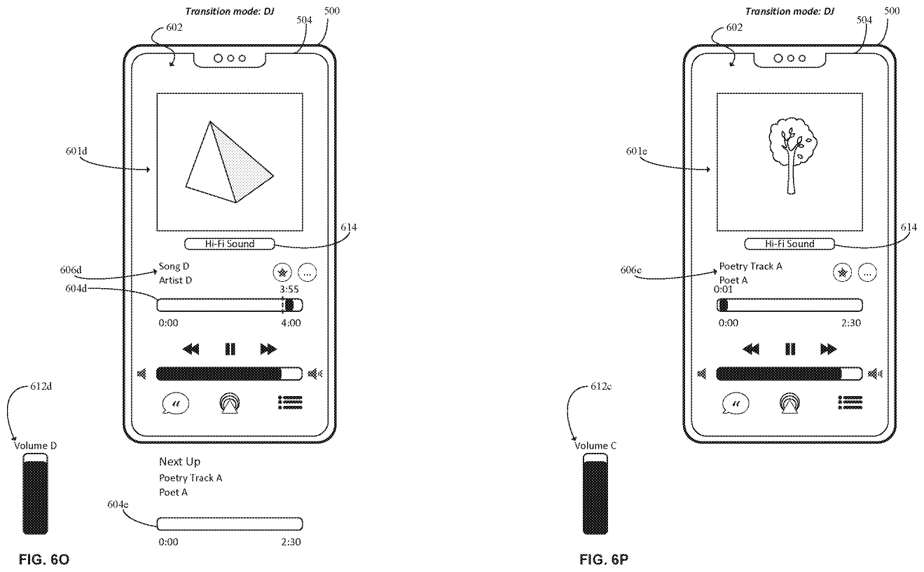

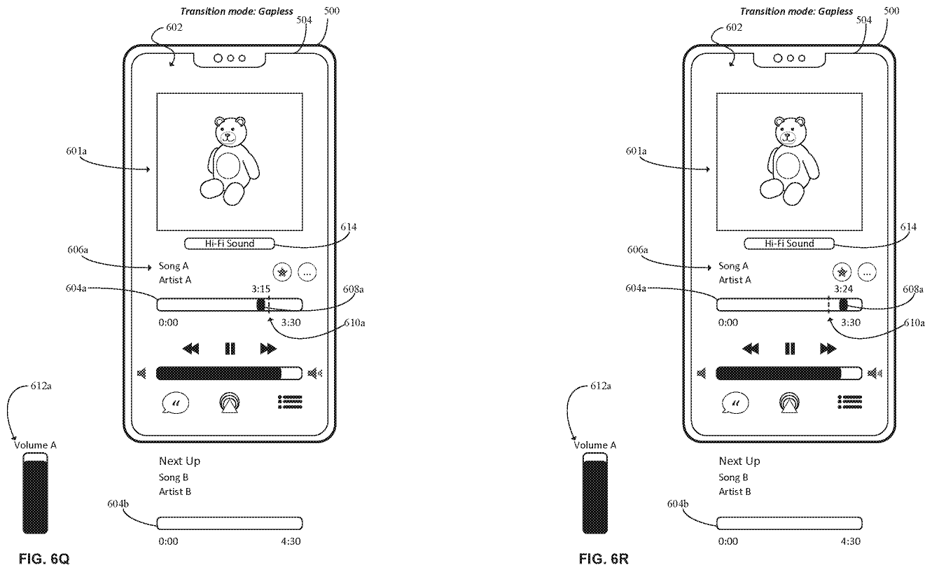

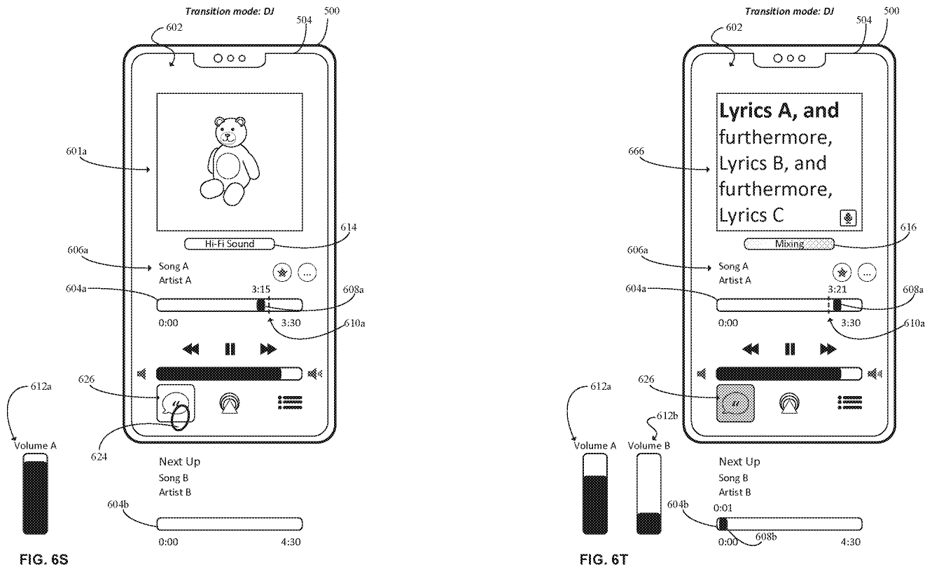

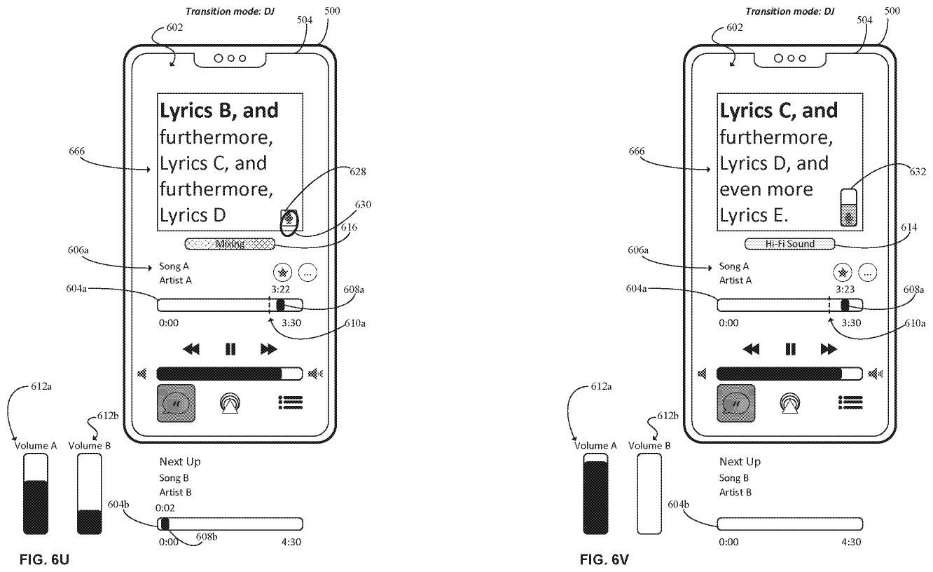

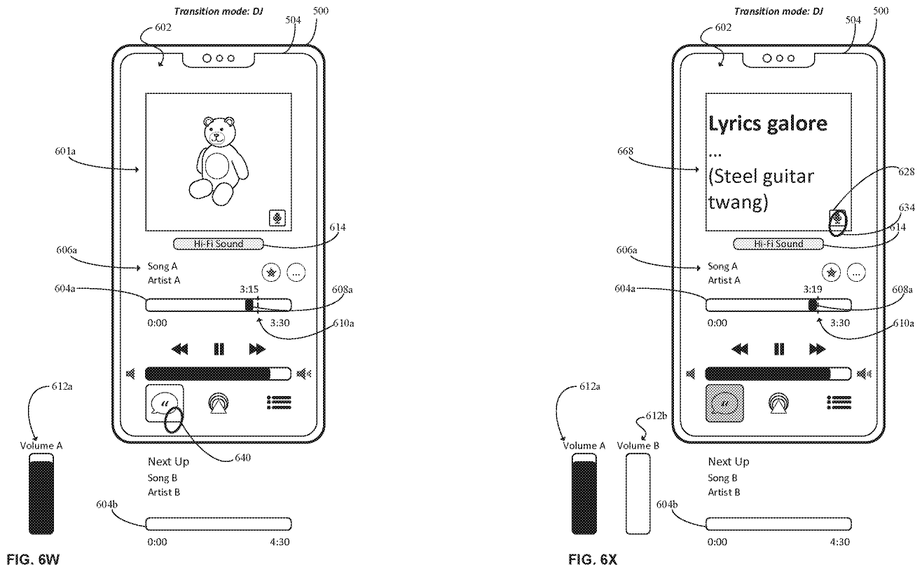

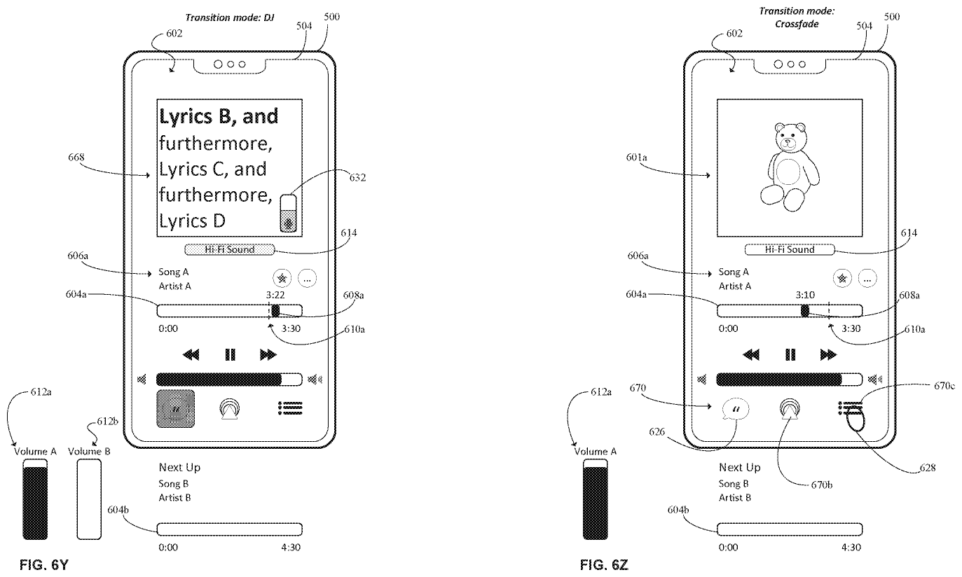

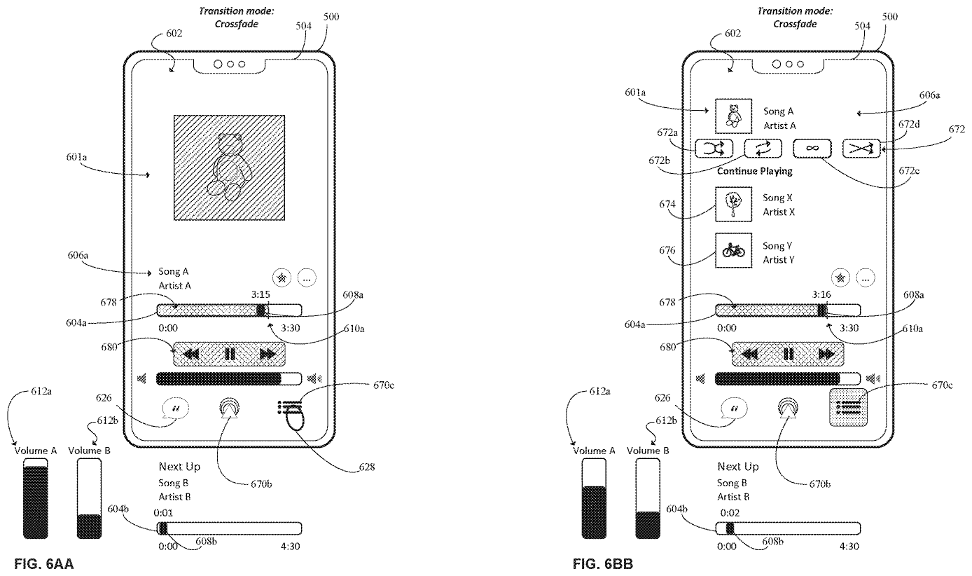

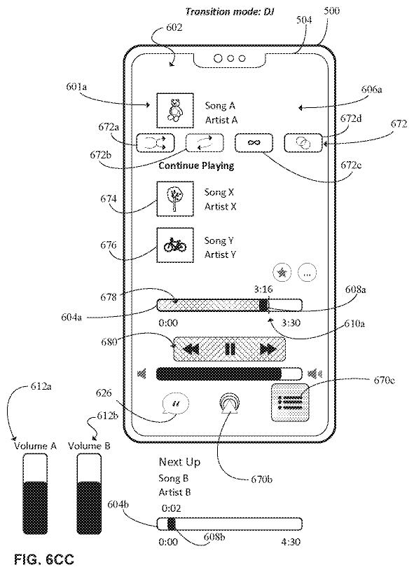

FIGS. 6A-6CC illustrate exemplary ways in which an electronic device presents a transition effect between media content. The embodiments in these figures are used to illustrate the processes described below, including the processes described with reference to FIG. 7 and/or FIG. 9. Although FIGS. 6A-6CC illustrate various examples of ways an electronic device is able to perform the processes described below with respect to FIGS. 7 and/or 9, it should be understood that these examples are not meant to be limiting, and the electronic device is able to perform one or more processes described below with reference to FIGS. 7 and/or 9 in ways not expressly described with reference to FIGS. 6A-6CC.

FIG. 6A illustrates embodiments of a user interface for a media player application. FIG. 6A illustrates an electronic device 500 that is in communication with a display generation component 504 (e.g., a touchscreen). In some embodiments, the electronic device 500 is a mobile device, such as a smartphone, tablet, or wearable device. In some embodiments, display generation component 504 is a touchscreen, a non-touch sensitive display, and/or a projected display in which images are cast into a physical environment of a user of the electronic device 500.

In FIG. 6A, electronic device 500 displays user interface 602, which optionally corresponds to a user interface for a media player application. For example, the media player application optionally facilitates playback and/or presentation of media, including audio, images, video, and/or playback controls to modify the playback of media content. In some embodiments, the media player application facilitates playback of audio such as songs, poetry, podcasts, and/or the like. In some embodiments, user interface 602 includes representations of content that is being presented (e.g., played back). It is understood that dependent upon the context, description of electronic device 500 presenting media content optionally includes playing back the media content, and vice-versa.

In some embodiments, electronic device 500 displays visual indications associated with currently presented media content. For example, in FIG. 6A, user interface 602 includes representation 601a, corresponding to a cover art and/or images associated with first content 606a. Additionally or alternatively, in FIG. 6A, user interface 602 includes a visual indication 614 indicating that the first content 606a is associated with a particular audio quality, such as a high fidelity audio track.

In FIG. 6A, electronic device 500 generates and/or causes generation of audio, playing back first content 606a, which optionally corresponds to a first song. In some embodiments, to indicate the playback progress of the first content 606a, electronic device 500 displays a scrubber bar such as scrubber bar 604a corresponding to first content 606a in FIG. 6A. As described with reference to method 700, a scrubber bar is optionally a visual element that indicates a position of playhead 608a (e.g., in FIG. 6A), and/or the start and/or the end time of currently presented content (e.g., “0:00” and “3:30” in FIG. 6A), thus indicating the progress of playback of first content 606a. In some embodiments, as playback of the first content 606a progresses, the electronic device 500 updates the position of the playhead 608a of scrubber bar 604a accordingly. In some embodiments, electronic device 500 presents content with one or more audio characteristics, such as a volume as indicated by glyph 612a in FIG. 6A that is a first volume. In some embodiments, glyph 612a is not displayed. In some embodiments, glyph 612a is representative of a degree of audibility of first content 606a, which includes volume and/or additional or alternative audio effects applied to the playback of first content 606a, as described with reference to method 700. It is understood that characteristic(s) of glyph 612a are optionally similar to or the same as additional or alternative glyphs described herein.

In some embodiments, electronic device 500 determines and/or obtains an indication of upcoming media content that will be next in a playback queue, such as corresponding to scrubber bar 604b (which in some embodiments is not shown during playback of the first content item, as in FIG. 6A). For example, as described further with reference to method 700, electronic device 500 optionally selects media that is similar to currently playing media content, such as based upon a theme, audibly similar, includes similar lyrical content, includes similar tempos, and/or the like. In some embodiments, the selected media is selected by electronic device without detecting an input expressly queuing the selected media, such as without detecting an input to add the selected media to the queue. Instead, the electronic device 500 optionally determines a musical similarity between currently presented content and prospective upcoming content, and/or optionally queues the automatically selected content without requiring any input (e.g., aside from initiating playback of media content in general). In some embodiments, electronic device 500 continues to play first content 606a, advancing playhead 608a toward a threshold 610a associated with a transition to the next media content in the playback queue.

In FIG. 6B, playhead 608a advances past threshold 610a as the playback of first content 606a continues. In some embodiments, when the playhead position 608a reaches threshold 610a, electronic device 500 initiates presentation of a transition effect, which includes changing of audio and/or visual media that is presented to a user of electronic device 500. For example, in FIG. 6B, electronic device 500 begins to scale the representation 601a downwards relative to user interface 602. Additionally or alternatively, in FIG. 6B, the volume of first content 606a decreases, indicated by the decrease in fill of glyph 612a. Concurrently, electronic device 500 initiates playback of second content correspond to scrubber bar 604b, as illustrated by playhead position 608b in FIG. 6B. Additionally or alternatively, electronic device 500 gradually increases the volume of the second content, as indicated by the fill pattern in glyph 612b. As described with reference to method 700, the gradual transitioning between playback of the first media content to the second media content is at times referred to herein as a “transition effect.” In FIG. 6B, electronic device 500 changes the visual indication 616 to indicate that electronic device 500 is “mixing” between the playback of the first content 606a and the second content, similar to a manner of mixing between musical tracks performed by a disk jockey (DJ). In FIG. 6B, despite the change in volume of first content 606a, the electronic device 500 maintains a volume slider 670 at a level that is the same as illustrated in FIG. 6A. The maintaining of the level of the volume slider 670 optionally conveys that the net volume of the first and/or the second media content are the same or similar as when first content 606a is played standalone (e.g., without applying the mixing effect), such as in FIG. 6A.

As described further with reference to method 700, the transition effect is optionally associated with a setting configuration (e.g., a first configuration corresponding to a “Transition mode: DJ” in FIG. 6B). In some embodiments, a DJ transition effect associated with a DJ transition configuration includes the cross-fading of volume between media content. Additionally or alternatively, the transition effect optionally includes dynamically determining a value of a threshold at which the transition effect is initiated, such as threshold 610a in FIG. 6B which is optionally based upon characteristics of the first and/or the second media content. In some embodiments, the transition effect is variable based upon musical characteristics, such as tempo, key change, pitches, downbeat patterns, lyrics, chords, and the like as described further with reference to method 700.

In FIG. 6C, electronic device 500 continues playback of first content 606a and/or continues to present the transition effect. For example, in FIG. 6C, electronic device 500 increases the volume of first content 606a and/or decreases the volume of the second content, as indicated in glyphs 612a and 612b respectively. Further, in FIG. 6C, playheads 608a and 608b continue to advance compared to their respective positions in FIG. 6B, with playhead 608a advancing further past threshold 610a.

In FIG. 6D, electronic device 500 continues playback of first content 606a and/or continues to present the transition effect. In FIG. 6D, playhead 608a passes a “pivot point,” a position relative to the first media content 606a at which the volume and/or audibility of second content 606b surpasses the volume and/or audibility of first content 606a. Additional or alternative embodiments related to the pivot point are described herein with reference to method 700, but it is understood that the pivot point is optionally variable in a manner similar to or the same as described with reference to the threshold 610a illustrated in FIGS. 6A-6C. For example, the pivot point is optionally a first or a second position relative to first content 606a in FIG. 6A in accordance with a determination that the second content 606b in FIG. 6D has one or more characteristics corresponding to respective first or respective second values (e.g., is a first or a second duration, is in a range of first or in a range of second volumes at the beginning of the second content, and/or the like).

In addition to changing audio during a transition effect, electronic device 500 changes the visible representation of respective media when passing the pivot point. For example, in FIG. 6D, electronic device 500 ceases display of the representation corresponding to the first content 606a shown in FIGS. 6A-6C, and initiates display of representation 601b corresponding to second content 606b, such as cover album art corresponding to an album of second content 606b. In FIG. 6D, because electronic device 500 initiates playback of second content 606b when the playhead associated with the first content reaches the transition effect threshold 610a in FIG. 6C, the relative difference in time between the threshold associated with the transition effect and the playhead 608a is same as the difference in time between the start time of second content 606b and the playhead 608b. In FIG. 6D, because second content 606b has different characteristic(s) from the first media content, threshold 610b corresponds to a different playback position than threshold 610a illustrated in FIG. 6A.

In FIG. 6E, the transition effect has concluded. For example, from FIG. 6D to FIG. 6E, electronic device 500 ceases presenting the first media content, continues to present second content 606b, and progressively increases the volume of second content 606b, indicated by glyph 612b in FIG. 6E. Additionally or alternatively, electronic device 500 restores display of the visual indication 614 (e.g., ceases display of visual indication 616 from FIG. 6D), indicating that the transition effect is no longer ongoing.

In FIG. 6F, playback of second 6 Kcontent 606b progresses past the threshold 610b. In FIG. 6F, electronic device 500 presents the transition effect from second content 606b to third media content, corresponding to the scrubber bar 604c. In FIG. 6F, playback of the third media content is ongoing, indicated by playhead 608c, and the transition effect has initiated, indicated by the relative decrease in the volume indicated by glyph 612b of the second content 606b, and the volume indicated by glyph 612c corresponding to the third media content. Additionally, electronic device 500 detects input 618 directed to playhead 608b, corresponding to a request to change the playhead position in FIG. 6F. In some embodiments, such an input expressly requesting a change in the playhead position is referred to as a scrubbing input. It is understood, however, that additional or alternative inputs are optionally also scrubbing inputs, such as an input directed to a portion of a scrubber bar requesting the playhead position be changed to the selected portion of the scrubber bar. Additional or alternative description and/or modalities of scrubbing input(s) are described with reference to method 700.

In FIG. 6G, electronic device 500 ceases presenting of the transition effect. For example, electronic device 500 ceases playback of the third media content as indicated by the empty scrubber bar 604c and/or the volume glyph 612c not including a fill in FIG. 6G. The electronic device optionally ceases presenting the transition effect in response to detecting the scrubbing input 618 in FIG. 6F, and/or in accordance with a determination that the input 618 in FIG. 6F is detected while the transition effect is ongoing. Due to the interruption of the transition effect caused by the scrubbing input, electronic device 500 displays the visual indication 614 and/or ceases display of visual indication 616, indicating that the transition effect ceased. Additionally or alternatively, similarly to as described above, the volume slider 670 included in user interface 602 is optionally maintained at a constant level between FIGS. 6F and 6G, thus indicating to the user that the net and/or overall content volume is maintained from FIG. 6F to FIG. 6G. In FIG. 6G, electronic device 500 detects the ongoing scrubbing input 618, and optionally detects further movement included in input 618, such as leftward relative to scrubber bar 604b.

In FIG. 6H, playhead 608b is positioned before threshold 610b. For example, in response to detecting the leftward movement of input 618 in FIG. 6G, electronic device 500 moves the playhead position in accordance with the input to a position (e.g., 3:59) prior to the position of threshold 610b (e.g., 4:00), as shown in FIG. 6H. In some embodiments, in response to detecting input such as scrubbing input while a transition effect is ongoing, electronic device 500 ceases presentation of the transition effect at least temporarily.

From FIG. 6H to FIG. 6I, electronic device 500 continues playback of the second content 606b, and forgoes presentation of the transition effect. For example, in FIG. 6I, electronic device 500 does not increase the volume and/or initiate playback of the third content, indicated by scrubber bar 604c not including a playhead and/or by the lack of fill overlaying glyph 612c. Thus, the transition effect is optionally not presented-despite the playhead 608b advancing past threshold 610b in accordance with playback of second content 606c-due to the temporary disabling of the transition effect. From FIG. 6I to FIG. 6J, playback again advances, indicated by the updated position of playhead 608b in FIG. 6J. In FIG. 6J, electronic device 500 continues to forgo presenting of the transition effect, for at least the reasons described above.

In FIG. 6K, electronic device 500 transitions from presenting the second media content to presenting third media content. For example, electronic device 500 in FIG. 6K initiates playback of third content 606c, and/or initiates display of representation 601c corresponding to a video associated with third content 606c. As described with reference to FIG. 6J, electronic device 500 does not present the transition effect, and instead optionally initiates playback of third content 606c in response to the playhead 608b reaching the end of second content 606b (e.g., between FIGS. 6J and 6K). In FIG. 6K, electronic device 500 presents the third content 606c with a volume indicated by glyph 612c that is a same volume as the previously-presented media content, and/or queues fourth media content corresponding to scrubber bar 604d.

In FIG. 6K and FIG. 6L, playhead 608c indicates the playback position of third content 606c. From FIG. 6K to FIG. 6L, playback of third content 606c advances past threshold 610c, and in response, electronic device 500 initiates presentation of the transition effect between third content 606c and fourth content 606d. In some embodiments, the electronic device 500 reenables the possibility of presenting the transition effect when electronic device 500 initiates playback of new media content other than the media content presented when a transition effect is interrupted. For example, electronic device 500 presents a transition effect including changing a scale of representation 601c from FIG. 6K to FIG. 6L after ceasing presenting the transition effect relative to the second content 606b in FIG. 6G. In FIG. 6L, electronic device 500 presents the transition effect, which optionally includes a decrease in the volume of third content 606c indicated by glyph 612c, initiation of playback of the fourth content corresponding to scrubber bar 604d as indicated by the movement of playhead 608d, and an increase of the volume of the fourth content as indicated by glyph 612d.

From FIG. 6L to FIG. 6M, electronic device 500 continues the transition effect. For example, a playhead corresponding to the scrubber bar 604d associated with fourth content 606d is displayed in FIG. 6M. Additionally, in FIG. 6M, volume indicated by glyph 612c of the third content 606c decreases relative to the corresponding level in FIG. 6L, and volume of the fourth content 606d indicated by glyph 612d increases relative to the corresponding level in FIG. 6L. In FIG. 6M, electronic device 500 detects input 620 requesting a change in position of the playhead. In response to detecting input 620, optionally including movement of input 620, electronic device 500 changes the playhead 608d in accordance with input 620 and/or ceases presentation of the transition effect, as shown in FIG. 6N.

In FIG. 6N, electronic device 500 queues media content that has characteristic(s) different from some or all of the above-described media content. For example, media content corresponding to scrubber bar 604e in FIG. 6N optionally corresponds to audio of poetry, ambient sounds, and/or audio that already includes particular transition effects (e.g., prerecorded DJ performances, and/or albums including similar transitions), which optionally is different from the musical audio illustrated with respect to FIGS. 6A-6M. In some embodiments, the electronic device 500 queues the media content with the different characteristics automatically, based on an algorithm or because the media content is included in a list of content item (e.g., a playlist) the electronic device 500 is playing. In some embodiments, the electronic device 500 queues the media content with the different characteristics in response to detecting a user input, such as an input requesting to add the media content to the playback queue. From FIG. 6N to FIG. 6O, electronic device 500 advances playback of the fourth content 606d, and because the queued media content does not satisfy one or more criteria, such as a criterion that is satisfied when the queued media content includes musical audio and/or does not include transition effect, the electronic device forgoes presentation of a transition effect in FIG. 6O.

In FIG. 6P, electronic device 500 presents the queued media content, corresponding to fifth content 606e that includes spoken word poetry. From FIG. 6O to FIG. 6P, electronic device 500 maintains display of visual indication 614 without displaying an indication that a transition effect is performed. Additionally, electronic device 500 displays the representation 601e corresponding to fifth content 606e without display a visual transition between representations of content. For example, in one or more of the transition effects described above, electronic device 500 optionally displays an animation (e.g., described further with reference to method 700), which is optionally not displayed (e.g., is forgone) when the playhead 608d reaches a transitionary threshold associated with fourth content 606d in FIG. 6O.

FIG. 6Q illustrates an embodiment in which electronic device 500 presents first content 606a, and the setting associated with the transition effects is a “gapless” configuration. In some embodiments, FIG. 6Q is similar to or the same as the above-described figures, such as FIG. 6A. From FIG. 6Q to FIG. 6R, electronic device 500 advances playback of first content 606a. Because the transition effect setting corresponds to the gapless configuration, electronic device 500 forgoes presentation of the transition effect from FIG. 6Q to FIG. 6R. Thus, because the setting corresponds to a different configuration, electronic device 500 changes how it presents transitions between media content (e.g., does not present the transition effect, and/or presents the transition effect differently from the DJ mode, as described with reference to method 700).

FIG. 6S illustrates an embodiment similar to or the same as described with reference to FIGS. 6A and/or 6Q. In FIG. 6S, the transition effect setting corresponds to the DJ transition effect, and electronic device 500 detects an input 624 directed to selectable option 626. In some embodiments, selectable option 626 is an icon, button, or virtual badge that, when selected, causes the electronic device 500 to initiate display of time-synchronized lyrics (e.g., representations of lyrics) associated with currently-presented content. For example, in response to detecting input 624 in FIG. 6S, electronic device 500 displays first lyrics 666 as shown in FIG. 6T and/or changes a visual appearance of selectable option 626 to indicate that the lyrics are enabled. Lyrics 666 optionally correspond to the lyrical content that is being presented and/or recently was presented during playback of first content 606a.

In FIG. 6T, electronic device 500 performs the transition effect while displaying lyrics 666 corresponding to first content 606a. In FIG. 6T, playhead 608a has advanced past threshold 610a, thus triggering the transition effect. For example, electronic device 500 changes the volume of first content 606a in FIG. 6T relative to the volume in FIG. 6S as indicated by glyph 612a, electronic device 500 initiates playback of second content as indicated by scrubber bar 604b and/or playhead 608b, and/or performs cross fading, increasing the volume of the second content as indicated by glyph 612b.

In FIG. 6U, playback of first and second media content continue in accordance with a transition effect while lyrics corresponding to the first media content are displayed. For example, from FIG. 6T to FIG. 6U, electronic device 500 continues playback of first content 606a. Thus, in some embodiments, the electronic device 500 presents the mixing transition effect while presenting content with time-synchronized lyrics if a sing-along mode, described in more detail below and with reference to method 700, is not active. Additionally or alternatively, electronic device 500 maintains display of lyrics 666, without changing a scale of lyrics 666, without displaying an animation visually transitioning to lyrics corresponding to the second media content, and/or without displaying the lyrics corresponding to the second media content. As indicated by glyphs 612a and/or 612b, from FIG. 6T to FIG. 6U, electronic device 500 continues to transition between the media content items, initiating playback of the second media content while displaying lyrics corresponding to the first content 606a. Additionally or alternatively, the transition effect is indicated by the display of visual indication 616 in FIG. 6U. In FIG. 6V, electronic device 500 detects input 630 directed to selectable option 628. In some embodiments, selectable option 628, when selected, causes the electronic device 500 to initiate a sing-along mode of presenting media content. In some embodiments, when the sing-along mode is enabled, electronic device 500 suppresses a vocal component and/or track included in media content (e.g., attenuates and/or completely silences the vocal component).

From FIG. 6U to FIG. 6V, electronic device 500 enables the sing-along mode, indicated by the volume indicator 632. For example, in response to detecting input 630 in FIG. 6V, electronic device 500 displays volume indicator 632 in FIG. 6V, and/or optionally ceases presenting of the transition effect (e.g., indicated by the lack of fill in glyph 612b and/or the lack of a playhead overlaying scrubber bar 604b). Thus, electronic device 500 optionally ceases the transition effect when the sing-along mode is enabled. Additionally or alternatively, electronic device 500 optionally forgoes presenting of the transition effect when the sing-along mode is enabled, and the playhead position passes threshold 610a (e.g., due to progression of playback, rather than scrubbing input).

For example, FIG. 6W illustrates an embodiment similar to or the same as described with reference to FIG. 6S. For example, electronic device 500 detects input 640 directed to the selectable option associated with display of lyrics corresponding to first content 606a in FIG. 6W. In FIG. 6X, electronic device 500 has enabled the lyrics mode, such as in response to input 640 in FIG. 6W. In FIG. 6X, electronic device 500 displays lyrics 668 corresponding to what is being played as indicated by playhead 608a, and electronic device 500 optionally detects input 634 directed to selectable option 628, requesting enabling of the sing-along mode. From FIG. 6X to FIG. 6Y, electronic device 500 has enabled the sing-along mode indicated by volume indicator 632. Additionally, electronic device 500 has forgone presentation of a transition effect to the second media content corresponding to scrubber bar 604b, because the sing-along mode was enabled at a time when playhead 608a passed threshold 610a. Thus, in some embodiments, electronic device 500 forgoes presenting of the transition effect when one or more criteria are satisfied, such as a criterion that is satisfied when a sing-along feature is not enabled.

FIG. 6Z illustrates electronic device 500 playing content corresponding to playback of first content 606a while a setting corresponding to a transition effect is configured with a respective configuration (e.g., “Transition mode: Crossfade”). In FIG. 6Z, a transition effect has not yet been initiated, therefore, respective media different from first content 606a is not playing. In FIG. 6Z, user interface 602 includes a plurality of selectable options, including selectable option 626, selectable option 670b, and selectable option 670c. In some embodiments, selectable option 670b is selectable to initiate sharing of first content 606a with another electronic device. In FIG. 6Z, electronic device 500 detects input 630 directed to selectable option selectable option 670c, and in response, electronic device 500 displays a queue view of user interface 602 (e.g., as shown in FIG. 6BB).

FIG. 6AA illustrates a scenario in which the transition effect described with reference to FIG. 6Z is being performed. For example, if electronic device does not detect input 630 as shown in FIG. 6Z, electronic device 500 advances playback of first content 606a and initiates presentation of a crossfading transition effect (e.g., based on a setting configured at electronic device 500). It is understood that some aspects of the transition effect described previously, such as increasing and/or decreasing volume of content and/or changing a size of representation 601a optionally apply to the transition effect as shown in FIG. 6AA. In some embodiments, the transition effect includes displaying simulated glowing and/or other visual effects applied to aspects of user interface 602. For example, as shown in FIG. 6AA, electronic device 500 displays a glow overlaying representation 601a of cover art associated with the content item the electronic device 500 is currently playing. In some embodiments, the glow includes increasing a contrast and/or displaying a color fill with a feathered edge overlaying and/or extending beyond the dimensions of user interface elements, such as overlaying representation 601a. In FIG. 6AA, scrubber bar 604a includes a glow 678. In some embodiments, glow 678 extends from a left edge of the scrubber bar 604a to the position of the playhead 608a. Additionally, as shown in FIG. 6AA, electronic device 500 displays glow 680 overlaying playback controls included in user interface 602. In FIG. 6AA, electronic device 500 detects input 630 directed to selectable option 670c, as described with reference to FIG. 6Z. Other visual effects described with reference to method 700, additionally or alternatively to glow effects, are possible in some embodiments.

FIG. 6BB illustrates electronic device 500 displaying a queue view of the user interface 602. In some embodiments, the queue view of user interface 602 as shown in FIG. 6BB is displayed in response to detecting input 630 as shown in FIGS. 6Z and/or 6AA. In FIG. 6BB, the transition effect described with reference to FIGS. 6Z and 6AA is ongoing, as indicated by glyphs 612a and 612b which respectively are indicative of volumes of playback of respective content, as described in greater detail above. In user interface 602 as shown in FIG. 6BB, representation 601a is displayed with a size that is different from the size of representation 601a as shown in FIG. 6AA. Additionally or alternatively, representation 601a in FIG. 6BB is not displayed with the glowing effect described with reference to FIG. 6AA and/or other visual effect associated with the transition. Thus, some portions of the transition effect displayed when user interface 602 is displayed with a first view (e.g., as shown in FIG. 6AA) are not displayed when user interface 602 is displayed with a second view (e.g., as shown in FIG. 6BB). In FIG. 6BB, electronic device 500 displays selectable option 670c with a visual appearance (e.g., a color fill and/or pattern fill) indicating that selectable option 670c is selected and the queue view of user interface 602 is being presented.

In FIG. 6BB, the queue view of user interface 602 includes a plurality of representations of content queued for playback. For example, representation 674 includes cover art associated with an upcoming content item (e.g., different from, or the same as the content indicated by scrubber bar 604b). Representation 674 further includes a song title and an artist title corresponding to the upcoming content item. In FIG. 6BB, the plurality of representations of content further includes representation 676, which includes respective cover art for a song queued for playback after the content item corresponding to representation 674.

In FIG. 6BB, the queue view of user interface 602 includes a plurality of selectable options 672. In some embodiments, selectable options 672 are associated with controlling playback of content. For example, selectable option 672a is optionally selectable to initiate a shuffle mode in which contents of the queue (e.g., corresponding to the plurality of representations of content) in user interface 602 as shown in FIG. 6BB are presented in a pseudo-random order. Additionally or alternatively, selectable option 672b is optionally selectable to initiate a repeating of one or more content items included in the queue view of user interface 602, as shown in FIG. 6BB. In some embodiments, selectable option 672c is selectable to add additional items to the queue. In some embodiments, the content items added to the queue when selectable option 672c is enabled are different from content items added to the queue as described with reference to FIG. 6CC and selectable option 672d. In FIG. 6BB, selectable option 672d is displayed with an icon that is indicated that a cross-fading transition effect is configured. In some embodiments, in accordance with a determination that the content that electronic device 500 is playing and/or is queued to play do not satisfy respective criteria, electronic device 500 disables the selectable option 672d and/or the transition effect, as described in greater detail above and/or with reference to method 700.

In FIG. 6BB, electronic device 500 displays glow 678 and glow 680, in a manner similar to or the same as described with reference to FIG. 6AA. In this way, electronic device 500 optionally presents portions of the transition effect when user interface 602 is displayed in the queue view (e.g., as shown in FIG. 6BB) that are also presented when user interface 602 is displayed with a view as shown in FIG. 6AA.

FIG. 6CC illustrates user interface 602 being presented in a manner similar to the manner described with reference to FIG. 6BB when the active transition effect corresponds to a DJ transition effect, as described above and with reference to method 700. In FIG. 6CC, the volume of the content corresponding to glyph 612b is greater than as shown in FIG. 6BB, at least partially because the DJ transition effect optionally mixes between content items in a manner that is different from a crossfading transition effect. In FIG. 6CC, selectable option 672d is displayed with a visual appearance that differs from as shown in FIG. 6BB, to reflect that the current transition effect corresponds to the DJ transition effect. In particular, selectable option 672d in FIG. 6CC is displayed with a set of overlapping circles, indicative of the mixing and/or overlapping between the content items presented during the transition effect. As described with reference to FIG. 6BB, the transition effect as shown in FIG. 6CC includes some aspects of the transition effect illustrated in FIG. 6AA such as glow 678 and/or glow 680. Additionally or alternatively, as described with reference to FIG. 6BB, the transition effect as shown in FIG. 6CC does not include some aspects of the transition effect illustrated in FIG. 6AA, such as the glow effect applied to representation 601a.

FIG. 7 illustrates a flow diagram illustrating a method in which an electronic device presents a transition effect between media content in accordance with some embodiments of the disclosure. The method 700 is optionally performed at an electronic device and/or electronic devices such as device 100, device 300, or device 500 as described above with reference to FIGS. 1A-1B, 2-3, 4A-4B and 5A-5H. Some operations in method 700 are, optionally combined and/or order of some operations is, optionally, changed.

In some embodiments, a method 700 is performed at an electronic device in communication with one or more input devices and a display generation component, such as electronic device 500 in communication with display generation component 504 as shown in FIG. 6A. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. Examples of input devices include physical buttons, knobs, handles, and/or switches of a vehicle, a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, and/or a motion sensor (e.g., a hand tracking device, a hand motion sensor).

In some embodiments, while presenting (e.g., playing back) first media content, such as first content 606a in FIG. 6A, and in accordance with a determination that a playhead position relative to first media content satisfies one or more first criteria relative to the first media content, such as the position of playhead position 604a as shown in FIG. 6B, including a criterion that is satisfied when the playhead position is within a threshold amount of time of an end of the first media content, the electronic device initiates (702) presentation of a transition effect, wherein the transition effect includes transitioning from presentation of the first media content to presentation of second media content, different from the first media content, such as a transition effect including changing of volume indicated by glyph 612a and glyph 612b in FIG. 6B. For example, the first media content optionally is and/or optionally includes audio, an image, an animation, and/or video that is presented by an application such as a media player application stored in memory of the electronic device. For example, the first media content is optionally an audio track including a song, spoken words, ambient sounds, and/or some combination thereof. In some embodiments, the electronic device generates audio in accordance with a playhead position relative to the first media content. The generating of audio optionally is included in and/or corresponds to the playback of the audio. Additionally or alternatively, the presentation of media content optionally includes playback of the audio. It is understood that respective media such as audio and/or video optionally is defined by a start and end time of the respective media. The playhead position, for example, optionally corresponds to the current playback time of respective media content, such as optionally corresponding to a 0 second mark of the first media content when the electronic device initiates playback of the first media content, optionally corresponding to a respective end time when the electronic devices reaches the ending of the playback of the first media content (e.g., 3 minutes and 30 seconds of a song, twenty minutes of a video, and/or additional or alternative subdivisions of time such as fractions of a second), and/or optionally corresponding to a time that is intermediate to the start and end time of the first media content. In some embodiments, the electronic device determines the relative position of the playhead with respect to concurrently playing media content. For example, a first relative position of the playhead optionally corresponds to the progression of playback of the first media content (e.g., relative to the start or end time of the first media content), and a second relative position of the playhead optionally corresponds to the progression of playback of second media content, optionally different from the first media content (e.g., the second relative position defined relative to the start or end time of the second media content).

In some embodiments, the electronic device plays a plurality of media content items, such as while advancing along a playlist of songs and/or videos and/or while advancing through a collection of songs that are associated with a theme that is determined in accordance with one or more artificial intelligence models (e.g., similar to or the same as described with reference to method 900). In some embodiments, the electronic device optionally plays different media content concurrently to gradually transition between playing respective media content. For example, the electronic device optionally plays the first media content alone for a period of time, and when approaching the end time of the first media content, optionally initiates playback of the second media content while concurrently continuing to play the first media content. In such an example, the first relative playback position is optionally 20 seconds from the end time of the first media content, and the second relative playback position is optionally 30 seconds from the start time of the second media content.

In some embodiments, the electronic device facilitates transitioning between the first media content and additional and/or alternative media content to reduce cacophonous user experiences while concurrently playing the first and the second media content. As an example, the electronic device optionally generates a cross-fading effect in which one or more characteristics of the first media content are changed to audibly blend the first media content with the second media content (e.g., the electronic device changes the volume, the application of one or more digital filters, the frequency responses of the one or more filters, the application of a reverberation effect, and/or a playback speed of the first media content and/or the second media content). In some embodiments, the transitioning effect includes one or more of decreasing a volume of audio channel(s) corresponding to the first media content, initiating playback of the second media content, and/or increasing the volume of audio channel(s) corresponding to the second media content. In some embodiments, the transition includes a plurality of the aforementioned operations performed concurrently. In some embodiments, the second media content is intelligently selected. For example, the electronic device optionally determines and/or obtains an indication that the second media content satisfies one or more transition criteria (e.g., the one or more first criteria). For example, the one or more transition criteria optionally include respective criterion that are respectively satisfied in accordance with a determination that a rhythmic beat of the first media content is similar to (e.g., is within a threshold difference in number of beats per minute (e.g., 1, 2, 3, 5, 7, 10, 15, or 20 bpm)), that a genre of the second media content is similar to or the same as a genre of the first media content, that an artist that recorded the first media content is similar to or the same as an artist that recorded the second media content, that one or more lyrics included in the first media content are similar to, the same as, and/or form a natural language phrase or sentence with one or more lyrics included in the second media content, that a relative volume of a portion of the first media content is similar to or the same as a relative volume of a portion of the second media content, and/or some combination thereof.

In some embodiments, performance of the transition is contingent upon satisfaction of the one or more first criteria. For example, the electronic device optionally initiates the transition in accordance with a determination that the playhead position relative to the first media content (e.g., the first relative position described previously) is within a threshold time of and end of the first media content (e.g. 0.005, 0.01, 0.5, 0.1, 1, 5, 10, 15, 20, 30, 45, or 60 seconds), and/or is within the threshold time of an audibly significant portion of the first media content (e.g., a portion in which a prolonged silence that lasts until the end of the first media content). Additional or alternative criteria are described herein; it is understood that the transition is optionally contingent upon satisfaction of one or more of such criteria in any suitable combination.

In some embodiments, while the transition effect is ongoing, the electronic device detects (704), via the one or more input devices, one or more inputs corresponding to changing of the playhead position relative to the first media content, such as input 618 as shown in FIG. 6F. For example, the electronic device optionally changes the playhead position relative to a start and/or end time of the first and/or the second media content in response to detecting one or more inputs requesting the change. In some embodiments, the one or more inputs optionally include one or more inputs detected by a trackpad included in and/or in communication with the electronic device, one or more inputs detected at a touch screen included in and/or in communication with the electronic device, voice input detected by microphones included in and/or in communication with the electronic device, one or more inputs detected by a computing peripheral (e.g., a mouse, a trackpad, a keyboard, a pointing device such as a stylus or a wireless and optionally contactless oblong pointing device, and/or some combination thereof) optionally separate from, but optionally in communication with the electronic device (e.g., wired and/or wireless communication), one or more inputs detected by tracking gaze and/or air gestures of the user (e.g., an air pinch including contact between fingers of a hand of a user of the electronic device, an air pointing of one or more fingers toward images displayed by the display generation component, and/or an air curling of the one or more fingers), and/or some combination of one or more inputs detected in accordance with one or more of such input modalities. As an example, the electronic device optionally detects one or more inputs directed to a fast forward button advancing the playback position and/or modifying the speed that the playhead advances relative to the first and/or the second media items, and optionally updates the playhead position relative to the first and/or the second media content in accordance with the one or more inputs (e.g., based upon a duration of contact of the one or more inputs with the fast forward button). It is understood that some embodiments are described with reference to advancing the playhead position relative to respective media content, but that the electronic device optionally performs similar operations when moving the playhead position backward relative to the respective media content. Additionally or alternatively, the one or more inputs are optionally directed to a scrubber bar that the electronic device optionally displays while playing the first and/or second media content. For example, the electronic device detects an input directed to the scrubber bar that corresponds to a request to reposition the play head, such as an input that repositions a visual indication of the playhead included in the scrubber bar.

In some embodiments, the scrubber bar visually indicates the playhead position relative to the first and/or second media content, such as a vertical line-the playback position-that illustrates the current timestamp relative to a timeline-the scrubber bar-that represents the duration of the first media content. As an example, the one or more inputs optionally include contact between an object such as a finger and a touch screen in communication with the electronic device at a location that corresponds to the displayed scrubber bar. In some embodiments, the location of the contact relative to the displayed scrubber bar optionally specifies a requested updated playback position for the playhead relative to the first and/or second media content. Additionally or alternatively, the one or more inputs optionally include moving of such a contact along a dimension of the scrubber bar while the contact is maintained. In some embodiments, in accordance with a determination that the contact moves in a first direction relative to the dimension of the scrubber bar, the electronic device updates the playhead to correspond to an earlier time than the current playback position (e.g., when the contact moves to the left of the current playhead position and/or left of the location of initial contact). In some embodiments, in accordance with a determination that the contact moves in a second direction, different from the first (e.g., opposing the first direction, such as when the contact moves to the right of the current playhead position and/or the location of initial contact), the electronic device updates the playhead to correspond to a later time than the current playback position.

In some embodiments, in response to detecting the one or more inputs changing the playhead position relative to the first media content (706), the electronic device initiates (708) playback of respective media at a respective position corresponding to the one or more inputs, such as second content 606b as shown in FIG. 6G and/or such as second content such as third content 606c as shown in FIG. 6K.

In some embodiments, in response to detecting the one or more inputs changing the playhead position relative to the first media content (706), the electronic device ceases (710) presentation of the transition effect, such as ceasing of the transition effect from FIG. 6F to FIG. 6G as indicated by the scrubber bar 604c. In some embodiments, the electronic device ceases the changing of the volume of the first and/or the second media content, ceases playback of the first and/or second media content, and/or changes the volume of the first and/or second media content to correspond to a volume of the respective media content used to play the respective media content prior to initiation of the transition effect. It is understood that any additional or alternative effects and/or changes applied to the presentation of the first media are optionally forgone in response to detecting the one or more inputs. Additionally or alternatively, the electronic device optionally plays the respective media without including one or more effects layered onto the respective media while presenting the transition effect when ceasing the presentation of the transition effect. In some embodiments, after detecting the one or more inputs, the electronic device forgoes presentation of the transition effect independently of whether the one or more first criteria are again satisfied. For example, in response to detecting input(s) changing the playback position to a respective playback position that is within the threshold amount of time of the end of the first media and/or in response to detecting the playback position advance to the respective playback position in accordance with gradual playback of the first media, the electronic device optionally forgoes the presentation of the transition effect. Thus, after ceasing the presentation effect, the electronic device optionally forgoes presenting the transition effect. In some embodiments, after the electronic device ceases playback of the first media content, the electronic device is able to again present the transition effect when the one or more first criteria are satisfied while presenting the first media at a later time.

In some embodiments, the electronic device initiates playback of the respective media corresponding to a playback position requested by the one or more inputs. In some embodiments, the respective media is the first media when the one or more second criteria are satisfied. In some embodiments, the respective media is the second media when the one or more second criteria are not satisfied. For example, the one or more inputs optionally include an input scrubbing from 10 seconds away from an end of the first media to 5 seconds away from the end of the first media, and optionally initiates the playback at the 5 second mark away from the end of the first media. Additionally or alternatively, the one or more inputs optionally include an input scrubbing from 2 seconds after the start time of the second media to 15 seconds after the start time of the second media, and the electronic device optionally initiates the playback 15 seconds after the start time of the second media. For example, the electronic device optionally does not play the respective media with one or more digital filters, reverberation, and/or changing of a beat of the respective media that are applied while transitioning between the first and the second media content. Terminating the transition effect and initiating and/or continuing to play respective media content allows a user of the electronic device to focus on consuming the respective media content and reduces processing required to resolve ambiguities related to resuming the transition effect in accordance with the one or more inputs changing the playback position, thereby reducing power consumption required for such processing and reducing the likelihood that the user is disoriented by the resumed transition effect.

In some embodiments, in response to detecting the one or more inputs changing of the playhead position relative to the first media content, such as input 618 as shown in FIG. 6F, and in accordance with a determination that the playhead position satisfies one or more second criteria, the respective media corresponds to the first media, such as second content 606b that is satisfied when the playhead position 608b is before a pivot point as shown in FIG. 6F. For example, the one or more second criteria optionally include a criterion that is satisfied when the playhead position is changed to correspond to a time position before a “pivot point.” As referred to herein, the pivot point optionally corresponds to a time position relative to the first media at which the electronic device optionally transitions from presenting the first media content as audibly dominant to presenting the second media content as audibly dominant. For example, the electronic device optionally concurrently presents the first media content and/or the second media content concurrently, and optionally plays the first media content louder than and/or with a degree of clarity that is greater than the second media content. Turning back to the input(s) described with reference to method 700, the electronic device optionally determines whether the input(s) request changing of the playhead position is detected when the playhead before the “pivot point” with respect to the first media and/or the second media. In such an example, the electronic device optionally terminates the transition effect and resumes optionally resumes playback of the first media content at the time position requested in accordance with the input(s) changing the playhead position. In some embodiments, the pivot point corresponds to a position relative to the first media content after the transition effect is scheduled to begin and/or before the end of the first media content. In some embodiments, in response to detecting input changing the playhead position while the transition effect is ongoing (e.g., before or after the playhead reaches the pivot point in accordance with natural playback, rather than scrubbing input), the electronic device changes the playhead position to an updated position corresponding to the first media content and accordingly maintains the presenting of the first media content, and/or forgoes presenting of the second media content. Presenting the first media content in response to input(s) changing the playhead position improves the likelihood that the user is able to continue consume the first media content, thus reducing user input required to preserve the presentation of the first media content and thereby reducing power consumption of the electronic device.

In some embodiments, while presenting the first media content and before detecting the one or more inputs, the electronic device displays, via the display generation component, a scrubber bar, such as scrubber bar 604b as shown in FIG. 6F, wherein the scrubber bar corresponds to the first media content. For example, the electronic device optionally displays a timeline illustrating the playhead position and/or current progress of presentation and/or playback of the first media content. The timeline is at times referred to herein as a scrubber bar. In some embodiments, to represent the playhead position, the electronic device displays a notch overlaying the scrubber bar and/or displays a progressively increasing portion of the scrubber bar with a fill color and/or pattern. As the playhead position moves, the electronic device optionally changes the position of the notch and/or the amount of fill.

In some embodiments, in response to detecting the one or more inputs, in accordance with the determination that the playhead position satisfies the one or more second criteria, such as a criterion satisfied when the playhead 608b is before a pivot point, the electronic device maintains display of the scrubber bar corresponding to the first media, such as the maintaining of display of scrubber bar 604b as shown in FIG. 6G. In some embodiments, the electronic device displays the scrubber bar to indicate whether the first media content or the second media content is currently being presented (e.g., with a level of audio prominence that is greater than other, concurrently presented media content). For example, in response to detecting the input(s) changing the playhead position relative to the first media content (e.g., at times, referred to herein as scrubbing input(s)) and when the playhead position was before the pivot point when the scrubbing input(s) were detected, the electronic device optionally maintains display of the scrubber bar corresponding to the first media. For example, the electronic device optionally maintains an indication of a start time, an end time, and optionally displays the fill extending from the start time up to the playhead position within the scrubber bar. Accordingly, the electronic device optionally forgoes changing of the scrubber bar to correspond to the second media content.

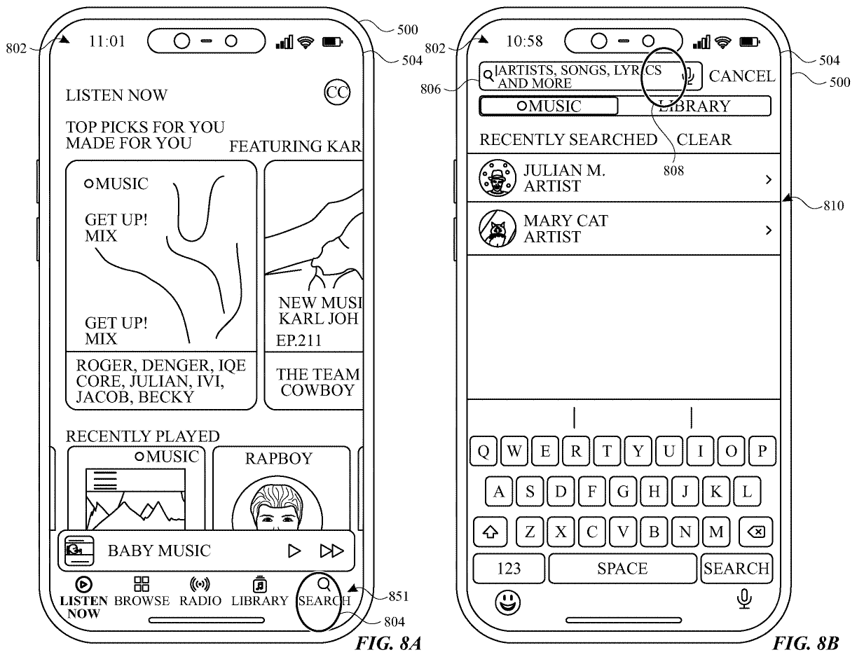

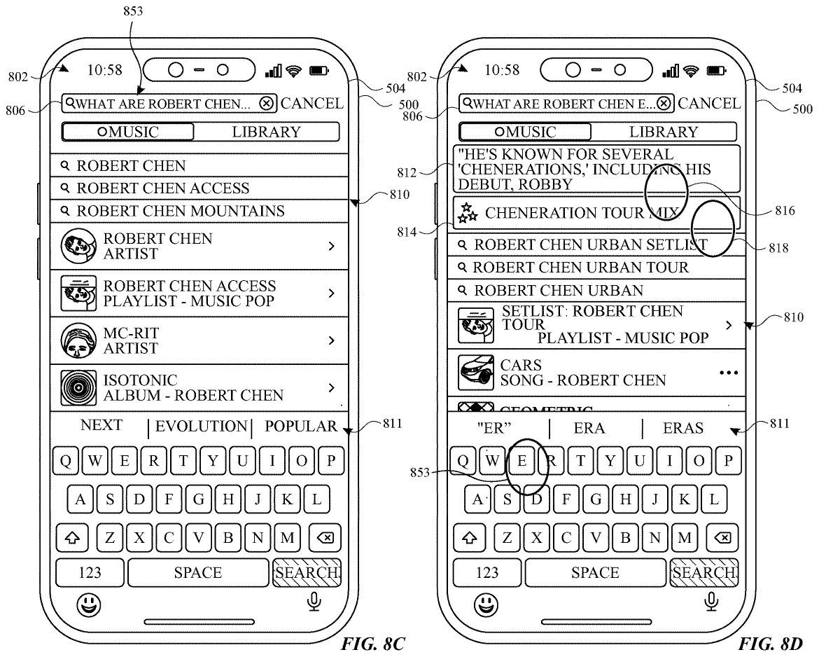

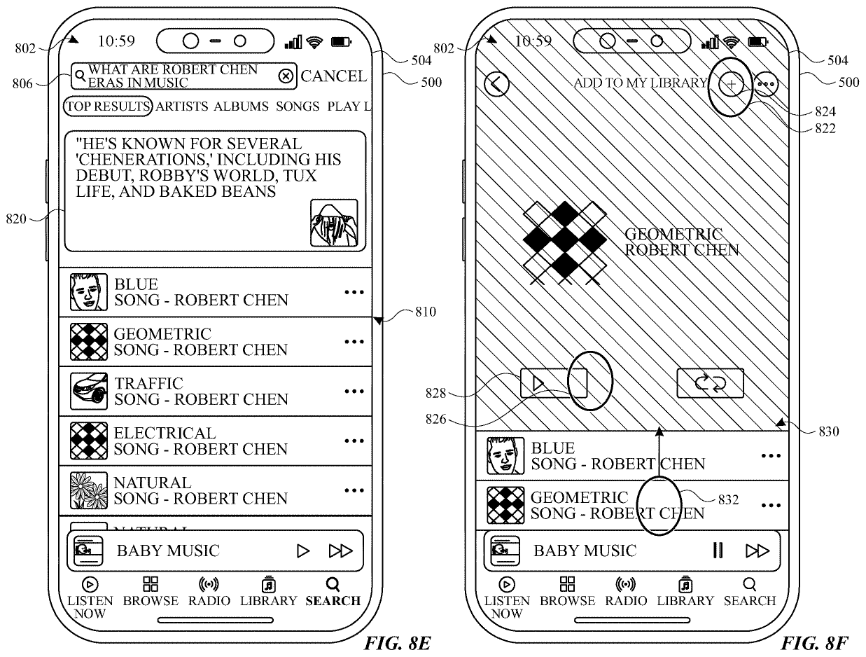

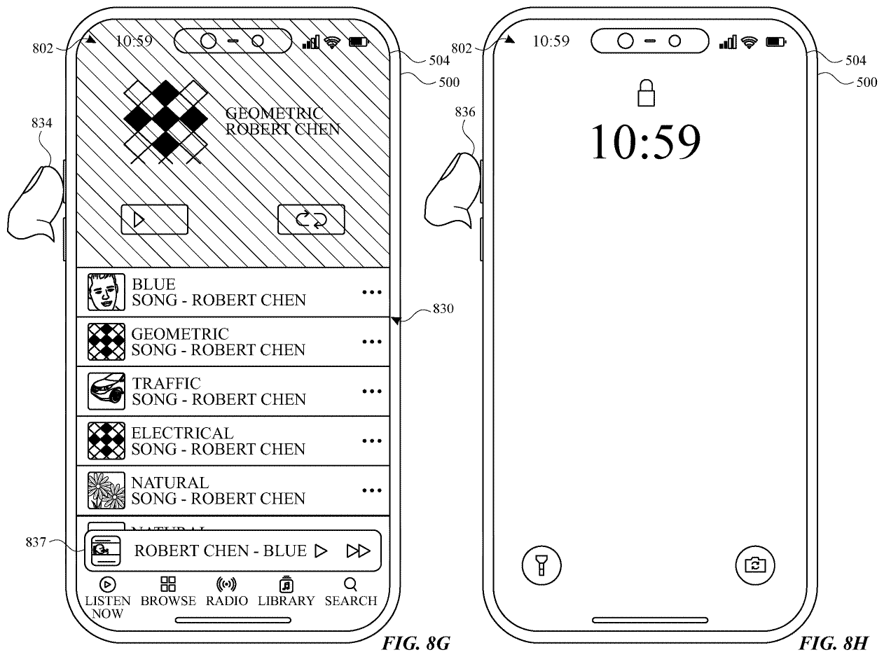

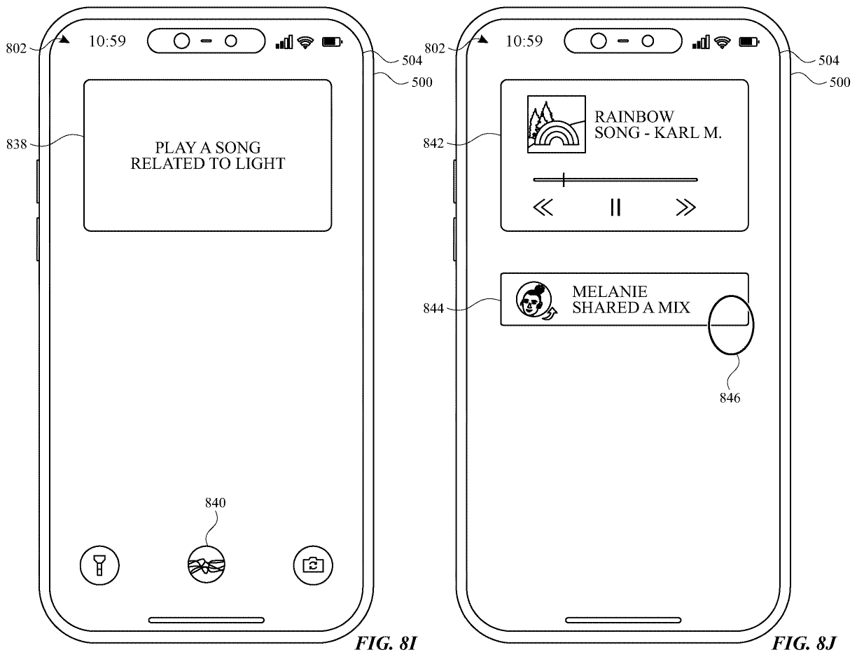

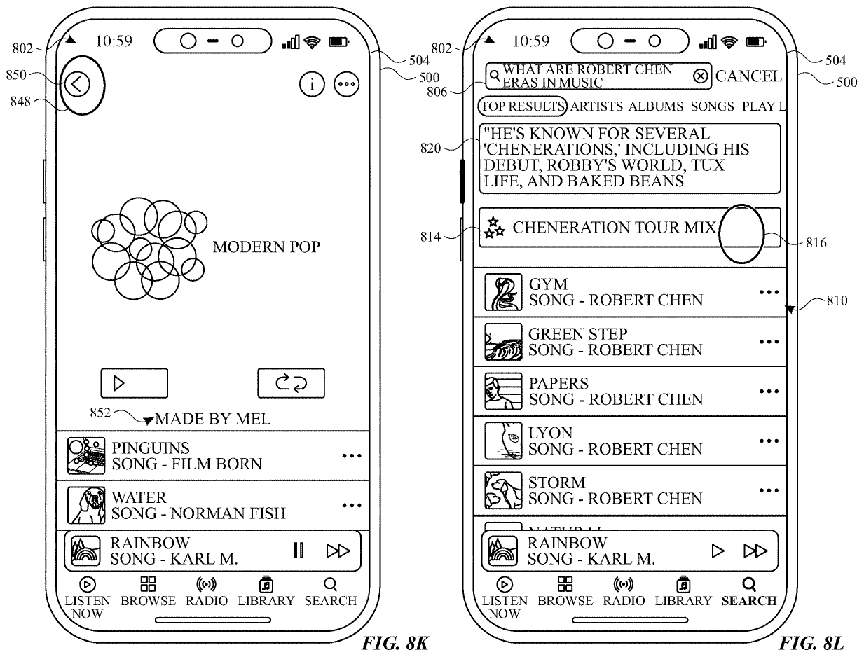

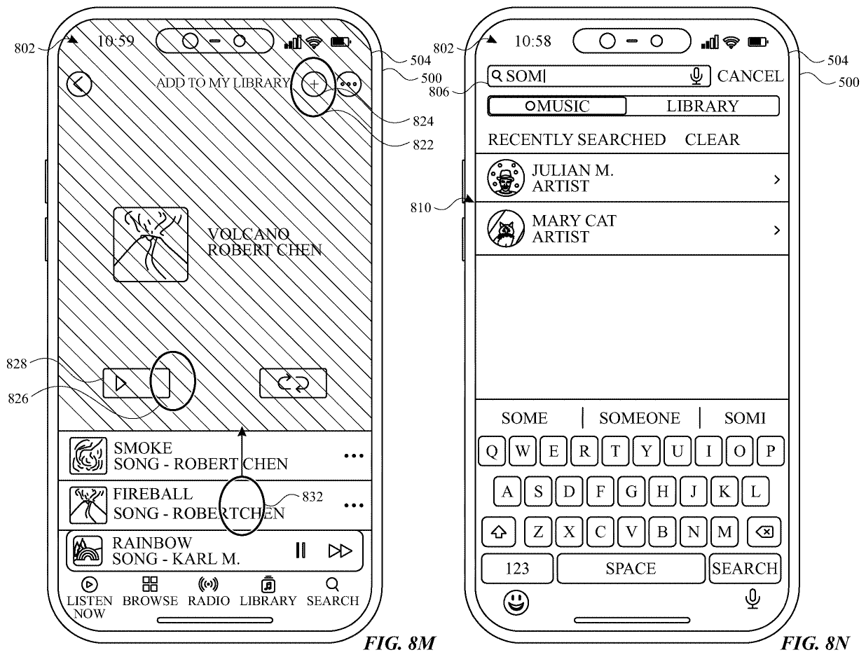

In some embodiments, in accordance with the determination that the playhead position does not satisfy the one or more second criteria, changing the scrubber to correspond to the second media content, such as when input 618 is detected while playhead 608b in FIG. 8F is after the pivot point. For example, in response to detecting the input(s) scrubbing the playhead position relative to the first media content and when the playhead is a position after the pivot point (e.g., before the end of the first media content) when the scrubbing input(s) are detected, the electronic device optionally changes the visual appearance of the scrubber bar to represent the start time, end time, and/or playback progress relative to the second media content. Changing the scrubber bar to reflect currently playing media content during the transition effect reinforces the transition between media content items, thus reducing the likelihood that the user erroneously attempts to interrupt the transition effect.

In some embodiments, in response to detecting the one or more inputs changing of the playhead position relative to the first media content, such as when input 618 is detected while playhead 608b in FIG. 8F is after the pivot point and/or when input 618 is detected and directed to scrubber bar 604c in FIG. 8K, and in accordance with a determination that the playhead position does not satisfy the one or more second criteria, the respective media corresponds to the second media content, such as scrubber bar 604c in FIG. 8K. For example, the electronic device optionally determines that the playhead position is past the pivot point when the scrubbing inputs are detected, and optionally initiates playback of the second media (and/or ceases display of the first media content) when the scrubbing inputs cease (e.g., when contact on a trackpad or touch screen is ceased, when a voice input is detected terminating the scrubbing, and/or when an air gesture provided by a portion of a user's body such as an air pinch contacting fingers together is ceased). Thus, the electronic device optionally presents (e.g., plays back) the first media content or the second media content in response to one or more inputs scrubbing through the first media content based upon whether the playhead position relative is before or is after the pivot point when scrubbing is initiated. Additionally or alternatively, because the first or the second media content optionally is louder and/or more audible than the other media content, the electronic device optionally displays the scrubber bar corresponding to the first media content or corresponding to the second media content (as described further below). In response to receiving the scrubbing input(s), the electronic device optionally updates the playhead position of the first media content when the scrubbing input is detected while the scrubber bar corresponds to the first media content. Additionally or alternatively, in response to receiving the scrubbing input(s), the electronic device optionally updates the playhead position of the second media content when the scrubbing input is detected while the scrubber bar corresponds to the second media content. Presenting the second media content when the one or more second criteria are not satisfied reduces the need to interrupt the one or more inputs scrubbing through the first media content in order to expressly request presenting of the second media content, thereby improving efficiency of interaction with the media player application and/or user interface.

In some embodiments, the one or more criteria include a criterion that is satisfied when one or more first characteristics of audio included in the first media content at the playhead position correspond to one or more second characteristics of second audio included in the second media content, such as audio characteristics of first content 606a as shown in FIG. 6C and audio characteristics of second content 606b as shown in FIG. 6D. For example, the electronic device determines and/or obtains an indication from other electronic device(s) of that the second media content is similar to the first media content, and optionally selects the second media content for presentation. In some embodiments, the characteristics include a tempo of the media content, a key of the media content, a genre and/or subgenre of the media content, and/or some combination thereof. In some embodiments, the second media content is selected as next in a playback queue irrespective of the playhead position. For example, the electronic device optionally selects the second media content in a manner similar to or the same as described herein, even when the playhead position has not passed the pivot point. Thus, the selection of the second media content is optionally based upon similarities between the first and the second media content, optionally even when the one or more criteria are not satisfied. In some embodiments, the second media content is selected without one or more inputs expressly requesting selection of the media, such as without detecting an input directed to a selectable option to add the second media content to the queue. In some embodiments, the electronic device continues to select additional media content in accordance with a determination that the characteristic(s) of the newly selected media content are similar to or the same as the characteristic(s) of the first and/or the second media content.

In some embodiments, while presenting (e.g., playing back) the first media content, and in accordance with a determination that the playhead position relative to first media content satisfies one or more second criteria relative to the first media content and that the one or more first criteria are not satisfied, the electronic device initiates presentation of a respective transition effect, such as presenting a transition effect transitioning from presenting first content 606a as shown in FIG. 6C to presenting third content 606c in FIG. 6K, wherein the respective transition effect includes transitioning from presentation of the first media content to presentation of the third media content, wherein the one or more second criteria include a first criterion that is satisfied when the playhead position is within the threshold amount of time of an end of the first media content, such as threshold 610a as shown in. FIG. 6C, and a second criterion that is satisfied when the one or more first characteristics of the audio included in the first media correspond to one or more third characteristics of third audio included in third media content, different from the first media content and different from the second media content, such as audio characteristics of first content 606a as shown in FIG. 6C and audio characteristics of third content 606c in FIG. 6K. For example, the electronic device optionally intelligently selects which respective media content that the electronic device will transition to based upon the characteristics of the respective media content. In some embodiments, the selection is based upon one or more machine learning models, such as models trained based upon popular DJ playlists and/or performances configured to identify an audible similarity between media content items. In some embodiments, the electronic device forgoes transitioning to particular media content in accordance with a determination that characteristic(s) of the particular media content are not similar to, or are not similar enough to the first media content.

For example, the electronic device optionally initiates the transition effect in accordance with a determination that the playhead position reaches past a threshold time (e.g., 1, 2, 5, 10, 15, 20, 30, or 45 seconds, and/or a dynamic threshold time based upon an amount of time requiring to align tempo and/or musical features such as words and/or harmonies between the first and/or the second media content). Additionally or alternatively, as described further herein with reference to the “duration” of the transition effect, the electronic device optionally changes the threshold amount of time based upon characteristics of the first and/or the second media content.

For example, the electronic device optionally transitions from the first media content to the third media content in accordance with a determination that a difference in tempos between the first and the third media content is less than a difference in tempos between the first and the second media content. In some embodiments, the correspondence between the first and the second or the third media content is based upon intelligently determined portions of the second and/or the third media content. For example, the first media content optionally includes lyrics in a bridge section of a song that are echoed in a climactic portion of the third media content. The climatic portion is optionally identified by the one or more machine learning models as significant and potentially pleasurable for the user to consume after the lyrics in the bridge are presented; thus, the electronic device optionally transitions from the bridge of the first media content to the climax of the third media content. Additionally or alternatively, the electronic device and/or other electronic devices optionally use one or more signal processing models to determine a period of time in which the electronic device is capable of speeding up the first media content to match a tempo of the third media content (and/or, the electronic device is unable to speed the first media content to match a tempo of the second media content over the same period of time). Accordingly, the electronic device determines and/or obtains an indication of correspondence between the first and/or the third media content, and optionally transitions between the content items. In some embodiments, the second and/or the third media content are identified without one or more inputs expressly analyzing the characteristics of the second and/or third media content. For example, the electronic device optionally does not detect inputs requesting display of the spectral, temporal, and/or metadata-related aspects of content, and optionally selects such content for the user's consumption automatically. Selecting the second or the third media content based upon characteristics of audio included in the second or third media content reduces user inputs required to manually select between the content, thereby reducing processing required to perform operations related to the input.

In some embodiments, in accordance with a determination that the first media content or the second media content has one or more first characteristics, a duration of the transition effect corresponds to a first period of time, such as characteristics of first content 606a as shown in FIG. 6C and/or characteristics of second content 606b as shown in FIG. 6D corresponding to a period of time indicated by threshold 610a as shown in FIG. 6C. For example, the electronic device optionally determines a duration of the transition effect based upon characteristic(s) of the first media content and/or the second media content. In some embodiments, the transition is longer when the first media content and/or the second media content are relatively longer duration content. For example, when the time of a first audio track and/or a second audio track-together or combined-correspond to a first amount of time, the duration amount is optionally a first value. When then time corresponds to a second amount of time (e.g., less than or greater than the first amount of time), the duration of the transition effect is optionally a second value (e.g., less than or greater than the first value). The transition effect is optionally longer when one or both of the content items are longer, and is optionally shorter when one or both of the content items are shorter.

In some embodiments, in accordance with a determination that the first media content or the second media content has one or more second characteristics, different from the one or more first characteristics, the duration of the transition effect corresponds to a second period of time, different from the first period of time, such as the period of time indicated by threshold 610b as shown in FIG. 6D based upon characteristics of content 6068 and content corresponding to third content 606c in FIG. 6F. For example, as described above, the electronic device optionally configures the duration of the transition effect based on the length of the first media content and/or the second media content. In some embodiments, the transition effect is additionally or alternatively based upon the content, such as the time that audio included in the first and/or second media content is greater than a threshold volume (e.g., 5%, 10%, 25%, 40%, 50%, 65%, and/or 75%) and/or a volume level normalized to a peak volume of the audio included in the first and/or second media content. In some embodiments, the duration is based upon tempo of the first media content and/or the second media content. For example, the duration is optionally relatively longer when the first and/or second media content are relatively lower tempo, and/or is optionally relatively shorter when the first and/or second media content are relatively higher tempo. In some embodiments, the transition effect includes modifying a playback speed of the first media content and/or the second media content, and the duration of the transition effect corresponds to an amount of time over which respective media content is sped up or slowed down to match a tempo of the other media content. In some embodiments, the duration corresponds to an amount of time to match a downbeat of the first media content with a downbeat of the second media content. Configuring the transition effect duration based upon the characteristics of the first and/or second media content reduces the user's cognitive load when consuming the transition effect and improves immersion of the media playback experiences.

In some embodiments, the presentation of the transition effect includes presentation of the first media content with one or more characteristics of the first media content being modified while the transition effect is being presented, such as the volume and/or other amounts of effects applied to audio as indicated by glyph 612a as shown in FIG. 6B. In some embodiments, during the transition effect, the electronic device concurrently presents and/or plays back the first and the second media content. For example, the electronic device optionally applies a cross-fading effect to the presentation of the first media content and/or the second media content, which optionally includes gradually increasing the volume corresponding to the second media content and/or gradually decreasing the volume corresponding to the first media content (e.g., from a respective first volume to a respective second volume that is different from the respective first volume). In some embodiments, the transition effect includes applying a level of distortion that gradually increases and/or decreases to the first and/or the second media content. As an example, the electronic device optionally increases a reverberation effect to the first media content and/or the second media content. In some embodiments, the application of the reverberation effect gradually increases in magnitude (e.g., more echo and/or delay) with respect to the first media content and/or gradually decreases in magnitude with respect to the second media content (e.g., less echo and/or delay). In some embodiments, the electronic device changes the tempo of the first and/or second media content to match the tempo of the media content items, and/or make them similar. In some embodiments, the electronic device changes a balance of frequency content to equalize and/or make the magnitude of audio corresponding to one or more portions of the audible frequency spectrum to be similar during the transition effect. In some embodiments, the electronic device changes a key and/or pitch of the first media content and/or the second media content to make the media content items keys and/or pitches similar or the same. Additionally or alternatively, the electronic device optionally presents visual transitionary effects, such as a cross-dissolves, optionally increasing the opacity of images and/or media corresponding to the second media content and/or optionally decreasing the opacity of images and/or media corresponding to the first media content included in the transition effect. Changing the playback and/or presentation of the first and/or second media content improves the fluidity of the transition between the content, thereby reducing cognitive load of the user consuming the media content and reducing the processing required to manually cause a similar transition.

In some embodiments, the presentation of the transition effect includes presentation of the second media content with one or more characteristics of the second media content being modified while the transition effect is being presented, such as the volume and/or other amounts of effects applied to audio as indicated by glyph 612b as shown in FIG. 6B. For example, the electronic device optionally modifies the second media content in a manner similar to or the same as described above. Changing the playback and/or presentation of the first and/or second media content improves the fluidity of the transition between the content, thereby reducing cognitive load of the user consuming the media content and reducing the processing required to manually cause a similar transition.

In some embodiments, the one or more first criteria include a criterion that is not satisfied when the first media content corresponds to a respective type of media or the second media content corresponds to the respective type of media, such as a type of media corresponding to fifth content 606e as shown in FIG. 6P. For example, the electronic device optionally forgoes presentation of the transition effect in accordance with a determination that the second media content is associated with one or more types of media content. In some embodiments, the one or more types include poetry, spoken word tracks, voice recordings that are not necessarily musical in nature, audio and/or video of a disk jockey (DJ) musical performance, white noise, and/or tracks to soothe and/or relax the user. In some embodiments, the first media content is of a different type of media content than the second media content, and the electronic device intelligently forgoes presentation of the transition effect to reduce unpleasant or unexpected transitions, such as between classical and hard rock music. In some embodiments, when transitioning to the different type of media content and/or between the different type of media content, the electronic device performs a cross-fading between media content while maintaining a tempo and/or musical key of the content items, plays the next media content in succession without presenting a transition effect, and/or presents a transition effect including a period of silence between the content items. In some embodiments, in accordance with a determination that the second media content is associated with one or more types of transition effect friendly content, the electronic device performs the transition. For example, the criterion described above is optionally satisfied when the second media content is a studio recording track, is determined to have one or more tempos, and/or is in one or more musical keys. Forgoing presentation of the transition effect reduces the likelihood the user is presented with a transition that is unpleasant, thus reducing user input required to forgo the transition effect manually, thereby reducing power consumption required to detect the user input.

In some embodiments, the one or more first criteria include a criterion that is satisfied when a sing-along feature associated with an application that is presenting the first media content is not enabled, such as the feature that is not enabled in FIG. 6U corresponding to selectable option 628. For example, the electronic device optionally displays a visual indication corresponding to a sing-along feature which when enabled, and/or optionally changes the audio component of the first and/or second media content to suppress a volume of singing included in the first and/or second media content. In some embodiments, in accordance with a determination that the user provided input directed to the visual indication toggling the sing-along feature on, the electronic device forgoes presentation of a transition effect that otherwise is presented at the appropriate time relative to the first media content. In some embodiments, in accordance with a determination that the user did not provide the input toggling the sing-along feature on, and/or that the feature is otherwise not enabled, the electronic device presents the transition effect as described with reference to method 700. In some embodiments, the input disabling the setting is detected before the transition effect is performed. For example, the setting is optionally disabled before playback of any media content is initiated, and/or optionally while the first media content is being played but before the playhead position reaches the position at which the transition effect is initiated. Not presenting the transition effect when a sing-along feature is enabled reduces the likelihood that the user's artistic expression is suppressed and the user is otherwise unable to hear the content they desire to sing along with, thus reducing user input required to scrub through the media content in an effort to play the content they desire, thereby reducing power consumption required to perform the scrubbing.

In some embodiments, while presenting the transition effect and in accordance with the determination that the playhead position relative to the first media content satisfies the one or more first criteria relative to the first media content, the electronic device displays, via the display generation component, a visual indication corresponding to the transition effect while the transition effect is being presented, such as visual indication 716 as shown in FIG. 6B. For example, the electronic device optionally displays text, graphics, an icon, video, and/or some combination thereof to visually indicate that the transition effect is ongoing. For example, the electronic device optionally displays an icon or a “badge” including text (e.g., “Mixing”) and/or ceases display of one or more other elements of the media player user interface to draw visual attention toward the icon and/or other indications of the transition effect. In some embodiments, the electronic device concurrently changes display of one or more aspects of the media player user interface, such as the scrubber bar. For example, the electronic device optionally displays a simulated lighting effect, mimicking the appearance of light emanating from behind and/or around the scrubber bar. Additionally or alternatively, the electronic device optionally scales the scrubber bar upward or downward in one or more dimensions, and/or optionally scales other aspects of the media player user interface (e.g., decreasing the size of playback control buttons, enlarging the mixing badge, and/or decreasing the scale of album art corresponding to the first media content). In some embodiments, when the transition effect concludes and/or is about to conclude, the electronic device changes the aspects of the media player user interface to their respective visual states as displayed prior to initiation of the transition effect. For example, the electronic device optionally restores the scale of the scrubber bar (e.g., shrinks or enlarges the scrubber bar), optionally ceases display of the icon or badge, optionally displays buttons and/or controls that were temporarily not displayed during the transition effect, and/or some combination thereof.

In some embodiments, while presenting the first media content and in accordance with a determination that the playhead position relative to the first media content does not satisfy the one or more first criteria relative to the first media content, the electronic device forgoes displaying, via the display generation component, the visual indication corresponding to the transition effect, such as not displaying the visual indication 716 as shown in FIG. 6B, and instead displaying visual indication 614 as shown in FIG. 6I. For example, the electronic device optionally maintains the display of the scrubber bar without the simulated lighting, optionally forgoes changing the scale of the scrubber bar, optionally forgoes visual effects transitioning between album art associated with the first and/or the second media content, optionally forgoes display of the mixing badge, and/or some combination thereof. Presenting visual indication(s) of transition effect reduces the likelihood that the user erroneously interrupts the transition effect, thus reducing user input (and associated processing required for operations related to the user input) otherwise required to reinitiate the transition effect.

In some embodiments, presentation of the transition effect includes, in accordance with a determination that a user interface for presenting the first media content is displayed with a first view while the transition effect is ongoing (and/or when the transition effect starts), such as user interface 602 as shown in FIGS. 6A-6CC, the computer system displays, via the display generation component, a first animation for the transition effect, such as the animating of user interface 602 as shown in FIGS. 6A through 6E. For example, the user interface has one or more characteristics of the media playback user interfaces described with reference to method 700. In some embodiments, the user interface includes one or more visual and/or interactive user interface elements, such as one or more playback controls, a name of an artist or publisher of media, a title for currently playing content, one or more playback controls such as a scrubber bar, a pause button a play button, a selectable option that is selectable to initiate display of lyrics corresponding to musical content or spoken content, a selectable option that is selectable to choose an audio playback device (e.g., included in or exterior to the electronic device), and/or a selectable option that is selectable to display a collection of items available for playback such as a playback queue, and/or one or more volume controls. In some embodiments, a same user interface is presented differently by the electronic device based on a current “view” of the user interface. A view of a user interface, as described herein, optionally includes the arrangement, inclusion, and/or exclusion of some or all of the aforementioned visual and/or interactive user interface elements included in the media playback user interface.

In some embodiments, the transition effect includes displaying a respective animation. In some embodiments, the electronic device displays a different animation during the transition effect based on which view of the user interface is being displayed when the transition effect is to initiate. For example, when the first view of the user interface is being displayed, the electronic device optionally presents the first animation. In some embodiments, displaying the first animation includes applying visual effects to content that is included in the first view of the user interface, and/or is not included in the second view of the user interface (e.g., as described in greater detail below). For example, the first view of the user interface optionally includes an image and/or video, such as cover art or a music video corresponding to the first media content. In some embodiments, displaying the first animation includes displaying an animating from the cover art of the first media content to displaying covert art of the second media content described with reference to method 700 (e.g., the media content that the electronic device will begin to play). In some embodiments, the animating between instances of cover art for the first media content and the second media content includes displaying a cross-dissolve between respective cover art instances.

In some embodiments, the first animation includes displaying an animation of a user interface element that is included in the first and the second views of the user interface. For example, the electronic device optionally displays a glowing effect applied to one or more playback controls, such as a scrubber bar, a play button, and/or the like that is included in the first view of the user interface and is also included in the second view of the user interface. Additionally or alternatively, the electronic device optionally displays an icon, graphic, and/or text indicating that the transition effect is ongoing in accordance with a determination that the user interface is displayed with the first view.

In some embodiments, in accordance with a determination that the user interface for presenting the first media content is displayed with a second view, different from the first view, while the transition effect is ongoing (and/or when the transition effect starts), the computer system displays, via the display generation component, a second animation, different from the first animation, for the transition effect, such as user interface 602 as shown in FIG. 6BB including display of glow 678 and/or glow 680. For example, the second view of the user interface optionally includes forgoing display of cover art included in the first view of the user interface. Additionally or alternatively, the second view of the user interface optionally includes at least some of the user interface elements included in the first view of the user interface, such as the scrubber bar, a pause button, a fast-forward button, a rewind button, and/or a selectable option that is selectable to toggle between display of the first view of the user interface and the second view of the user interface. In some embodiments, the second view of the user interface includes one or more representations of content available for playback and/or queued for playback. For example, the second view of the user interface includes text such as artist titles, song names, and/or album names of queued content. Additionally or alternatively, the second view of the user interface includes optionally includes media content, such as cover art and/or video corresponding to respective content included in the queued media content. In some embodiments, respective representations of content included in the queue are selectable to initiate playback of the corresponding media content. For example, the electronic device optionally detects tapping on a touch screen at a location where a first representation of a respective first content is displayed, and in response, ceasing presentation of the first media content and initiatives presentation of the respective first content (e.g., optionally without presenting a transition effect). In some embodiments, the second view of the user interface includes one or more selectable options not included in the first view of the user interface. For example, displaying the second view of the user interface optionally includes displaying respective selectable options that are respectively selectable to initiate a shuffle mode of the queued content, enable repeating of playback of the queue, and/or initiate automatic population of the queue based on modelling of consumption preferences of a user of the electronic device. Presenting a transition effect based on a view of a user interface reduces power consumption of the electronic device required to display content corresponding to the transition effect when portions of the user interface are less suited to being displayed with the transition effect and/or are not displayed during the transition effect.

In some embodiments, while presenting the first media content, the computer system displays, via the display generation component, a user interface for presenting the first media content, such as user interface 602 as shown in FIG. 6BB and FIG. 6CC. In some embodiments, the user interface includes (e.g., as described in greater detail above), a plurality of representations of content upcoming for presentation including a representation of the second media content, such as representation 674 and/or representation 676 as shown in FIG. 6BB. For example, the electronic device displays one or more representations of content queued for playback, as described in greater detail above. In some embodiments, the user interface includes a selectable option, such as selectable option 672d as shown in FIG. 6BB and FIG. 6CC. For example, the electronic device displays a selectable option that is selectable to toggle between enabling or disabling the transition effect. In some embodiments, the user interface includes, in accordance with a determination that a setting of the electronic device associated with the presentation of the transition effect is configured in a first configuration and that one or more respective criteria are satisfied, the selectable option is displayed with a first appearance, such as selectable option 672d as shown in FIG. 6CC. For example, the first appearance includes display of first text describing a name or function of the second configuration of the transition effect. In some embodiments, the text includes a “DJ” and/or some other text describing the automatic content selection functions performed by the electronic device. Additionally or alternatively, the first appearance optionally includes a first icon, graphic, picture, and/or video corresponding to the first configuration, optionally different from the second icon, graphic, picture, and/or video corresponding to the second configuration described below. For example, the electronic device optionally displays a visual indication of a “DJ” effect. In some embodiments, the electronic device forgoes display of text and/or icon(s), graphic(s), and/or media that is included in the second appearance of the selectable option described in greater detail below. In some embodiments, the one or more respective criteria include a criterion that is satisfied based on characteristics of the media content that the electronic device is transitioning between as part of the transition effect, as described in greater detail below and/or with reference to a “respective type of media” herein. In some embodiments, while displaying the selectable option with the first appearance, in response to detecting selection of the selectable option, the electronic device changes the setting to the second configuration.

In some embodiments, the user interface includes, in accordance with a determination that the setting of the electronic device is configured with a second configuration, different from the first configuration, the selectable option is displayed with a second appearance, different from the first appearance such as the appearance of selectable option 672d as shown in FIG. 6BB. In some embodiments, the second configuration corresponds to the transition effect being disabled. In such embodiments, the second appearance of the selectable is the same as or similar to a third visual appearance, as described further below. For example, the second appearance optionally includes an icon or graphic that is included in the first appearance, but the first appearance and the second appearance optionally includes different levels of saturation and/or brightness. In some embodiments, while displaying the selectable option with the second appearance, in response to detecting selection of the selectable option, the electronic device changes the setting to the first configuration.

In some embodiments, the second configuration corresponds to a transition effect different from the “DJ” effect. For example, the second appearance includes display of second text describing a name or function of the second configuration of the transition effect. Additionally or alternatively, the second appearance optionally includes a second icon, graphic, picture, and/or video corresponding to the second configuration. For example, the electronic device optionally displays a visual indication of a cross-fading effect. In some embodiments, the electronic device forgoes display of text and/or icon(s), graphic(s), and/or media that is included in the first appearance of the selectable option described in greater detail below. Displaying a selectable option with an appearance corresponding to a configuration of a setting reduces user inputs otherwise may be required to navigate to a settings user interface for the media playback application.

In some embodiments, the one or more respective criteria include a criterion that is satisfied in accordance with a determination that the transition effect is to be presented from the first media content between the first media content and the second media content, such as between first content 606a and second content 606b, as shown in FIG. 6C and in FIG. 6D, respectively. For example, in accordance with a determination that a genre of the first media content corresponds to one or more genres that are potentially less suitable for the transition effect, the electronic device optionally disables the possibility of presenting the transition effect. To reflect the disabling, the electronic device optionally displays the selectable option with the third appearance described below. In some embodiments, the electronic device forgoes presentation of the transition effect in accordance with the determination that the genre of the first media content corresponds to the one or more genres designated as being potentially incompatible with the transition effect. For example, an abstract jazz song, a recording of a live music performance, a podcast recording, and/or a user voice recording are optionally less suited to the transition effect, and the electronic device optionally disables the transition effect for transitioning from such media content (and/or transitioning into such media content).

In some embodiments, in accordance with a determination that the setting of the electronic device associated with the presentation of the transition effect is configured in the first configuration and that the one or more respective criteria are not satisfied, the selectable option is displayed with a third appearance, different from the second appearance, such as an appearance of selectable option 762d different from as shown in FIG. 6BB and/or FIG. 6CC. For example, the electronic device optionally displays the selectable option with a gray fill, ceases display of a color fill included in the first visual appearance, and/or displays the selectable option with a level of brightness that is less than the level of brightness included in the first visual appearance. In some embodiments, some characteristics of the first and the third visual appearance are the same. For example, the first and third visual appearance optionally include a same icon displayed with different levels of saturation and/or brightness. Visually indicating whether the one or more respective criteria are not satisfied indicate that the transition effect optionally will not be presented, thus reducing user inputs attempting to enable the transition effect, thereby conserving power consumption of the electronic device and making interaction with the electronic device more efficient.

In some embodiments, the transition effect comprises, in accordance with a determination that the setting is configured with the first configuration associated with a first type of transition effect, the transitioning from presentation of the first media content to presentation of second media content is based on the first type of transition effect, such as the transition effect being presented as shown in FIG. 6CC. For example, the electronic device optionally detects that a user setting managed by an operating system of the electronic device is configured to present the mixing and/or “DJ” type of transition effect. Accordingly, when the electronic device detects input directed to the selectable option that corresponds to the first type of transition effect, the electronic device optionally enables and/or disables the first type of transition effect between media content. In some embodiments, in response to detecting input directed to the selectable option such as input that is maintained for a period of time greater than a threshold period of time (e.g., 0.1, 0.2, 0.3, 0.4, 0.5, 1, or 1.5 seconds), the electronic device displays a menu with first content that corresponds to the first type of transition effect. For example, the menu optionally includes one or more selectable options that are more specific to the first type of transition effect, such as a selectable option for selecting a mood or qualitative energy level of content intelligently selected by the electronic device, a selectable option for prioritizing beat matching between the first media content and content queued for playback, and/or a toggle for added audio effects (e.g., reverb, stutters, record scratching sounds, and/or some combination thereof). In some embodiments, in response to detecting input directed to a respective selectable option included in the menu, the electronic device performs one or more operations associated with the selected selectable option. For example, the electronic device optionally changes selection criteria used to curate future content (e.g., queuing first content corresponding to a first mood or queuing second content, different from the first content, corresponding to a second, different mood, queuing first content based on first range of beat matching or queuing second content based on a second, wider range of beat matching) and/or disables presentation of some portions of audio effects included in the transition effect.

In some embodiments, the transition effect comprises, in accordance with a determination that the setting is configured with the second configuration associated with a second type of transition effect, different from the first type of transition effect, the transitioning from presentation of the first media content to presentation of second media content is based on the second type of transition effect, such as the transition effect being presented as shown in FIG. 6BB. For example, the electronic device optionally enables or disables a cross-fading effect between the first media content and next-played media content based on whether the selectable option is enabled or disabled, and/or based on whether the selectable option is displayed with the second appearance when selection of the selectable option is detected. Using different types of transition effects enriches user experience and reduces user inputs that otherwise may be required to navigate to a settings user interface to select the different types of transition effects and/or enable or disable the transition effects.

In some embodiments, while presenting (e.g., playing back) the second media content and after ceasing the presentation of the transition effect in response to detecting the one or more inputs changing the playhead position relative to the first media content, such as after the ceasing of the transition effect performed in response to detecting input 618 as shown in FIG. 6G, and in accordance with a determination that the playhead position relative to the second media content satisfies the one or more first criteria relative to the second media content, including a criterion that is satisfied when the playhead position is within a respective threshold amount of time of an end of the second media content, the electronic device initiates presentation of a respective transition effect, wherein the respective transition effect includes transitioning from presenting of the second media content to presenting of third media content, different from the second media content, such as the transition effect presented in response to playhead 608c advancing past threshold 610c as shown in FIG. 6L. For example, when the input scrubbing relative to the first media content is detected after the playhead position is past the pivot point (described further herein), the electronic device optionally continues presentation of the second media content and/or ceases presentation of the first media content. Additionally or alternatively, in some embodiments, when scrubbing input is detected while the first media content is being presented (e.g., played back) and the transition effect including presenting the second media content is ongoing, the electronic device maintains the presenting of the first media content and/or ceases the presenting of the second media content. In such embodiments, the electronic device optionally updates the playhead position relative to the first media content in accordance with the scrubbing inputs.

In some embodiments, after interrupting the transition effect between the first and the second media content, the electronic device disables the transition effect while presenting the first media content, and/or reenables the possibility of presenting the transition effect when playback of the second media content begins. For example, the electronic device optionally ceases the presentation of the transition effect as described with reference to method 700, and optionally does not again present the transition effect while the first media content is being played. After the first media content concludes, the electronic device optionally initiatives playback of the second media content. While the second media content is being presented, and in accordance with a determination the one or more first criteria are satisfied, the electronic device optionally presents a transition effect (e.g., the respective transition effect). Stated an addition way, the electronic device optionally presents the transition effect that transitions between the second and the third media content when the playhead position satisfies the one or more first criteria described with reference to method 700. In some embodiments, the respective threshold amount of time has one or more characteristics similar to or the same as the threshold amount of time described herein. For example, the respective threshold amount of time is optionally a same amount of time as the threshold amount of time. Additionally or alternatively, the respective threshold amount of time is optionally dynamic, and/or dependent upon characteristics of the second and/or the third media content. In some embodiments, the respective transition effect has one or more characteristics that are similar to or the same as one or more characteristics of the transition effect between the first and the second media content. Presenting the transition effect when transitioning between additional tracks lends a consistency to consumption of media content and reduces user input required to manually cause the transition, thereby reducing processing required to perform operations related to the user input.

In some embodiments, while presenting the first media content, the electronic device displays, via the display generation component, a first visual representation of the first media content, such as representation 601 as shown in FIG. 6B. For example, the electronic device optionally displays a picture, a graphic, video, an animation, text, and/or some combination thereof that correspond to the first media content. As examples, the electronic device optionally displays album art, a snippet of a looping video from a music video, and/or video included in the first media content during playback of the first media content. In some embodiments, the electronic device transitions from the representation of the first media content to a representation of the second media content.

In some embodiments, in accordance with the determination that the playhead position relative to the first media content satisfies the one or more first criteria, the electronic device displays, via the display generation component, a second visual representation of the second media content, different from the first visual representation of the first media content, such as representation 601b as shown in FIG. 6D, wherein the presentation of the transition effect includes transitioning from the displaying of the first visual representation of the first media content to the displaying of the second visual representation of the second media content, such as from FIG. 6C to FIG. 6D. For example, the electronic device optionally displays the second visual representation of the second media content when the playhead position reaches the pivot point. In some embodiments, the second visual representation has one or more characteristics similar to or the same as described with reference to the first media content, but is optionally based upon the second media content. For example, the second visual representation is optionally album art corresponding to an album that includes the second media content. In some embodiments, as described with reference to the cross-dissolve visual effect, the transition effect includes visually changing from representing the first media content to representing the second media content in the media playback user interface. In some embodiments, the transition effect includes scaling the first visual representation and/or the second visual representation over time, such as shrinking album art corresponding to the first media content while initiating display of and/or enlarging the album art corresponding to the second media content. In some embodiments, the transition effect includes ceasing display and/or reducing an opacity of the first visual representation, and/or initiating display and/or increasing opacity of the second visual representation. In some embodiments, during the transition effect, the first and the second visual representations of corresponding media content are displayed concurrently or are displayed sequentially (and not displayed concurrently). In some embodiments, the transition effect includes displaying a particle effect, including displaying of one or more pixels with a simulated glow and/or a color. Additionally or alternatively, the transition effect optionally includes a simulated smoking effect, in which one or more portions of the user interface are displayed with a colored, opaque overlay with one or more feathered edges mimicking the appearance of smoke overlaying the user interface.

In some embodiments, some of the above-described visual transition effects are displayed when a transition mode corresponds to a first transition mode, and other of the above-described visual transition effects are displayed when a transition mode corresponds to a second, different mode (e.g., the transition modes described with reference to gapless and/or DJ transition modes). For example, in accordance with a determination that the transition mode corresponds to a DJ transition effect, the electronic device optionally performs the cross-dissolve between first album art and second album art corresponding to the first and the second media content, respectively. In accordance with a determination that the transition mode corresponds to a gapless transition effect, the electronic device optionally does not perform the transition effect and/or optionally displays the second album art replacing the first album art, forgoing display of the cross-dissolve. In some embodiments, the visual transition included in the transition effect at least partially includes displaying an animation of one or more colors swirling throughout the media player user interface, similar to or the same as an animation displayed when generating a collection of content items as described with reference to method 900. Displaying a visual transition visually indicates that the transition effect is ongoing, thus reducing the likelihood that the user erroneously attempts to interrupt the transition effect.

In some embodiments, while presenting the first media content, the electronic device displays, via the display generation component, a first visual representation of first lyrics corresponding to the first media content, such as first lyrics 666 as shown in FIG. 6T. For example, the electronic device optionally displays lyrics corresponding to the first media content while the first media content is being presented, and in response to detecting selection input of a virtual or hardware button corresponding to enabling the display of the lyrics included in the media player user interface. In some embodiments, the electronic device displays text corresponding to currently presented and/or upcoming lyrics included in the first media content. In some embodiments, the lyrics that are currently or are recently sung or presented by the electronic device are displayed with a visual appearance indicating their temporal relevance, such as with a level of opacity higher than, a relatively higher level of brightness, a different color, and the like as compared to displayed, but not-yet played back lyrics. In some embodiments, as the presentation and/or playback of the first media content progresses, the electronic device ceases display of lyrics corresponding to portions of the first media content that have already been played. In some embodiments, the electronic device concurrently initiates display of newly upcoming lyrics. In some embodiments, the currently displayed lyrics are changed in accordance with input(s) scrubbing through the first media content, such that the current and/or immediately upcoming lyrics are displayed in the media player user interface.

In some embodiments, in accordance with the determination that the playhead position relative to the first media content satisfies the one or more first criteria, the electronic device displays, via the display generation component, a second visual representation of second lyrics corresponding to the second media content, different from the first visual representation of the first lyrics corresponding to the first media content, wherein the presentation of the transition effect includes transitioning from displaying the first visual representation of the first lyrics corresponding to the first media content to displaying the second visual representation of the second lyrics corresponding to the second media content, such as displaying lyrics corresponding to second content associated with scrubber bar 604 as shown in FIG. 6V. For example, the electronic device optionally initiates transition from the first media content to the second media content, optionally including ceasing display of the first visual representation of the first lyrics and/or initiating display of the second visual representation of the second lyrics (e.g., in response to the playhead position reaching the pivot point by way of playback (e.g., instead of by way of scrubbing input(s)). Thus, the electronic device is capable of visually transitioning between lyrics of media content items. At times, reference is made to the first lyrics and/or second lyrics being displayed and/or not being displayed-it is understood that such references optionally include displaying and/or not displaying respective visual representations of the first and/or the second lyrics. For example, displaying the first lyrics optionally includes displaying text corresponding to the lyrics.

In some embodiments, the electronic device changes the level of visual prominence of the first and/or second lyrics relative to the media player user interface during the transition effect. In some embodiments, the level of visual prominence includes a level of brightness, saturation, opacity, a blurring radius and/or a magnitude of a blurring effect, and/or some combination thereof. For example, the electronic device optionally decreases the level of opacity of the first lyrics and/or optionally increases the level of opacity of the second lyrics during the transition effect, optionally terminating in the cessation of display of the first lyrics and/or the display of the second lyrics with the level of visual prominence of the first lyrics (e.g., before the transition effect was initiated). In some embodiments, the time at which the level of visual prominence of the second lyrics begins to exceed the level of visual prominence of the first lyrics corresponds to the pivot point described above.

In some embodiments, in response to detecting input(s) scrubbing through the first media content and after the transition effect is initiated, the electronic device maintains display of the lyrics corresponding to whichever media content is relatively higher volume. For example, in accordance with a determination that scrubbing input is detected before the playhead position reaches the pivot point and while the transition effect is ongoing, the electronic device optionally maintains display of the first lyrics, increases the level of visual prominence of the first lyrics to a level that was displayed prior to the transition effect, and/or forgoes the display of the second lyrics that otherwise are included in the transition effect. In accordance with a determination that the scrubbing input is detected after the scrubbing input is detected and while the transition effect is ongoing, the electronic device optionally ceases display of the first lyrics and/or increases the level of visual prominence of the second lyrics. Changing the displayed lyrics visually indicates whether the playhead position is before or after the pivot point and/or visually indicates that the transition effect is ongoing, thus reducing the likelihood user input erroneously interrupts the transition effect, thereby reducing processing required to perform operations related to the erroneous interruption.

In some embodiments, the one or more first criteria include a criterion that is satisfied when the playhead position is within the threshold amount of time of the end of the first media content while a setting associated with playback position corresponds to a first configuration, such as a the first configuration (e.g., “Transition mode: DJ”) as shown in FIG. 6P. For example, the setting associated with the playback position optionally corresponds to a transition effect configuration. In some embodiments, the electronic device detects input such as directed to a settings user interface associated with the operating system of the electronic device requesting changing of the configuration, such as from the first configuration to a second configuration, or vice-versa. In some embodiments, the configuration dictates the manner in which the electronic device transitions between media content items during the transition effect.

In some embodiments, while presenting (e.g., playing back) the first media content, and in accordance with a determination that a playhead position relative to first media content satisfies one or more second criteria, different from the one or more first criteria, relative to the first media content, including a criterion that is satisfied when the playhead position is within a threshold amount of time (e.g., a threshold that is the same or different from the threshold described with reference to method 700) of an end of the first media content, and a second criterion that is satisfied when the setting corresponds to a second configuration, different from the first configuration, initiating presentation of a respective transition effect, wherein the respective transition effect includes transitioning from presentation of the first media content to presentation of the second media content, different from the first media content, such as a setting configuration corresponding to the second configuration (e.g., “Transition mode: Gapless”) as shown in FIG. 6Q. For example, the setting optionally indicates that the transition effect corresponds to a cross-fade mode. In some embodiments, the cross-fade mode is a fixed length transition mode, and presenting a transition effect based upon the cross-fade mode includes crossfading between content items over a period of time that is the same irrespective of the particular media content items. In some embodiments, the cross-fade mode does not include one or more aspects of a DJ transition mode. In some embodiments, the DJ transition mode has one or more characteristics similar to or the same one or more characteristics described with reference to method 700 (e.g., the DJ mode transition duration is based upon the duration, tempo, and/or musical characteristics of the content items that the electronic device is transitioning between). In some embodiments, the setting optionally indicates that the transition effect corresponds to a gapless mode, different from the cross-fade and/or the DJ mode. In some embodiments, the gapless mode includes presenting the second media content immediately after the first media content concludes, without concurrently playing the first and/or second media content and/or without changing characteristic(s) of the first and/or second media content items. In some embodiments, the duration of the transition effect for different configurations and/or modes of transition are different, such as a longer duration for the DJ mode compared to the cross-fade mode, or vice-versa.

In some embodiments, the second one or more criteria have one or more characteristics similar to or the same as the one or more second criteria described herein. In some embodiments, the electronic device presents the respective transition effect in accordance with the setting described above. For example, the electronic device optionally performs a DJ transition effect when the setting corresponds to a first configuration and/or does not perform a cross-fade transition effect (e.g., despite any similarities between the DJ and cross-fade effects). Additionally or alternatively, the electronic device optionally forgoes presentation of the DJ transition effect in accordance with a determination that the setting configuration corresponds to a gapless transition effect. Presenting the transition effect in accordance with a setting configuration provides the user flexibility in their media content consumption, thus reducing cognitive load and/or improving clarity of media content.

In some embodiments, the transition effect includes concurrently presenting the first media content and the second media content, such as the concurrently presenting of first content 606a and second content 606b as shown in FIG. 6F. In some embodiments, while the transition effect is ongoing, the electronic device displays, via the display generation component, a scrubber bar, wherein the one or more inputs corresponding to changing of the playhead position are detected while displaying the scrubber bar, such as scrubber bar 604b as shown in FIG. 6F. In some embodiments, the scrubber bar is displayed with a start time and/or an end time corresponding to a duration of currently presented content. In some embodiments, the start and/or end time correspond to the true duration of the recorded media content, as opposed to a truncated duration associated with the gradual transition effect from the first media content to the second media content. For example, prior to initiating the transition effect, the electronic device displays a scrubber bar in a manner similar to or the same as described above. In some embodiments, the scrubber bar reflects the first media content start time, end time, and/or the playhead position relative to the first media content when the playhead position is before the pivot point. In some embodiments, the electronic device changes the scrubber bar to correspond to the second media content when the playhead position reaches and/or is after the pivot point. In some embodiments, while displaying the scrubber bar corresponding to the respective media content described with reference to method 700 (e.g., corresponding to either the first media content when the playhead position is before the pivot point, or the second media content when the playhead position is after the pivot point), the electronic device detects the one or more inputs scrubbing the playhead with respect to the respective media content.

In some embodiments, in response to detecting the one or more inputs, in accordance with a determination a first volume corresponding to the first media content is greater than or equal to a second volume corresponding to the second media content when the one or more inputs are detected, such as the volumes indicated by glyphs 612b and 612c as shown in FIG. 6F, the electronic device displays the scrubber bar corresponding to the first media content. For example, the electronic device optionally displays the scrubber bar optionally corresponding to the respective media content described above, and optionally facilitates scrubbing the playhead position with respect to the respective media content. In some embodiments, the scrubbing input(s) are detected while the first volume of the first media content is greater than second volume of the second media content (e.g., before reaching the pivot point). In such embodiments, the electronic device optionally changes the playhead position with respect the first media content, and/or optionally forgoes the presentation of the second media content, thus optionally ceasing the transition effect.

In some embodiments, in response to detecting the one or more inputs, in accordance with a determination the first volume corresponding to the first media content is less than the second volume corresponding to the second media content when the one or more inputs are detected, the electronic device displays the scrubber bar corresponding to the second media content, such as the volumes indicated by glyphs 612c and 612d as shown in FIG. 6M. In some embodiments, the scrubbing input(s) are detected while the first volume of the first media content is less than second volume of the second media content (e.g., after the playhead position reaches the pivot point, based upon the playback of the first media content rather than a scrubbing input). In such embodiments, the electronic device optionally changes the playhead position with respect the second media content, and/or optionally forgoes the presentation of the first media content, thus optionally ceasing the transition effect.

In some embodiments, in response to detecting input scrubbing through the respective media content the electronic device maintains and/or initiates display of the scrubber bar corresponding to the media content that is audibly dominant at the time the input is detected. For example, in response to detecting movement of a contact on a trackpad, a touch screen, and/or movement of an air gesture in a first direction by a first amount, and when input movement is initially detected before the playhead position reaches the pivot point, the electronic device optionally advances or pulls the playhead position back relative to the first media content in a second direction by a second amount (e.g., an amount of time and/or direction of scrubbing is based upon distance and/or direction of input movement). For example, the electronic device optionally maintains display of the scrubber bar corresponding to the first media content initiates the transition effect 30 seconds before the end of the first media content, optionally detects the scrubbing input 20 seconds before the end before reaching the pivot point positioned at 15 seconds before the end of the first media content, and/or optionally moves the playhead position forward 10 seconds in response to detecting a first swiping of a contact on a touchscreen. As an additional example, the electronic device optionally detects the same input while the transition effect is ongoing and after the playhead position passes the pivot point due to content playback (e.g., instead of scrubbing inputs). In the additional example, the electronic device optionally changes the scrubber bar from corresponding to the first media content to the second media content in response to the input (e.g., or the input is detected while the scrubber bar already corresponds to the second media content). In response to the input detected after the playhead reaches the pivot point, the electronic device optionally scrubs through the second media content -instead of the first media content-by the requested 10 seconds. It is understood that the electronic device optionally performs similar operations with respect to additional or alternative media content, additional or alternative pivot points, additional or alternative input(s) requesting different amounts of scrubbing, and/or some combination thereof. Displaying the scrubber bar in accordance with the playhead position relative to the pivot point when scrubbing input is detected reduces the likelihood that the user erroneously initiates and/or ceases playback of media content they would like to consume, thus reducing user input and related processing to handle the input required to correct for the erroneous initiating and/or ceasing of playback.

In some embodiments, the one or more first criteria include a criterion that is satisfied when the playhead position has not been changed in accordance with user input during the presentation of the transition effect, such as a criterion satisfied when the playhead 608b that has advanced to the position shown in FIG. 6G without detecting input directed to scrubber bar 604b. For example, the electronic device optionally does not present a transition effect in accordance with a determination that input, such as scrubbing input(s), are detected while the transition effect is ongoing. Additionally or alternatively, the electronic device optionally does not present the transition effect in accordance with a determination that the transition effect was previously interrupted by such scrubbing input(s), at least until the user expressly reinitiates playback of the beginning of media content.

In some embodiments, after detecting the one or more inputs changing the playhead position relative to the first media content, while the playhead position is within the threshold amount of time of the end of the first media content, and in accordance with the determination that the one or more first criteria are not satisfied, the electronic device forgoes presentation of the transition effect, such as indicated by glyphs 612b and 612c as shown in FIG. 6G indicating content corresponding to scrubber bar 604c is not being presented. For example, as described above, the electronic device optionally does not present the transition effect.

In some embodiments, after reaching the end of the first media content, presenting second media content, different from the first media content without presenting the transition effect, and while presenting the second media content, in accordance with a determination that the playhead position relative to the second media content satisfies one or more second criteria, different from the one or more first criteria, including the criterion that is satisfied when the playhead position is within a respective threshold amount of time of the end of the second media content, the electronic device initiates presentation of the transition effect, wherein the transition effect includes transitioning from presentation of the second media content to presentation of third media content, different from the second media content, such as the transition effect illustrated by glyphs 612c and 612d from FIG. 6L to FIG. 6M. For example, because the transition effect is not performed, the electronic device initiates playback of the second media content following conclusion of the presentation of the first media content.

For example, the electronic device optionally enables presentation of the transition effect between the second media content and the third media content, even when the transition effect is disabled with respect to additional or alternative media content. In some embodiments, the presenting of the second media content and/or the transition effect between the second and the third media content have one or more characteristics similar to, or the same as described with reference to presenting of the first media content and/or the transition effect between the first and the second media content. In some embodiments, the one or more second criteria are related to the playhead position relative to the second media content. In some embodiments, in response to detecting scrubbing input and while the transition effect between the second and the third media content is ongoing, the electronic device ceases presentation of the transition effect and/or disables presentation of the transition effect until the second media content concludes. In some embodiments, the one or more second criteria have one or more characteristics similar to or the same as one or more characteristics of the one or more first criteria described with reference to method 700. In some embodiments, the respective threshold amount of time has one or more characteristics similar to, or the same as the threshold amount of time described with reference to method 700 and/or the respective threshold amount of time described above. Disabling the transition effect in response to detecting a scrubbing input during a transition effect reduces manual user input otherwise required to disable the transition effect, thereby reducing the processing required to perform operations related to the manual user input.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 900) are also applicable in an analogous manner to method 700 described above with respect to FIG. 7. For example, the operation of displaying a presenting a transition effect described above with reference to method 700 optionally has one or more of the characteristics of selecting media content using one or more machine learning models and/or generating collections of content items described herein with reference to other methods described herein (e.g., method(s) 900 and/or 1100). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, initiating operation 702 and 708, detecting operation 704, and ceasing operation 710 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners. In some embodiments, an electronic device is in communication with one or more input devices, a display generation component, and wireless circuitry. In some embodiments, the electronic device presents a user interface for a media player application that facilitates consuming, searching for, and/or generating collections of content items. The embodiments described below provide ways in which an electronic device facilitates consuming, searching for, and/or generating collections of content items. Searching for content items and/or generating collections of content items reduces the user inputs required to separately search for content items and/or add the content items into a collection. It is understood that people use devices. When a person uses a device, that person is optionally referred to as a user of the device.

FIGS. 8A-8R illustrate exemplary ways in which an electronic device displays search user interfaces for media content according to some embodiments. The embodiments in these figures are used to illustrate the processes described below, including the processes described with reference to FIG. 7 and/or FIG. 9. Although FIGS. 8A-8R illustrate various examples of ways an electronic device is able to perform the processes described below with respect to FIGS. 7 and/or 9, it should be understood that these examples are not meant to be limiting, and the electronic device is able to perform one or more processes described below with reference to FIGS. 7 and/or 9 in ways not expressly described with reference to FIGS. 8A-8R.

FIG. 8A illustrates embodiments of a user interface for a media player application. FIG. 8A illustrates an electronic device 500 that is in communication with a display generation component 504 (e.g., a touchscreen). In some embodiments, the electronic device 500 is a mobile device, such as a smartphone, tablet, or wearable device. In some embodiments, display generation component 504 is a touchscreen, a non-touch sensitive display, and/or a projected display in which images are cast into a physical environment of a user of the electronic device 500.

In FIG. 8A, electronic device 500 displays user interface 802, which optionally corresponds to a user interface for a media player application. For example, the media player application optionally facilitates playback and/or presentation of media, including audio, images, video, and/or playback controls to modify the playback of media content. Additionally or alternatively, the media player application optionally facilitates generating collections of content items and/or searching for content items. In some embodiments, the media player application facilitates playback of audio such as songs, poetry, podcasts, and/or the like. In some embodiments, user interface 802 includes representations of content that are being presented (e.g., played back). It is understood that dependent upon the context, description of electronic device 500 presenting media content optionally includes playing back the media content, and vice-versa.

As described with reference to FIGS. 8A-8E and 8L-8R, in some embodiments, electronic device 500 receives inputs such as keyboard, dictation, and/or handwritten inputs, and displays a plurality of search results based upon the query. In some embodiments, the query is a natural language query, and electronic device 500 presents selectable options that, when selected, cause electronic device 500 to display information associated with the query and/or generate collections of content. As described with reference to FIGS. 8F-8K, in some embodiments, electronic device 500 generates and/or receives indications of collections of content and displays content items included in the collection, such as collections that are generated based upon one or more machine learning models at electronic device 500 and/or at one or more devices such as servers in communication with electronic device 500.

As described above, electronic device 500 optionally displays a user interface 802 for a media player application, such as shown in FIG. 8A. In FIG. 8A, user interface 802 includes a plurality of representations of media available for consumption of a user of electronic device 500. For example, user interface 802 in FIG. 8A includes representation of collections of content items-at times referred to herein as “mixes” such as “Get up mix” and/or representations of albums, such as “Rapboy.” In some embodiments, user interface 802 includes a plurality of selectable options that, when selected, respectively cause the electronic device 500 to initiate display of a user interface and/or of content included in the user interface for the media player application. In FIG. 8A, for example, electronic device 500 optionally detects selection input 804 directed to a selectable option 851 including text (e.g., “Search”).

In FIG. 8B, electronic device 500 displays a user interface for searching for media content items, as described further with reference to method 900. In FIG. 8B, user interface 802 includes a search bar 806, to which the electronic device 500 detects an input providing a search query. In some embodiments, search bar 806 includes text indicating the types of queries and/or information for which electronic device 500 is able to search (e.g., “artists, songs, lyrics, and more” in FIG. 8B). In some embodiments, the search interface includes a plurality of results 810. In some embodiments, the results 810 include one or more recently-searched and/or-selected representation of artists and/or media content, such as “Julian M.” and “Mary cat” in FIG. 8B. In some embodiments, electronic device 500 ceases display of the recently searched suggestions in response to detecting input directed to the search bar. For example, in FIG. 8B, electronic device 500 detects input 808 directed to search bar 806, which optionally is or corresponds to a touch input directed to a touch screen corresponding to display generation component 504. Additional or alternative description of inputs are presented herein, when describing method 900.

From FIG. 8B to FIG. 8C, electronic device 500 detects one or more inputs entering a query directed to search bar 806. For example, electronic device 500 optionally detects one or more inputs directed to a keyboard, a microphone, a virtual or physical surface for entering simulated handwriting, and/or some combination thereof after detecting input 808 in FIG. 8B. In response to receiving the one or more inputs, electronic device 500 optionally displays representations of the user's input, such as text 853. In FIG. 8C, electronic device 500 displays “What are Robert Chen,” in accordance with input directed to the virtual keyboard displayed below search bar 806.

In some embodiments, electronic device 500 displays a plurality of suggested terms associated with media content in response to detecting inputs directed to search bar 806. For example, in FIG. 8C, electronic device 500 displays suggestions 811, associated with the query “What are Robert Chen.” In some embodiments, the suggestions 811 are tailored to a specific context in accordance with a determination that the electronic device 500 is displaying the search interface associated with media content. For example, suggestions 811 include a term “next,” in accordance with a determination that a user of electronic device 500 and/or other users interacting with similar search interfaces have searched for an artist's next album release. Additionally or alternatively, suggestions 811 in FIG. 8C include the term “evolution,” associated with a common phrase relating to an artist's revolution. Additionally, suggestions 811 in FIG. 8C include the term “popular,” in accordance with a determination that such a phrase is commonly used to query for popular content. As described further with reference to method 900, electronic device 500 optionally employs one or more machine learning models to generate an understanding of the query represented in search bar 806, and/or optionally generates the terms that potentially relate to media content queries that are included in suggestions 811.

In some embodiments, electronic device 500 displays a plurality of search results 810, such as in FIG. 8C. In FIG. 8C, search results 810 optionally include information, representation of entities responsible for creating or publishing media content, individual titles of media content, images, video, and/or graphics associated with such entities and/or media content, and/or one or more suggested search strings. For example, search results 810 in FIG. 8C include a first suggested search “Robert Chen,” a selectable option and/or graphic corresponding to an artist named Robert Chen (e.g., “Robert Chen Artist”). Additionally or alternatively, search results 810 includes an album associated with the queried artist (e.g., “Isotonic”). In some embodiments, search results 810 in FIG. 8C are displayed based upon matching of metadata (e.g., content related to the artist “Robert Chen”). In some embodiments, search results 810 are partially or entirely based upon results of one or more machine learning models that parse the query entered represented in search bar 806, and/or generate an understanding of the natural language meaning of the query and/or what the query is likely to correspond to, as described with reference to method 900.

From FIG. 8C to FIG. 8D, electronic device 500 detects additional input adding to the natural language query. For example, electronic device 500 detects additional keyboard inputs, including text 853 that corresponds to a request for entry of the letter “e.” Accordingly, electronic device 500 updates the search results 810 from FIG. 8C to FIG. 8D, presenting a plurality of terms that are likely to be associated with content for media content. For example, electronic device 500 optionally determines and/or receives an indication that one or more machine learning models such as large language models (LLMs) generated an output indicating that the query is likely alluding to a request to discover “eras” of artistic evolution of an artist, as indicated in suggestions 811 in FIG. 8D. In FIG. 8D, electronic device 500 updates search results 810 to include a plurality of related search results. For example, electronic device 500 displays a selectable representation corresponding to a list of songs performed by the artist during a concert (e.g., “Setlist: Robert Chen Tour”).

Additionally or alternatively, search results 810 include and/or are displayed concurrently with selectable option 812 and/or selectable option 814 in FIG. 8D. In some embodiments, the one or more machine learning models and/or the electronic device determines that the query of the user is qualitative and/or complex, as described in further detail below with reference to method 900. In such embodiments, selecting search results based upon metadata matching the query to metadata of content items is supplemented by parsing the query, and the electronic device 500 provides additional information and/or options to generate content that potentially is associated with the natural language query.

In FIG. 8D, selectable option 812, when selected optionally causes the electronic device 500 to display information that is generated to provide contextual information that is potentially associated with the user's query and/or includes part of the contextual information. In FIG. 8D, selectable option 814 optionally includes text indicating that a mix that will be generated in response to detecting selection of selectable option 814, optionally indicating that the mix will include content related to an era in the artist's musical development (e.g., a period during which the artist held a world tour (e.g., “Cheneration Tour”)). In FIG. 8D, electronic device 500 detects selection input 816 directed to selectable option 812, and/or detects selection input 818 directed to 814, such as contact with a touch screen corresponding to display generation component 504.

In FIG. 8E, electronic device 500 initiates display of information contextualizing the search results. In some embodiments, electronic device 500 displays information that relates to the user's query, such as shown in FIG. 8E (e.g., “What are Robert Chen's Eras in Music” and the corresponding information 820, “He's known for several ‘Chenerations’”). In FIG. 8E, electronic device 500 ceases display of selectable option 814, but in some embodiments, electronic device 500 maintains display of selectable option 814 in response detecting input 816. In FIG. 8E, search results 810 are also selected based upon the information 820. For example, in FIG. 8E, search results 810 are optionally content items that correspond to content items included in information 820, and/or are associated with information 820 by virtue of a relationship between a concert tour, album, and/or another event that is described in information 820 such as an award show. Additional descriptions of the search user interfaces are described immediately below, such as with reference to FIG. 8N. Additional description of FIG. 8F and other figures are included further below.

FIG. 8N illustrates additional or alternative embodiments associated with the search user interface described above. In FIG. 8N, electronic device 500 has detected input directed to search bar 806, including a request to type a string of characters (e.g., “som”). In response to detecting the input, electronic device 500 optionally determines that the query is incomplete, and accordingly temporarily does not display a plurality of search results based upon the query (although it is understood that in some embodiments, the search results 810 in FIG. 8N updated in response to individual inputs adding to the query). Accordingly, search results 810 in FIG. 8N are optionally based upon previous searches performed by electronic device 500.

In FIG. 8O, electronic device 500 detects additional input, such as touch input directed to the keyboard included in user interface 802. In some embodiments, in response to detecting the input, the electronic device 500 optionally appends text 857 to the query displayed in search bar 806. In some embodiments, the electronic device 500 updates search results 810 including a first result that includes the word included in the query (e.g., “somewhere Samantha Richards” in response to the query “somewhere”). In FIG. 8O, electronic device 500 forgoes display of the selectable option that, when selected, causes the electronic device 500 to display contextual information associated with a query, for example, because one or more criteria are not satisfied (e.g., as described further with reference to method 900). For example, in FIG. 8O, because the query is too short and/or one or more machine language models are unable to probabilistically determine a meaning of the query (e.g., because the query is a lone word), electronic device 500 optionally determines that a confidence score and/or another probabilistic indication is insufficient, and attempting to display information associated with the query is less likely to be satisfactory for the user's interests.

From FIG. 8O to FIG. 8P, electronic device 500 detects input adding additional content to the query included in search bar 806. In FIG. 8P, because the one or more machine learning models typically used to parse and/or determine a context of the query have not yet produced results that are likely of interest to the user, electronic device 500 initiates display of selectable option 854, which, when selected, optionally causes the electronic device 500 to invoke one or more additional machine learning models and/or to incorporate inputs from different informational sources. For example, the “voice assistant” indicated by selectable option 854 is optionally able to access information available over the internet, while the one or more machine learning models run locally at electronic device 500 are optionally reliant upon information stored at the electronic device 500 (e.g., browsing patterns, previous searches, content consumption, locally stored trained models configured to parse the user's query, and/or the like). In FIG. 8P, electronic device 500 detects selection input 856 directed to selectable option 854, and optionally initiates a search for content items in accordance with one or more machine learning models different from those used to parse the user's query and/or provide information, as described with reference to FIG. 8D and/or FIG. 8F.

FIGS. 8Q and 8R illustrate embodiments in which electronic device 500 detects different types of queries, and optionally presents search results based upon a nuanced understanding of those queries. For example, in FIG. 8Q, the one or more machine learning models are used to parse the input query (e.g., “The beats covers”). In FIG. 8Q, because the one or more machine learning models are trained and/or configured to understand that the intent of the query likely corresponds to a set of content that is different than a set of content determined based on metadata matching, electronic device 500 displays search results 810 in FIG. 8Q. For example, electronic device 500 optionally displays a first search result 858 in FIG. 8Q, corresponding to a song that is performed by an artist specified in the query. Similarly, second search result 860 and third search result 862 optionally are also performed by the artist specified in the query. Search results 810 in FIG. 8Q (e.g., generated based upon the natural language understanding of the query) are optionally different from search results that are displayed based upon metadata-matching search at least because electronic device 500 is optionally able to determine that the query means to include songs in the search results that are originally recorded by artists other than the queried artist (e.g., the songs are “covers” of other songs). Accordingly, search results 810 in FIG. 8Q include search results that optionally pertain to a natural language understanding, and optionally do not include search results that are possibly inconsistent with the intent of the query, such as a song performed by an artist that is not specified in the query and/or songs that were originally performed by the artist specified in the query.

In FIG. 8R, electronic device 500 has detected input directed to search bar 806 specifying a qualitative query, such as a mood that is optionally engendered by listening to certain content. For example, electronic device 500 optionally displays the text “break up songs” included in search bar 806 in FIG. 8R in response to such input. Additionally or alternatively, in response to the aforementioned input, electronic device 500 optionally displays a plurality of search results 810 associated with the mood. For example, the one or more machine learning models running at electronic device 500 and/or at a server in communication with electronic device 500 optionally determine that phrase “break up” optionally corresponds to a severing of a romantic relationship, which potentially engenders feelings of anger, sadness, despair, and/or the like. Accordingly, the results of the one or more machine learning models are optionally used to identify songs that are optionally associated with the mood, and/or the results are optionally used as inputs to additional or alternative machine learning models to identify such songs. In FIG. 8R, electronic device 500 displays search results 810, which optionally correspond to songs that include certain progressions of chords, lyrics, tempos, song structures, were recorded by artists that experienced events and/or personal developments that relate to the query (e.g., and/or experienced such events at a time the songs were recorded), and/or some combination thereof. Thus, electronic device 500 is capable of identifying qualitative information in a user's query, and/or optionally presents search results that correspond to the qualitative information.

Turning back to FIG. 8F, in some embodiments, electronic device 500 generates and/or displays representation of content items that comprise a collection of content generated at least in part using one or more machine learning models. For example, electronic device 500 optionally detects input 818 in FIG. 8D directed to selectable option 814, and in response to detecting the input, the electronic device 500 optionally generates collection 830 of content items in FIG. 8F. In some embodiments, intermediate to displaying the collection 830 and the input 818 (and/or in response to detecting input 818), electronic device 500 displays an animation (e.g., as described with reference to method 900). In FIG. 8F, the animation includes with information such as identification of a theme (e.g., “Geometric Robert Chen” corresponding to a titular song from a series of albums corresponding to the same name) included in user interface 802.

Additionally or alternatively, in FIG. 8F, electronic device 500 displays a plurality of selectable options that, when selected, respectively cause the electronic device 500 to perform operations related to the collection 830. For example, selectable option 824, when selected, causes the electronic device 500 to store the collection 830 in a library of mixes and/or collections associated with a profile of a user account that is logged into electronic device 500. Additionally or alternatively, in FIG. 8F, electronic device 500 displays selectable option 828, which, when selected, optionally causes the electronic device 500 to initiate playback of a content item included in collection 830. In FIG. 8F, electronic device 500 detects input 826 selecting selectable option 828, requesting initiating of playback of media content included in collection 830. Additionally or alternatively, in FIG. 8F, electronic device 500 detects input 822 directed to selectable option 824 requesting saving of the collection 830, and detects input 832 corresponding to a dragging and/or moving of contact on a touch screen to scroll through collection 830.

FIG. 8G illustrates the result of operations the electronic device 500 performs in response to detecting the inputs illustrated in FIG. 8F. For example, electronic device 500 optionally initiates playback, as indicated by the playback controller 837 in FIG. 8G, of a content item included in collection 830 shown in FIG. 8F. Additionally or alternatively, in response to detecting input 832 in FIG. 8F, electronic device 500 in FIG. 8G has scrolled upwards, initiating display of additional or alternative content items included in the collection 830. In some embodiments, in response to detecting the input scrolling upwards, electronic device 500 ceases display of one or more elements of user interface 802 shown in FIG. 8F, such as ceasing display of selectable option 824. In FIG. 8G, electronic device 500 detects input 834, directed to a hardware button included in electronic device 500 that is selectable to perform one or more operations associated with electronic device 500.

In FIG. 8H, electronic device 500 displays a lock screen user interface included in user interface 802 in response to detecting the input 834 that is illustrated in FIG. 8G. In FIG. 8H, electronic device 500 detects input 836, optionally directed to the same hardware button used to lock the electronic device 500 in FIG. 8G. In FIG. 8I, in accordance with a determination that input 836 is maintained for a period of time greater than a threshold period of time (e.g., 0.01, 0.025, 0.05, 0.075, 0.1, 0.125, 0.15, 0.3, or 0.5 seconds), electronic device 500 invokes a voice assistant indicated by electronic device 840, and/or optionally detects input such as voice input corresponding to the information 838 displayed in FIG. 8I.

In FIG. 8J, electronic device 500 initiates playback of information corresponding to the voice input detected in FIG. 8I. For example, electronic device 500 uses the one or more machine learning models associated with the search user interface described above (e.g., and/or without using one or more machine learning models managed by and/or corresponding to the voice assistant, such as models that use the internet as an informational source). In FIG. 8J, as indicated by playback control 842, electronic device 500 initiates playback of a song that is selected based on the machine learning model(s) parsing keywords and/or an intent of the query in FIG. 8I, and/or matching the intent to lyrics included in a song represented in playback control 842. In FIG. 8J, electronic device 500 displays a notification 844 in response to receiving an indication of a message and/or of a notification from another electronic device, such as a cell phone or a head mounted wearable device. In FIG. 8J, notification 844 indicates that a user associated with the other electronic device has shared a mix (e.g., a collection of content items) generated at and/or initially received at the other electronic device, and electronic device 500 detects selection input 846 directed to the notification 844.

From FIG. 8J to FIG. 8K, electronic device 500 initiates display of user interface 802 including information associated with the notification 844. For example, in FIG. 8K, electronic device 500 displays user interface 802 associated with a broad theme (e.g., modern pop) that is related to content items included in the collection of content items shared by the other device. In FIG. 8K, electronic device 500 displays information 852 indicating the other user. In some embodiments, the electronic device 500 facilitates interaction with the collection of content illustrated in FIG. 8K in a manner that is similar to, or the same as the manner of interactions with user interface 802 as shown in FIG. 8F. In FIG. 8K, electronic device 500 detects an input 848 directed to selectable option 850, which is optionally selectable to navigate away from the collection of content received from the other electronic device.

In FIG. 8L, in response to detecting the input 848 as shown in FIG. 8K, electronic device 500 initiates display of user interface 802, corresponding the plurality of search results last displayed as described with reference to FIG. 8D. In FIG. 8L, however, search results 810 are optionally different from the search results illustrated in FIG. 8D. The difference in search results is optionally based upon one or more factors described with reference to method 900, such as the one or more machine learning models used to identify search results being non-deterministic models. In FIG. 8L, electronic device 500 detects input 816 directed to selectable option 814. I

In FIG. 8M, electronic device 500 displays user interface 802 corresponding to a mix of content items that is different from the mix of content items illustrated in FIG. 8F. For example, the one or more machine learning models used to generate the collections of content items are optionally non-deterministic, and electronic device 500 optionally displays different content items in response to detecting repeated selections of a same selectable option (e.g., selectable option 816 in FIG. 8L). As an example, the collection of content items illustrated in FIG. 8M are optionally based upon a different chapter in the artistic evolution of the artist that corresponds to the query illustrated in selectable option in FIG. 8L (e.g., corresponding to the “Volcano” tour of Robert Chen). In FIG. 8M, electronic device 500 detects inputs 826, 822, and/or 832, and optionally initiates one or more operations similar to or the same as the operations described with reference to similar inputs illustrated in FIG. 8F.

FIG. 9 illustrates a flow diagram illustrating a method in which an electronic device displays search user interfaces for media content according to some embodiments. The method 900 is optionally performed at an electronic device and/or electronic devices such as device 100, device 300, or device 500 as described above with reference to FIGS. 1A-1B, 2-3, 4A-4B and 5A-5H. Some operations in method 900 are, optionally combined and/or order of some operations is, optionally, changed.

In some embodiments, a method 900 is performed at an electronic device in communication with one or more input devices and a display generation component, such as electronic device 500 in communication with display generation component 504 as shown in FIG. 8A. For example, the electronic device, the one or more input devices, and/or the display generation component optionally have one or more characteristics of the electronic device(s), the one or more input devices, and/or the display generation components described with reference to method 700.

In some embodiments, while displaying, via the display generation component, a media user interface, the electronic device detects (902), via the one or more input devices, first one or more inputs specifying a natural language query (e.g., a search query to search for content available at the electronic device via the media user interface), such as the query included in search bar 806 as shown in FIG. 8C. For example the media user interface optionally is or includes a music player and/or content browsing/playback user interface. For example, the music player user interface optionally includes a plurality of selectable options that are optionally respectively selectable to initiate display of visual representations and/or information describing media content items and/or collections of media content items available for consumption of a user of the electronic device. In some embodiments, the music user interface includes a selectable option to initiate a search for media, such as a magnifying glass that is selectable. In response to detecting a selection input (e.g., as described with reference to method 700), the electronic device optionally initiates display of a search user interface included in the music player user interface. In some embodiments, in response to detecting input(s) directed toward the search user interface such as touch and/or voice input described further herein, the electronic device initiates a search for media content. In some embodiments, the natural language query specified by the first one or more inputs includes human language including words, phrases, and/or questions, and/or sentences that the electronic device uses to tailor results of a media content search to correspond to the natural language query. In some embodiments, the search interface includes a plurality of representations of media content that the user recently searched for and/or played, such as a representation of an artist, an album, a song, a collection of content generated in accordance with a previous search, and/or some combination thereof. In some embodiments, the search interface includes one or more representations of respective categories of media, such as genres of music, moods associated with the media, an artist associated with the category of the media, and/or some combination thereof. In some embodiments, while displaying the search interface, the electronic device concurrently displays a representation of a music player, including one or more of: media corresponding to currently playing and/or currently paused media (e.g., album cover art, a graphic, video, and/or some combination thereof), information corresponding to the media such as a track title and/or a file name, and/or one or more playback controls, such as a pause, a play, a fast forward, and/or a rewind buttons. In some embodiments, the electronic device detects selection input directed toward some or all of the representation of the music player and initiates display of an expanded view of the music player, as described further herein.

In some embodiments, the search interface includes a search bar that is selectable to initiate searching for media content that the user is able to consume. For example, the electronic device optionally detects selection input(s) including touch input directed to a touch screen and/or a trackpad, a voice input, a selecting of a virtual or physical button, an air gesture (e.g., described with reference to method 700), and/or attention including gaze of a user of the electronic device directed toward the search bar, and in response to detecting the selection input, initiates display of the recently searched media and/or queries. In some embodiments, in response to detecting the selection of the search bar, the electronic device ceases display of other aspects of the search user interface, such as the representation of the categories of media available for consumption by the user and/or the display of the representation of the music player. In some embodiments, however, the electronic device maintains display of the representation of the music player in response to the selection of the search bar. In some embodiments, the electronic device displays a representation of a keyboard in response to detecting the search bar selection. In some embodiments, in response to detecting input(s) directed toward the keyboard, the search bar populates with text corresponding to the detected keyboard input(s). In some embodiments, the electronic device additionally or alternatively detects voice input, and in response to detecting the voice input populates the search bar with text corresponding to the detected voice input. It is understood that the entry of various input including input directed to a virtual keyboard, voice, and/or selection of button(s) are optionally included in the first one or more inputs described herein.

In some embodiments, in response to detecting the first one or more inputs (904), the electronic device displays (906), via the display generation component, a plurality of representations of content corresponding to the natural language query, such as included in search results 810 as shown in FIG. 8C. For example, in response to detecting text entry directed to the keyboard, voice input, and/or some combination thereof, the electronic device optionally displays a representation of a collection of search results, such as a list of search results, a grid of search results, a rotating carousel of search results, and/or some combination thereof. In some embodiments, the first one or more inputs partially complete a query, and the electronic device displays search results that dynamically update as the user continues to add detail to the query. In some embodiments, the collection includes one or more search suggestions based upon the first one or more inputs (e.g., when the query can be expanded upon and/or appears incomplete). For example, the electronic device optionally generates and/or obtains information indicative of a parsing of text specified by the first one or more inputs. The information optionally corresponds to a plurality of prospective search queries that are of potential interest to the user, such as metadata-related information and/or natural language processing-related information. The metadata-related information, for example, optionally includes an album, artist, song, track number on an album, composer, producer, genre, and/or play count of the media. As an example, the electronic device optionally detects input searching for “the” and in response optionally displays a first search suggestion including text “the banana boat” corresponding to a popular first album entitled “The Banana Boat.” In response to detecting input searching for “more,” without detecting the input indicating “the,” the electronic device optionally forgoes display of the first search suggestion in accordance with a determination that the query “more” does not correspond to “The Banana Boat.” In such an example, the electronic device optionally displays a second search suggestions including text such as “Mo' Shekels Mo' Problems” corresponding to a second album, different from the first album. In some embodiments, the search results include results corresponding to individual media content items, playlists, albums, artists, and/or some combination thereof. For example, the search results optionally include pictures, graphics, video, animations, and/or some combination thereof displayed concurrently with titles of corresponding media and/or groups or individuals associated with the media. The search results, for example, optionally includes a first artist name and a picture of the artist and optionally include a first picture of album art corresponding to a first album, both of which are optionally related to the entered search query. In some embodiments, the search results are respectively selectable to initiate playback of a corresponding media content item (e.g., a track included in the search results, a first track of an album included in the search results, a first track of a playlist and/or music mix included in the search results). In some embodiments, in accordance with a determination that a selected search result corresponds to a single content item, the electronic device initiates playback of the selected content item. In accordance with a determination that the selected search result corresponds to a collection of content items (e.g., a mix, a playlist, and/or an album), the electronic device optionally initiates display of a listing of media content item(s) included in the collection and forgoes playback of a respective content item included in the collection until the electronic device optionally detects selection of the respective content item included in the listing of the content item(s).

In some embodiments, in response to detecting the first one or more inputs (804), in accordance with a determination the natural language query satisfies one or more criteria, the electronic device displays (908), via the display generation component, a selectable option that is selectable to generate a collection of content corresponding to the natural language query (e.g., wherein the collection of content includes respective content items different from (e.g., not included in) the content that corresponds to the plurality of representation of the content), such as selectable option 814 as shown in FIG. 8D. For example, the electronic device optionally parses the query using one or more natural language processing models and/or additional or alternative machine learning models to classify and/or determine characteristics of the query. As an example, the electronic device optionally uses one or more machine learning models to recognize words, determine grammar associated with a plurality of words, segment the query into words and/or phrases, extract a meaning of one or more portions of the query and/or perform additional linguistic and/or sentiment analysis of the query and/or optionally obtains information indicative of results of such one or more learning models from other devices, such as servers. As examples, the electronic device optionally tokenizes, labels, lemmatizes, determines word dependencies, parses labels identified based upon the dependencies, and/or identifies and/or extracts entity types from the query such as subjects of the query. The electronic device optionally performs operations to classify, identify a sentiment of the query, identify implicit meanings of the query, score a probability of a connection between portions of the query and identified topics, and/or some combination thereof to parse and understand the content of the query. Based upon the results of such operation(s), the electronic device optionally generates one or more collections of content items that potentially relate to the query. In some embodiments, when the one or more criteria are satisfied, the electronic device displays one or more selectable options that respectively correspond to collections of content items associated with the query. For example, the electronic device optionally detects input(s) specifying a query including “award-winning music from 2020,” and in response to the detection, optionally generates and displays a representation of a collection of music including music content that won a music award in the year 2020. Additionally or alternatively, the query optionally includes, “artist A's less-popular hits,” and the collection optionally includes content items that have fewer streams on a musical platform than a threshold number of streams (e.g., 2500, 5000, 10,000, 25,000, 50,000, 100,000, or 250,000) and/or content items that did not reach a position on media chart (e.g., was not a top-100 song in a country, was not a top 100 song in any country, and/or did not reach a top 10 position on a television chart). In some embodiments, the electronic device automatically generates the collection without detecting additional or alternative inputs other than those required to define the natural language query and/or select a representation corresponding to the collection. Thus, in some embodiments, the electronic device generates collections of content items based upon a nuanced understanding of the query, in addition to or in the alternative to matching metadata such as the artist, song title, album title, media title, producer, and/or year included in a query to corresponding content items.

In some embodiments, the query corresponds to a qualitative query that yields a limited set of search results when the query is strictly matched to metadata keywords. In such embodiments, the electronic device displays the selectable option that is selectable to generate the collection that relates to the query, using one or more natural language processing models to determine a meaning of the query. In some embodiments, the selectable option has one or more characteristics similar to or the same as described with reference to representation of search results herein (e.g., includes text, images, and/or some combination thereof). For example, the selectable option is optionally included in a collection of search results, and optionally includes text that describes a theme and/or characteristic of media content included in the collection of content. As examples, the selectable option optionally includes text describing a mood, an artist, an era of the artist's artistic development, cover songs recorded by an artist, and/or some combination thereof in response to detecting a related query (e.g., “break up Mix,” “Bob Sylvan's greatest hits,” “covers by Bob Sylvan,” and/or “T Swizzle's greatest hits Mix”). In some embodiments, the selectable option includes an image and/or artwork that corresponds to the collection of content. For example, the electronic device optionally determines and/or obtains information from one or more computing devices such as servers that performs generative artificial intelligence operation(s) to analyze visual content associated with the collection of content, such as album art, popular images of an artist that record content items included in the collection, and/or images associated with a respective item often published on social media platforms and optionally generates an image and/or artwork based upon the output of the generative artificial intelligence operations. As an example, the electronic device optionally displays an abstract image with one or more colors included in and/or similar to album artwork associated with the content items included in the collection of content, includes some or all of an image of an artist while the artist was touring and performing a content item included in the collection of content, and/or includes text corresponding to phrases that the user of the electronic device used to search for and select content items from previous searches that are similar to those included in the collection of content items. In some embodiments, the electronic device displays an icon designating that the search result corresponding to the collection is generated based upon the natural language processing of the query.

In some embodiments, in response to detecting the first one or more inputs (804), in accordance with a determination that the natural language query does not satisfy the one or more criteria, the electronic device forgoes (910) displaying of the selectable option, such as not displaying the selectable option 814 as shown in FIG. 8C. For example, the electronic device optionally displays the search results and forgoes display (e.g., does not display) the selectable option corresponding to the collection of content items. In some embodiments, when the natural language query does not satisfy the one or more criteria, the electronic device displays representations of one or more search results that are concurrently displayed when the one or more criteria are satisfied, such as songs that correspond to the query. Displaying the selectable option when the natural language query satisfies the one or more criteria reduces additional user input required to generate the collection of content and reduces the processing and/or power consumption required to display the selectable option and/or perform operations relating to the selectable option when the query does not satisfy the one or more criteria.

In some embodiments, the one or more criteria include a criterion that is satisfied when a length of the natural language query exceeds a threshold length, such as a length of a query longer than the query indicated in search bar 806 as shown in FIG. 8O. For example, the electronic device optionally displays the selectable option in accordance with a determination that the natural language query includes a number of characters, letters, words, and/or phrases that is greater than a threshold number (e.g., 2, 3, 4, 5, 7, 10, 12, or 15 characters, letters, words, and/or phrases). Accordingly, the electronic device optionally uses a length of the natural length query to inform whether or not to optionally surface the selectable option. Displaying the selectable option when the natural language query exceeds the threshold length reduces the likelihood that the selectable option is displayed based upon a low complexity query, thus reducing power consumption required to display the selectable option.

In some embodiments, the one or more criteria include a criterion that is satisfied when the natural language query is associated with a qualitative characteristic associated with one or more content items included in the collection of content, such as the information included in the query indicated in search bar 806 in FIG. 8R (e.g., “break up songs”). For example, the qualitative characteristic includes an emotion, a mood, a type of an event, an activity, a broad descriptor of tempo, a time of day, and/or some combination thereof. In contrast, the criterion associated with a qualitative characteristic is optionally not satisfied when the natural language query corresponds to specific metadata that is matched to content items, such as a year that an album or song is released, and/or a specific number of beats per minute. As an example, when the query corresponds to a “night time drive,” the electronic device optionally selectable option that is based upon the “night time” corresponding to a time of day and/or the “drive” aspect of the query, corresponding to an activity. Additionally or alternatively, the query optionally corresponds to “up-tempo music for dancing at a party celebrating dad,” the electronic device optionally displays the selectable option based upon a determination that the query requests up-tempo music, that the query corresponds to a dancing activity, that the query corresponds to a party event, and/or that the query corresponds to a celebratory emotion and/or context. In some embodiments, the selectable option is displayed in accordance with the determination that query includes a qualitative characteristic of the media, independently of whether the query includes quantitative information and/or metadata, such as a specific tempo, a specific artist, a specific album, and/or some combination thereof. Displaying the selectable option when the query is associated with a qualitative characteristic of content items reduces power consumption required to perform operations related to the selectable option, such as generating the collection of content when the electronic device is capable of displaying content search results that are identifiable without using qualitative characteristics of the query.

In some embodiments, the one or more criteria include a criterion that is satisfied when at least a portion of the natural language query corresponds to information different from metadata associated with one or more content items included in the collection of content, such as information included in the query displayed in search bar 806 as shown in FIG. 8Q (e.g., “covers” by an artist “the beats”). For example, the query optionally includes or optionally corresponds to information that is different from metadata, such as the qualitative characteristic(s) described further herein. In some embodiments, the selectable option is displayed in addition to or in alternative to search results that are displayed when the user of the electronic device provides a query that specify media content metadata, such as an artist, author, media title, album title, year, record label, producer, and/or some combination thereof. It is understood that in some embodiments, the electronic device optionally displays the selectable option in accordance with a determination metadata information is included in the natural language query in addition to other information (e.g., describing a feeling, describing an era of music, and/or describing an event in addition to including metadata-related information). Thus, the electronic device optionally displays the selectable option when artificial intelligence models and/or natural language processing and/or crowdsourcing are used to process and items when operations different from metadata matching are employed to identify the content items. Displaying the selectable option when the natural language query includes information different from metadata visually indicates that content that is tailored to the query is available for consumption that is selected based upon artificial intelligence models, thus reducing user inputs required for the user to identify specific content items based upon several metadata related searches, thereby reduces power consumption required to perform operations associated with the user inputs.

In some embodiments, in response to detecting the first one or more inputs and in accordance with the determination that the natural language query satisfies the one or more criteria, the electronic device displays, via the display generation component, information associated with the natural language query, different from a transcription of the natural language query, that is associated with a plurality of representations of search results, such as information included in selectable option 812 in FIG. 8D and/or information 820 FIG. 8E. In some embodiments, the selectable option that, when selected, causes the electronic device to generate the collection of content is included in the plurality of representations of search results. In some embodiments, the electronic device displays information related to the natural language query, such as a summary of the query and/or information providing context related to the query and/or related to content item search results. In some embodiments, the information additionally or alternatively describes the collection of content items that is generated in response to detecting the selection of the selectable option described with reference to method 700. For example, the electronic device displays the information in a region of the search user interface, such as with an icon and/or boundary that is similar to or the same as an icon and/or boundary associated with a representation of a content item included in search results displayed based upon the natural language query. For example, the natural language query optionally corresponds to text, such as “music award winners in 2021.” In such an example, the electronic device optionally displays a button, icon and/or a search result that includes information describing a specific set of music awards and/or identifies the year. In some embodiments, the information includes text, pictures, and/or video corresponding to related content items, such as a song title and text describing that the song won the best song award of 2021. Additionally or alternatively, the information identifies an album title and/or identifies that the displayed album was the best album of that year. In some embodiments, the information includes an answer to query, such as information describing a birth date and/or horoscope sign in response to detecting input querying for the age and/or “sign” of an artist. In some embodiments, in response to detecting a selection input directed toward the search result corresponding to the contextual information, the electronic device displays additional information that was not previously displayed. For example, the electronic device optionally displays a selectable option included in the search results that represents a collection of content items related to “Berry award winners” based upon a query about Berry award winners from a year or range of years. In response to detecting selection of the selectable option, the electronic device optionally initiates display of one or more representation of content items, individuals, bands, and/or collections of content items that respectively correspond to the “Berry award” winners from the queried year or range of years. Such representation optionally include one or more characteristics of the information related to content items described above. Additionally or alternatively, the information optionally includes descriptive text such as “the 2021 Berry award winners included big wins for new artist Mugs-a-lot, including best new album and best new artist.” In some embodiments, the additional information, when selected, causes the electronic device to display additional information and/or to initiate playback of related content. For example, the electronic device optionally detects selection input directed toward a representation of the album that won the “Berry award” for best new album, and in response, optionally initiates playback of an audio track included in the album and/or initiates display of a listing of the content items included in the album. Displaying information associated with search results provides feedback about the rationale for presenting specific media content items to the user and/or informs the user about content items available for their consumption, thus reducing user inputs required to search for such information, thereby reducing processing required to detect the user inputs.

In some embodiments, while displaying the selectable option that is selectable to generate the collection of content corresponding to the natural language query, the electronic device detects, via the one or more input devices, an input directed to the selectable option, such as input 818 as shown in FIG. 8D. For example, the electronic device optionally detects one or more selection inputs directed to the selectable option, such as described with reference to method 700 and/or 900.

In some embodiments, in response to detecting the input, the electronic device displays, via the display generation component, an animation associated with generating the collection of content, such as an animation corresponding to the transition of user interface 802 from as shown in FIG. 8D to as shown in FIG. 8F, and/or included in the region of the user interface above collection 830 in FIG. 8F. For example, the animation optionally visually indicates that the electronic device and/or device(s) in communication with the electronic device are generating the collection of content items described with reference to method 900. In some embodiments, the animation includes ceasing display of some or all of the plurality of search results that are displayed in response to detecting the natural language query. In some embodiments, the animation includes displaying one or more visual effects at one or more regions of the user interface displayed by the electronic device. In some embodiments, the one or more visual effects include one or more of a pattern fill, a color fill, a changing of a saturation and/or brightness, an application of a simulated lighting effect mimicking lighting sources illuminating regions of the user interface, and/or some combination thereof. In some embodiments, the regions of the user interface that includes the one or more visual effects are changed gradually over time. In some embodiments, when the collection of content items is generated, the electronic device gradually ceases display or some or all of the visual effects. In some embodiments, the animation includes gradually displaying a representation of the content items included in the collection of content. For example, the electronic device optionally ceases display of a colored and/or undulating visual effect beginning from a central portion of the user interface, and/or optionally replaces the display of the visual effect by displaying a portion of a representation of a content item and/or a textual identifier corresponding to the collection of content. In some embodiments, when and/or as the animation concludes, the electronic device displays the representations of content items included in the collection, an identifier of a common theme related to the content items, and a plurality of selectable options to initiate and/or modify playback of the content items, such as a first selectable option that is selectable to initiate playback in accordance with an order of the collection and/or a second selectable option that is selectable to initiate the playback in accordance with a pseudo-random order. Displaying the animation reduces the likelihood that the user provides input erroneously interrupting the generating of the collection of content items, thus reducing user inputs and/or processing required to again-perform the generating of the collection of content items.

In some embodiments, while displaying the selectable option that is selectable to generate the collection of content corresponding to the natural language query, the electronic device detects, via the one or more input devices, a first input directed to the selectable option (e.g., the first input optionally has one or more characteristics of input(s) described with reference to methods 700 and/or 900), such as input 818 as shown in FIG. 8D. In some embodiments, in response to detecting the first input directed to the selectable option, the electronic device displays, via the display generation component, a first plurality of first content items included in a first collection of content that corresponds to the natural language query, such as the collection 830 as shown in FIG. 8F. For example, the electronic device optionally displays the animation described herein, which optionally includes displaying a plurality of first content items associated with a first collection of content items. The first content items are optionally related to a common theme identified based upon the natural language query, such as content items that are determined to match a mood, a tempo, an activity, and the like as determined by one or more natural language models and/or artificial intelligence models (as described further with reference to method 900). In some embodiments, the electronic device displays a portion of the first plurality of first content items, such as in a rows and/or columns, including text, pictures, video, and/or some combination thereof representing the corresponding content item. In some embodiments, the electronic device displays the portion of the first plurality of first content items overlaying and/or adjacent to an images and/or video that is associated with the first collection, such as video of an artist associated with the first collection singing and/or an animated version of an album art is associated with a portion of the first content items. In some embodiments, the video and/or the image is animated, such as using a cross-dissolve visual effect to gradually display the video and/or image. In some embodiments, in accordance with a determination that the first collection of items has been viewed by the user previously, the electronic device forgoes display of the animation, but does display the video and/or the image. In some embodiments, while displaying the first plurality of content items, the electronic device detects one or more inputs navigating through the first plurality of content items, and updates what portion of the first content items are represented in the media player user interface. For example, in response to detecting one or more contacts on a touchscreen, one or more air gestures including movement of an air pose (e.g., a contacting of a plurality of fingers, a pointing and swiping of a finger through the air, and/or a curling of a plurality of fingers), and/or in response to detecting input directed to a joystick included in a controller in communication with the electronic device, the electronic device optionally scrolls through the representation of the first content items, initiating display of representation of previously not displayed content items, and forgoing display of representation of content items that were displayed when the input(s) were detected. In some embodiments, in response to detecting selection input directed to a representation of a content item included in the first content items, the electronic device initiates playback of the selected content item. In some embodiments, the electronic device detects input directed to a selectable option that is displayed concurrently with the first plurality of first content items (e.g., in response to the first input). In some embodiments, in response to detecting the input, the electronic device initiates display of a first content item included in the plurality of content items, thus initiating playback of the collection of content items, Displaying the first plurality of the first content items in response to detecting the first input reduces user input required to manually create the first collection of content items, thereby reducing cognitive load of the user.

In some embodiments, the first collection is generated using one or more artificial intelligence models, and the first content items are included in the first collection based upon the natural language query, such as one or more artificial intelligence models used to parse, determine a meaning of, and display representation of content items related to the query included in search bar 806 in FIG. 8Q and/or FIG. 8R. In some embodiments, the first collection is generated using one or more artificial intelligence models. For example, the electronic device and/or other devices optionally uses natural language processing model(s) to determine the context and/or meaning of the words and/or phrases included in the natural language query. In some embodiments, prior to detecting the input selecting the selectable option associated with initiating generating of the first collection, the first collection of content items is not defined in memory of the electronic device and/or of another device (e.g., a server). In some embodiments, the electronic device determines a pattern of user interactions and/or preferences based on their interactions with the music player application, such as what content has been played in response to certain queries and/or what content the user tends to consume. In some embodiments, the artificial intelligence models and/or the electronic device cross references the meaning of the natural language query with the user preferences, and selects one or more content items to be included in the first content items. In this way, the electronic device optionally facilitates selection of which content items are the first content items based upon a sophisticated understanding of the user's natural language query and/or the user's preferences. Generating the first collection of content using one or more artificial intelligence models reduces user input required to determine and collect content items to include in a collection, thereby reducing processing for the user input and reducing cognitive load required by the user.

In some embodiments, one or more respective first content items included in the first content items are different from one or more respective second content items represented by respective representations of content included in the plurality of representations of content (e.g., that are generated in response to detecting the first one or more inputs), such as one or more content items included in search results 810 as shown in FIG. 8E and one or more content items included in collection 830 as shown in FIG. 8F. For example, the electronic device optionally presents search results related to the natural language query which are different from content items included in the collection of content items generated by the electronic device. In some embodiments, some of the content items included in the search results presented in the search interface are similar to or the same as some of the content items included in the first content items. For example, the electronic device optionally searches for music award winners, and optionally displays in a plurality of search results (e.g., the plurality of representation of content) a first representation of a song that won a musical award in the year 2012, in addition to a second representation of a different song that is entitled “Award Winner.” Thus, the plurality of search results optionally include a mix of content items included based upon metadata matching and/or natural language query parsing. In addition, in response to detecting the query about the music award winners, the electronic device optionally displays the selectable option that is selectable to display a plurality of representation of content items corresponding to award winners from the year 2020. Thus, the electronic device optionally includes first content items in the first collection generated based upon artificial intelligence model(s), and/or optionally includes second, different content items (and/or optionally, some of the same content items) in the plurality of search results that are optionally displayed concurrently with the selectable option that is selectable to generate the first collection of first content items. Described an additional way, the respective first content items included in the first collection are optionally at least partially different from respective second content items included in the search results. Including at least partially different content items in the plurality of search results and the collection of content items that are both based upon a natural language query provides the user with broad and convenient access to various content items, thus reducing user inputs required to browse for the same breadth of content items, thereby reducing power consumption required to detect the user inputs.

In some embodiments, after displaying the first plurality of first content items included in the first collection of content, and while displaying the media user interface, the electronic device detects, via the one or more inputs devices, second one or more inputs specifying the natural language query, such as one or more inputs entering information corresponding to the information displayed in selectable option in FIG. 8L. For example, the electronic device optionally detects a swiping input and/or an input including selection of a button collapsing and/or suppressing display of the first plurality of first content items, such as selecting a “back” button to again-view search results related to the natural language query associated with the first collection of content (e.g., the natural language query entered in response to detecting the second one or more inputs is optionally the same natural language query described with reference to method 900). In some embodiments, the second one or more inputs additionally or alternatively include selection of a search icon included in the media player user interface and/or inputs entering and/or submitting the same natural language query used to generate the first collection.

In some embodiments, in response to detecting the second one or more inputs and in accordance with the determination that the natural language query satisfies the one or more criteria, the electronic device displays, via the display generation component, a second selectable option (e.g., the same as or different from the selectable option) that is selectable to generate a second collection of content corresponding to the natural language query, different from the first collection of content, such as selectable option 814 as shown in FIG. 8L. In some embodiments, the electronic device detects the one more inputs searching for the same natural language query, and in response, displays the second selectable option that corresponds to a second collection of second content items, different from the first collection of content items. Thus, the natural language model(s) and/or artificial intelligence model(s) optionally and dynamically create a collection of content items using the natural language query as a basis to select what content items are included in the collection, and optionally changes the collection in response to detecting repeated entry of the same query. In some embodiments, the second selectable option includes information such as text and/or images that are different from the selectable option that is selectable to generate the first collection of content items. For example, the collections optionally correspond to different “mixes” and/or themes of content; accordingly, the electronic device optionally displays text labelling the name of the mix and/or the theme that is different based upon the content of the collection. As one example, the query optionally includes a “songs for a bad day,” and the selectable option includes first text (e.g., “sad user mix”) and the second selectable option includes second text (e.g., “angry mood mix.”). In some embodiments, the selectable option described with reference to method 900 and the second selectable option are the same selectable option. For example, the selectable option and/or the second selectable option are optionally generic, describing that the user is able to “create a mix” by displaying such text included in and/or adjacent to the selectable option. Displaying a selectable option that is different and corresponds to different content items based upon a first instance or a second instance of submitting a query reduces user inputs required to manually gather such content items twice over, thereby reducing the user's cognitive load.

In some embodiments, in response to detecting the second one or more inputs, the electronic device displays, via the display generation component, a plurality of respective representations of content corresponding to the natural language query, different from the plurality of representations of content corresponding to the natural language query, such as the difference in search results 810 as shown in FIG. 8L as compared to as shown in FIG. 8D. In some embodiments, the electronic device changes which search results are presented when repeating a search using a same natural language query between the various searches. For example, one or more content items represented by the plurality of representations of content are optionally different from the one or more content items represented by the plurality of respective representations of content. Thus, the electronic device optionally displays a first set of search results a first time the search is performed using a particular query, and optionally display a second set of search results a second time that the search is performed using the same query. Therefore, the search results are optionally non-deterministic, and optionally change between different instances of searches using a same query. In some embodiments, the search results differ based upon information that is available when a second search is performed that is not available when the first search is performed. For example, in response to detecting input querying for award winners in the year 2030, the electronic device optionally displays first results and/or does not display a visual indication associated with providing contextual information associated with award winners in the year 2030 when the current year precedes the year 2030 or an event that occurs in 2030. In response to detecting the same input querying for the 2030 award winners after the event occurs, and/or during or after the year 2030, the electronic device optionally displays second search results including representations of media content that won awards at the event and/or a visual indication associated with contextual information that is available because the event has taken place.

Additionally or alternatively, the search results are optionally updated between different instances of searches based upon developments in the user's activity. For example, in addition to the examples described above, the electronic device optionally displays first search results based on an understanding of the user's browsing habits, media consumption, previous searches for media content, and/or some combination thereof. When the electronic device detects input corresponding to the second search, the electronic device optionally displays second search results (e.g., after the first results) the electronic device optionally displays second search results that are optionally at least partially different, based upon updates to the user's browsing habits, media consumption, previous searches for media content, and/or some combination thereof. Additionally or alternatively, the one or more artificial intelligence models used to generate the search results are non-deterministic, and optionally generate different results in response to being fed the same one or more inputs. Thus, due to changes in real-world events, variations in outputs generated by one or more artificial intelligence models, and/or the user's activity, the electronic device optionally displays a representation of at least a first content item in first search results and/or does not display a representation of at least a second content item that is included in second search results in response to detecting input searching for a term or phrase, when the first and the second search results are generated in response to the same input (e.g., the same query for different instances of a search). In some embodiments, one or more items are represented in both the plurality of representations of content and the plurality of respective representations of content. In some embodiments, one or more of the plurality of respective representation of content are not included in the plurality of representations of content. Displaying representations of different content in response to detecting different searches using a same query reduces user inputs required to discover different search results, thereby reducing power consumption required to perform operations in accordance with the user inputs.

In some embodiments, the first one or more inputs are detected while a user account associated with the electronic device corresponds to a first user account, such as a first user account associated with display of search results 810 as shown in FIG. 8D. For example, the user account is optionally associated with an e-mail address and/or is logged into the electronic device and/or a content application including the media user interface. In some embodiments, the user account is associated with ownership of software, is associated with subscriptions such as to media subscription services, and/or is associated with user preferences and/or settings, including -but not limited to-media consumption preferences and tendencies.

In some embodiments, the plurality of representations of content that correspond to the natural language query and are displayed include a first plurality of representation corresponding to a first plurality of content items, such as the search results 810 as shown in FIG. 8D. For example, the content items represented in the search results and/or included in a collection generated in response to detecting selecting of a selectable option displayed concurrently with the search results optionally is at least partially based upon characteristic(s) and/or preferences and/or usage (e.g., content consumption and/or browsing) history associated with an active user account. As an example, the first content items included in the first collection of content items described herein optionally are at least partially based upon preferences and/or usage history of the first account, because the first user account is logged into the electronic device and/or application including the media user interface when the search is initiated. In some embodiments, in accordance with a determination that the active user account is a second user account, different from the first user account, the electronic device displays different search results and/or generates a mix including different content items than are generated if the active user account is the first user account.

In some embodiments, while displaying, via the display generation component, the media user interface, and while the user account associated with the electronic device corresponds to a second user account, different from the first user account, such as a second user account that is logged in and/or associated with electronic device 500 in FIG. 8L, the electronic device detects, via the one or more input devices, second one or more inputs specifying the natural language query, such as information reflected in search bar 806 as shown in FIG. 8L. For example, the first user account is optionally not logged in to the electronic device and/or the second user account is optionally logged in to the electronic device when the second one or more inputs are detected. Additionally or alternatively, the second user account is optionally associated with different preferences, usage history, and/or additional or alternative factors. In some embodiments, the preferences and/or the usage history have one or more characteristics similar to or the same as described with reference to the preferences and/or usage history associated with the first account, but based upon interaction patterns of a user corresponding to the second account. In some embodiments, the second one or more inputs specify the same natural language query that is specified based upon the first one or more inputs.

In some embodiments, in response to detecting the second one or more inputs, the electronic device displays, via the display generation component, a respective plurality of representations of content corresponding to the natural language query, wherein the respective plurality of representations of content include a second plurality of representations corresponding to a second plurality of content items, different from the first plurality of content items, such as the search results 810 as shown in FIG. 8L that are based upon the second user account. For example, the second plurality of content items optionally include one or more content items that are different from the first plurality of items. In some embodiments, the content items included and/or excluded from a respective collection of content items represented by the electronic device based upon the natural language query are based upon user preferences, such as the user preferring not to hear an artist, the user often listening to a specific album, a user expressly indicating a fondness for a genre and/or an artist, and/or some combination thereof. In some embodiments, the electronic device selects the content items to be included in search results and/or collections of content items in accordance with those preferences, such as omitting songs by a disliked artist and/or including songs that are musically similar to songs that the user enjoys. Changing search results and/or content items that are included in a collection based upon an active user profile reduces user input required to add or remove such content items manually, thereby reducing cognitive load of the user.

In some embodiments, while displaying a respective user interface, such as user interface 802 as shown in FIG. 8J, the electronic device receives an indication of a respective collection of content from a respective electronic device, different from the electronic device, such as an indication of a mix received from another device as indicated by notification 844 as shown in FIG. 8J. For example, the indication of the respective collection is optionally included in a message, e-mail, notification, and/or other indication that is communicated from another electronic device to the electronic device. In some embodiments, the respective collection of content has one or more characteristics similar to or the same as the collections of content and/or content mixes described herein. For example, the user of the respective electronic device optionally generates the collections of content and/or content mixes using one or more artificial intelligence models, such as in response to optionally detecting an input directed to a selectable option that is displayed by the respective electronic device in response to detecting a natural language query.

In general, collections of content generated based upon the one or more machine learning models described herein are optionally different from playlists and/or collections of content that are generated in accordance with a plurality of user inputs expressly adding content items to the collections. For example, the electronic device optionally generates the model-generated collections of content selecting a plurality of content items in response to a discrete input such as selecting of the selectable option displays with search results, in contrast to collections of content that are optionally generated based upon a plurality of user inputs selecting a plurality of songs and/or a plurality of user inputs adding such songs to a collection (e.g., individually adding songs from to a playlist). Additionally or alternatively, the content items included in the model generated collections are optionally all associated with a theme that is generated by the electronic device. For example, the electronic device optionally determines the theme of the content based upon a seed such as the natural language query described herein, and the electronic device optionally uses that theme to identify and/or select the content items to be included in the collection. Additionally or alternatively, the electronic device optionally selects content items for inclusion in the collection based upon audio characteristics such as tempo, instrumental style, genre, volume level, and/or additional or alternative characteristics that are optionally selected without the user providing input expressly identifying and/or adding the content items.

It is understood that some of the above-described examples referencing the electronic device generating the collections of content using one or more machine learning models optionally apply to the electronic device at least partially offloading the generating of the collections to one or more servers and/or other devices. For example, the electronic device optionally transmits an indication of the natural language query to a server that generates the collection, and/or optionally receives the collection and/or an indication of the contents of the collection.

In some embodiments, in response to receiving the indication of the respective collection of content, the electronic device displays, via the display generation component, a visual indication corresponding to the respective collection of content from the respective electronic device, such as notification 844 as shown in FIG. 8J. For example, the visual indication is optionally or optionally includes a notification displayed overlaying a user interface displayed by the electronic device, a message received from another user, an icon displayed in a keyboard region of the user interface and/or displayed in the media player user interface indicating that a contact of the user has optionally shared a collection of content, and/or some combination thereof.

In some embodiments, while displaying the visual indication, detecting, via the one or more input devices, an input directed to the visual indication, such as input 846 as shown in FIG. 8J. For example, the electronic device optionally detects a selection input directed to the visual indication.

In some embodiments, in response to detecting the input, the electronic device displays, via the display generation component, a representation of the respective collection that includes information indicating that the respective collection is associated with the respective electronic device, such as the collection included in user interface 802 as shown in FIG. 8K. For example, the electronic device optionally displays an animation and/or displays information corresponding to the respective collection created by a user of the other electronic device, optionally in a manner similar to or the same as described further herein with reference to displaying information and/or representation of content items associated with a collection of content generated by artificial intelligence and/or large language model(s). As one example, the electronic device optionally displays a title of a theme and/or characteristic associated with the content items included in the received collection. Additionally or alternatively, the electronic device optionally displays selectable options to initiate content playback. In some embodiments, the electronic device displays text and/or an icon corresponding to a user account associated with the electronic device that provided the collection, such as a name, a picture, and/or an avatar corresponding to the other user account. In some embodiments, in response to detecting input specifying a query and/or initiating generating of a collection of content using the same query that was used to generate the received, respective collection, the electronic device optionally generates a collection of content items that at least partially differs from the respective collection, due to the difference in preferences associated with the different user accounts that were factors in determining the contents of a collection. Displaying information that indicates a source of the respective collection indicates that the respective collection potentially differs from the user's taste and preferences, and reduces input required to identify the source of the respective collection, thereby reducing processing required to perform operations based on the input.

In some embodiments, while displaying the selectable option that is selectable to generate the collection of content corresponding to the natural language query, the electronic device detects, via the one or more input devices, one or more second inputs, different from the first one or more inputs, including a request to save the collection of content into a library of content associated with the electronic device, such as input 822 as shown in FIG. 8F. For example, the electronic device optionally displays a menu and/or displays an icon to save and/or add the collection of content to a library of content associated with the electronic device, such as a library corresponding to a user account logged in to the electronic device. In some embodiments, the electronic device detects one or more inputs selecting the menu and/or the icon to save the collection. In some embodiments, the electronic device detects voice input saving the collection. In some embodiments, in response to detecting such input, the electronic device saves the collection and/or saves the listing of the content items that is included in the collection. In some embodiments, the collection of content is saved to the library of content without detecting an input expressly saving the collection to the library. For example, the electronic device optionally performs the saving of the collection in response to detecting the input initiating generation of the collection of content, as described with reference to method 900.

In some embodiments, after detecting the one or more second inputs, the electronic device detects, via the one or more input devices, one or more third inputs, different from the one or more second inputs, including a request to display a representation of content included in the library of content, such as an input directed to a selectable option included in user interface 802 as shown in FIG. 8A (e.g., “library”). For example, the electronic device optionally detects selection of a button and/or icon that represents the library of content. In some embodiments, the library of content includes songs, playlists, albums, artists, mixes, and/or other discrete content items and/or collections of content items that the user has saved for consumption.

In some embodiments, in response to detecting the one or more third inputs, the electronic device displays, via the display generation component, a representation of the collection of content corresponding to the natural language query, such as a representation similar to or the same as collection 830 as shown in FIG. 8G. In some embodiments, in response to detecting the one or more third inputs, the electronic device displays information including text, graphics, pictures, video, and/or some combination thereof of the content items saved to the library of content. In some embodiments, the information includes a representation of the collection that was saved to the library. For example, the representation optionally includes a graphic displayed when the collection was generated (e.g., during or at a conclusion of the animation described herein), optionally includes text identifying the collection and/or the theme of the collection, and/or indicates a date that the collection was generated or saved to the library. It is understood that the electronic device optionally detects selection of representation of content and/or collections from the library, and optionally initiates display of listings of the content and/or initiates playback of the content in response to detecting selection of the representation(s) in the library. Facilitating saving of the collection reduces user input required to reconstruct the collection manually, thereby reducing cognitive load of the user.

In some embodiments, in response to detecting a respective input included in the first one or more inputs, the electronic device displays, via the display generation component, one or more first suggested terms associated with the natural language query, wherein the one or more first suggested terms are associated with content managed by a media application corresponding to the media user interface, such as the suggestions 811 illustrated in FIG. 8C. For example, the electronic device optionally detects and/or obtains an indication from a controller that one or more virtual and/or physical keys have been selected and/or that one or more voice inputs have specified one or more terms included in the natural language query. In response to the detecting and/or obtaining the indication, the electronic device optionally displays one or more suggested words or phrases to continue text entry. In some embodiments, the one or more suggested words or phrases are displayed within a user interface element that in for other user interfaces of other applications than the media player application, displays words or phrases related to content that is are not necessarily media content related, such as in a suggestion bar or region adjacent to and/or overlaying a virtual keyboard displayed by the electronic device. In some embodiments, the suggested words are sensitive to the operating context when the respective input is detected, such as being sensitive to the fact that the user is querying the media player for content to consume. Accordingly, some or all of the words or phrases suggested to the user optionally relate to subject matter associated with media content, such as a last name of an artist, a word included in an album title that the electronic device predicts the user is attempting to consume, and/or an event that likely relates to media content that the electronic device predicts the user is attempting to consume. As an example, in response to detecting text entry corresponding to “bill,” the electronic device optionally displays a surname of an artist that the user frequently listens to, and/or forgoes display of “of rights,” in accordance with a determination that the user is searching for media content and not searching for information related to the United States Constitution. Additionally or alternatively, the electronic device optionally detects the respective input corresponding to entry of the string “bat,” and optionally suggests the terms “batter up” corresponding to a popular album sharing the same title, and optionally forgoes display of the word “guano” in accordance with a determination that the user is searching for an album, and is not searching for encyclopedic knowledge related to the mammalian bats.

In some embodiments, while displaying a respective user interface, different from the media user interface, the electronic device detects, via the one or more input devices, second one or more inputs associated with text entry, such as input similar to input that caused entry of information to search bar 806 as shown in FIG. 8C. In some embodiments, in response to detecting the second one or more inputs, the electronic device displays, via the display generation component, one or more second suggested terms, wherein the one or more second suggested terms are different from the one or more first suggested terms, such as terms similar to, but different from the suggestions 811 as shown in FIG. 8C. For example, the electronic device optionally displays the phrase “Bill of Rights” and optionally forgoes the display of the surname of the artist that is displayed while the media player user interface is displayed, such as while an internet browsing user interface is displayed. Additionally or alternatively, the electronic device optionally displays the term “guano” and optionally forgoes display of the terms “batter up” in response to detecting entry of the term “bat,” such as in accordance with a determination that the user is searching for files related to a research paper in a file explorer user interface. Thus, the electronic device optionally offers context-sensitive suggested terms to the user when searching for media content to consume that is optionally not displayed when the user is not searching for media content (e.g., in a user interface other than the media player user interface and/or the media player search interface). Displaying suggested terms that are relevant to the user when searching for media content reduces user input required to enter such terms manually, thereby reducing processing required to perform operations related to the user input

It should be understood that the particular order in which the operations in FIG. 9 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 700) are also applicable in an analogous manner to method 900 described above with respect to FIG. 9. For example, the operation of displaying representations of calendar items described above with reference to method 900 optionally has one or more of the characteristics of presenting transition effects and/or generating collections of content items described herein with reference to other methods described herein (e.g., method(s) 700 and/or 900). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 9 are, optionally, implemented by components depicted in FIGS. 1A-1B. For example, displaying operation 906 and 908, detecting operation 902, and forgoing operation 910 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners. In some embodiments, an electronic device is in communication with one or more input devices, a display generation component, and wireless circuitry. In some embodiments, the electronic device presents content items. The embodiments described below provide ways in which an electronic device generates collections of content items using artificial intelligence and/or machine learning. Generating collections of content items reduces user input otherwise required to browse and discover content items. It is understood that people use devices. When a person uses a device, that person is optionally referred to as a user of the device.

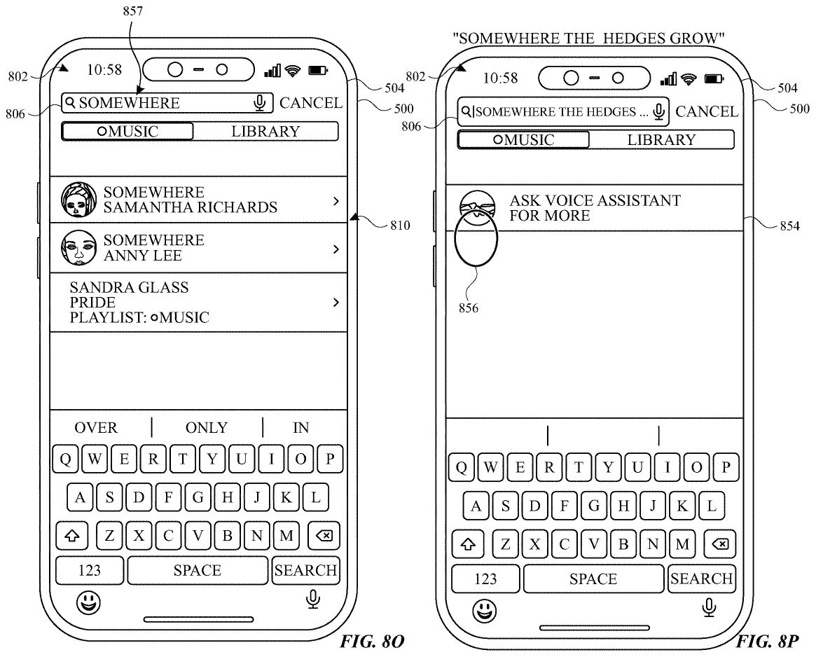

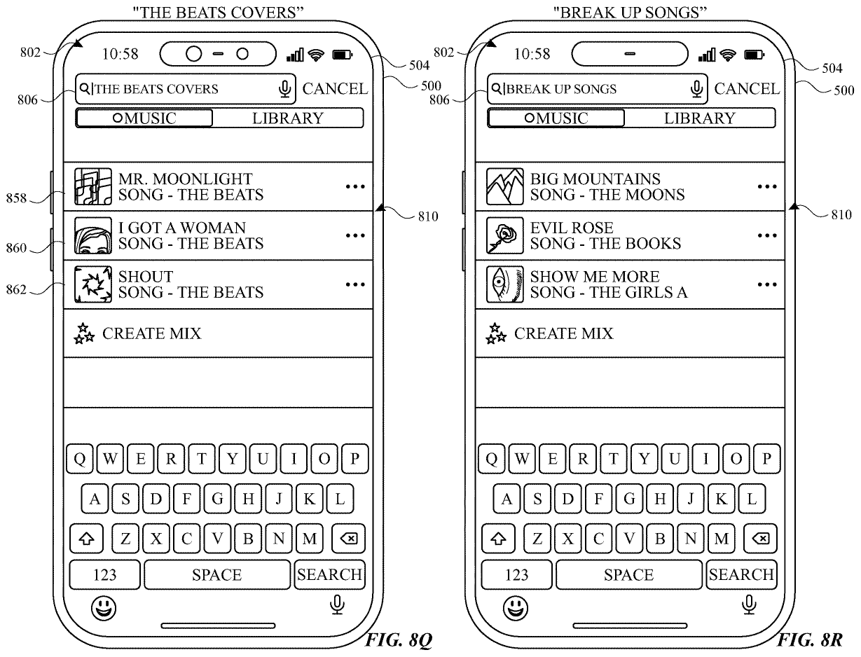

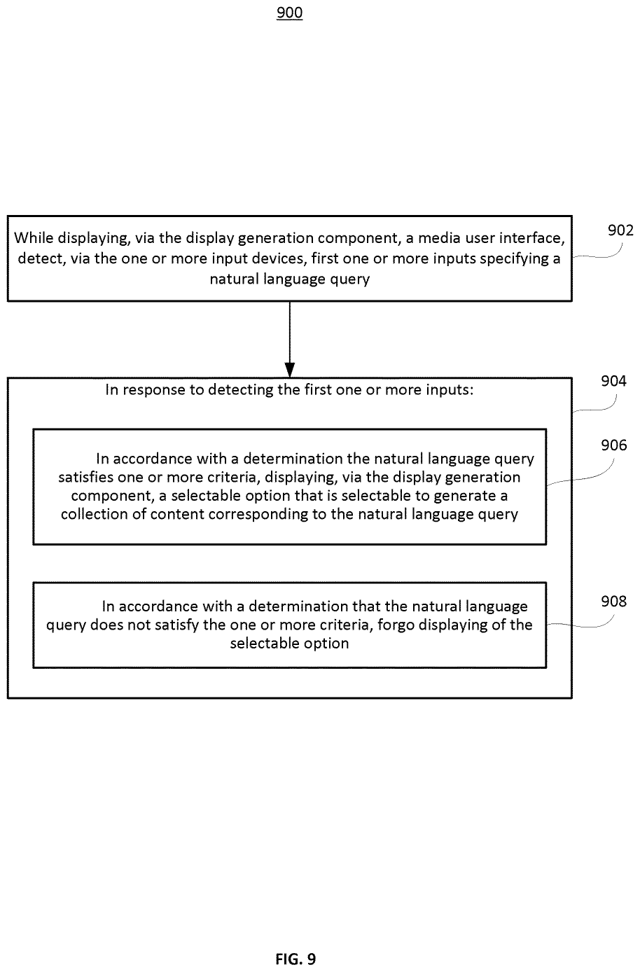

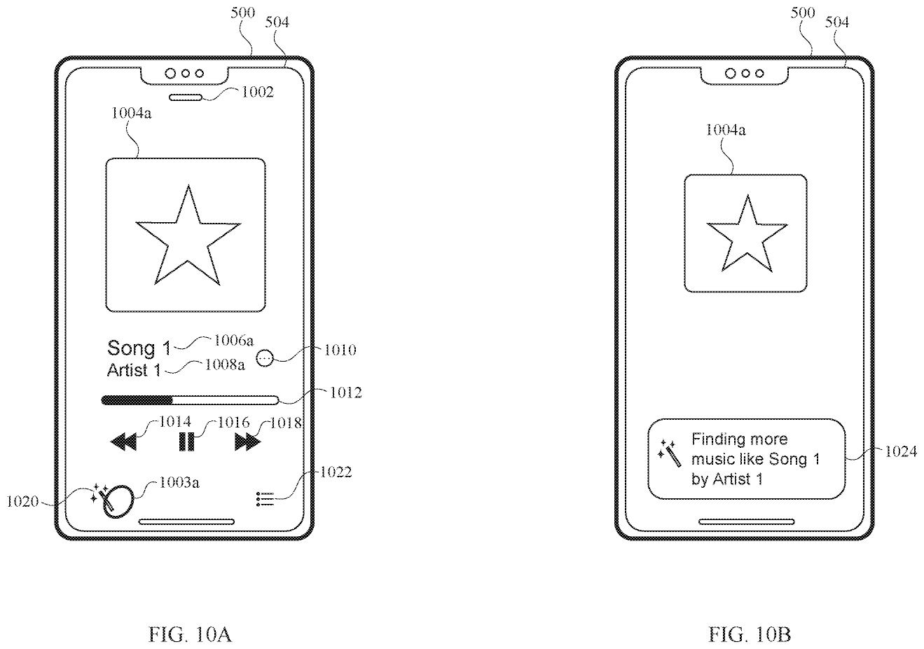

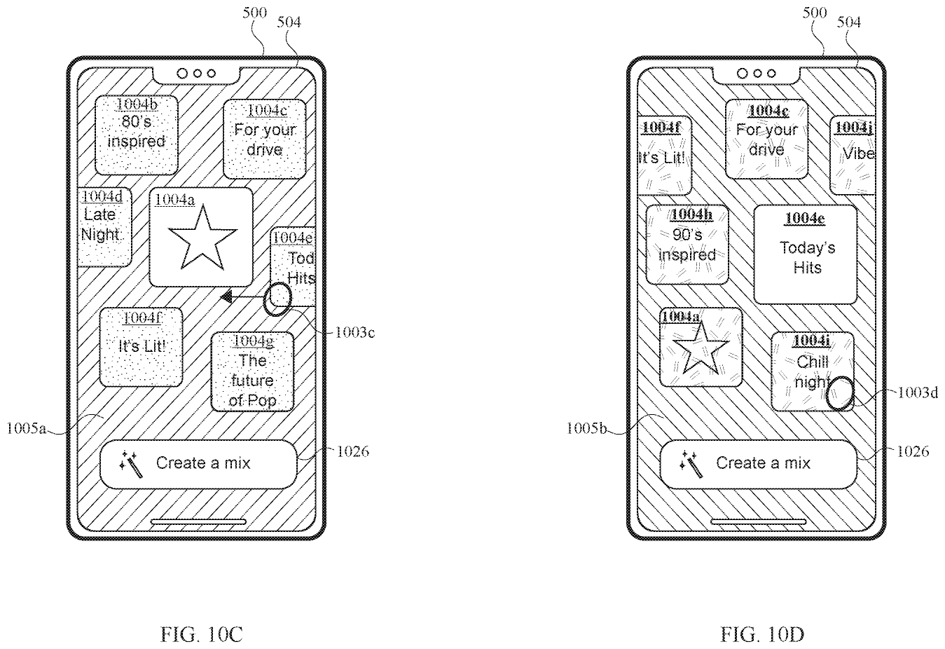

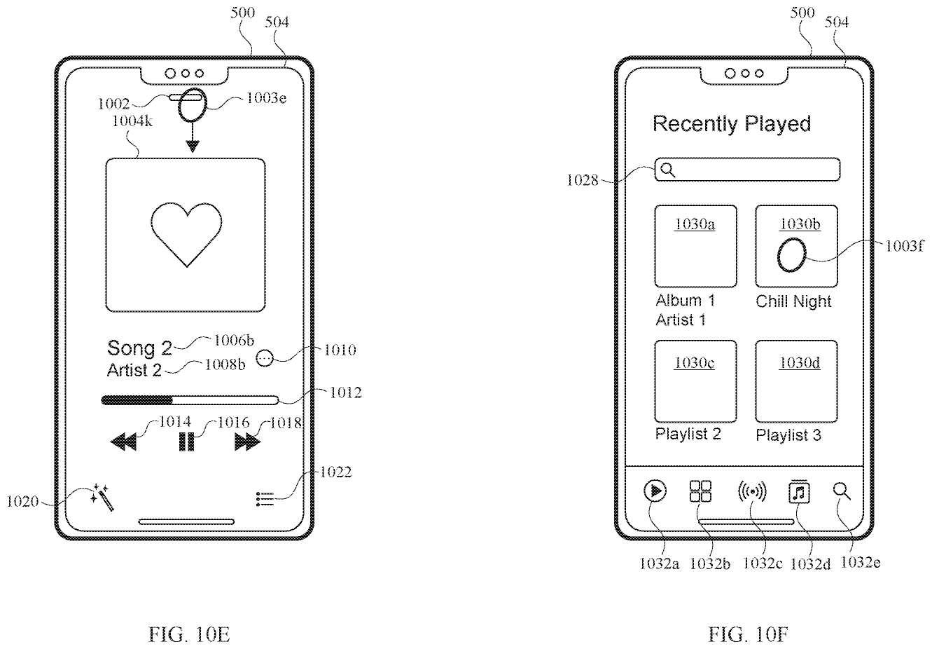

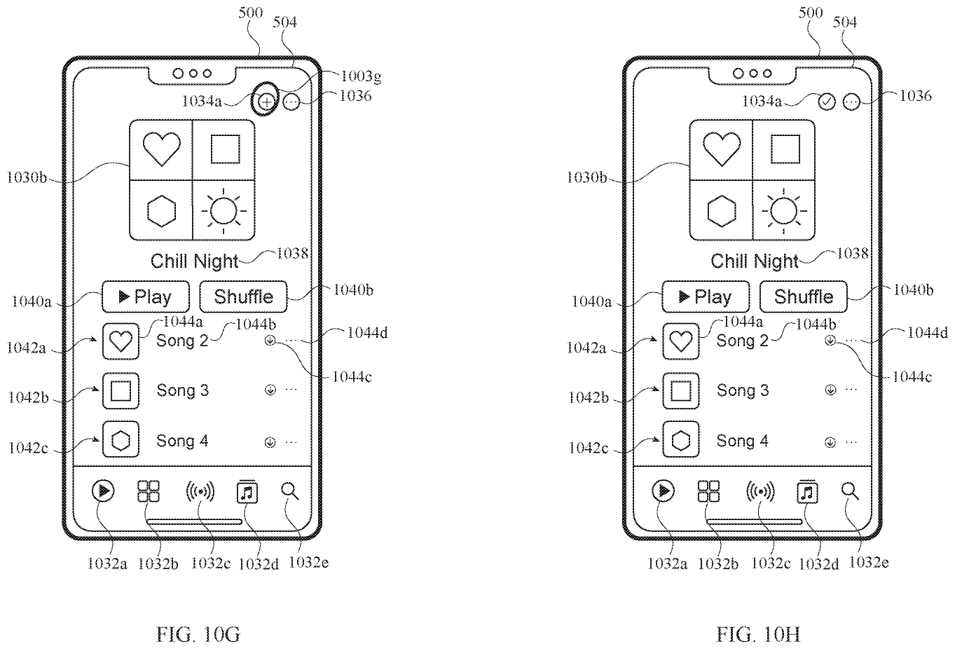

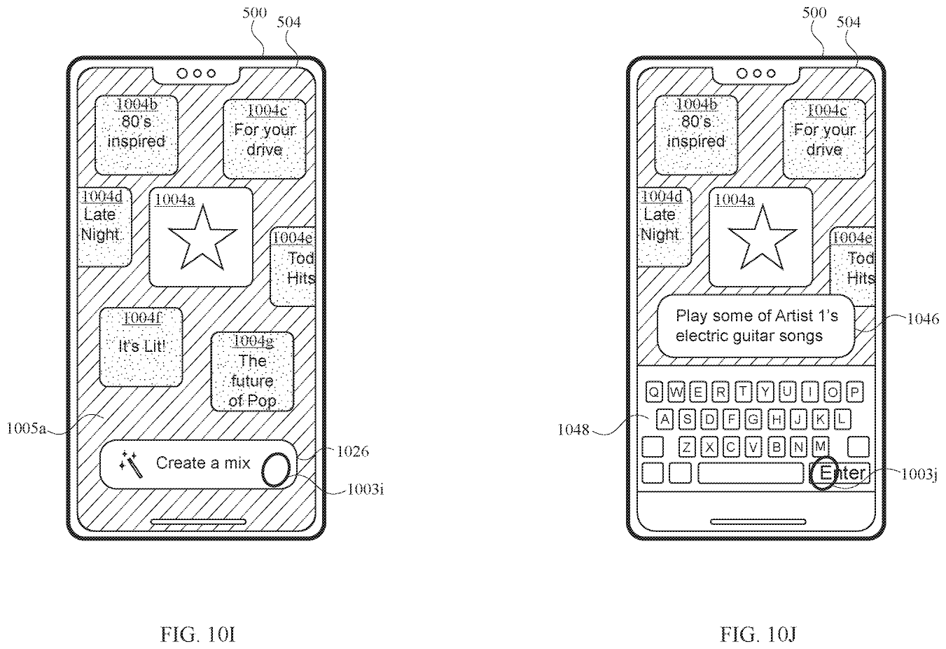

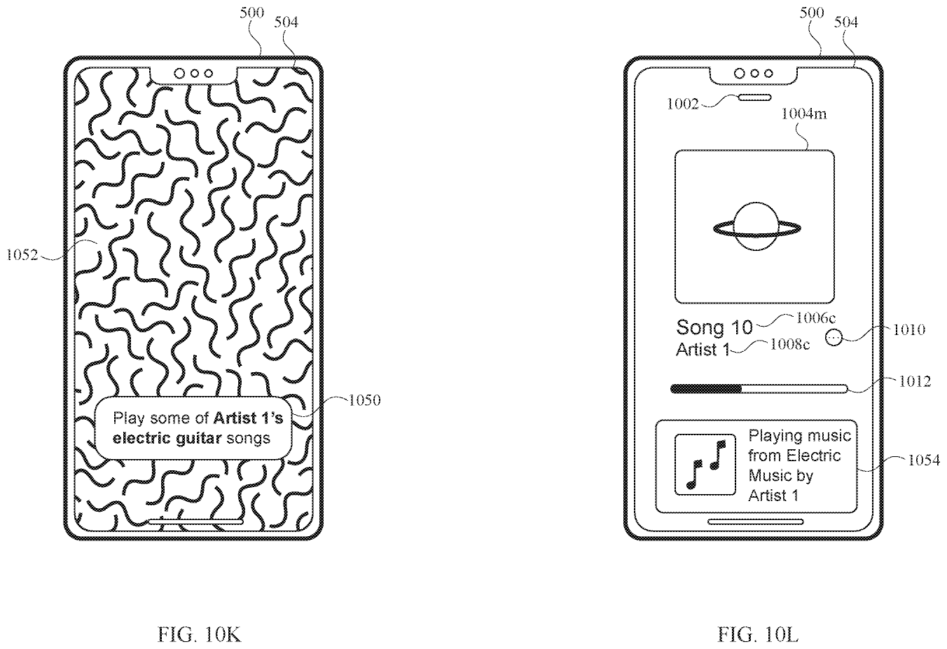

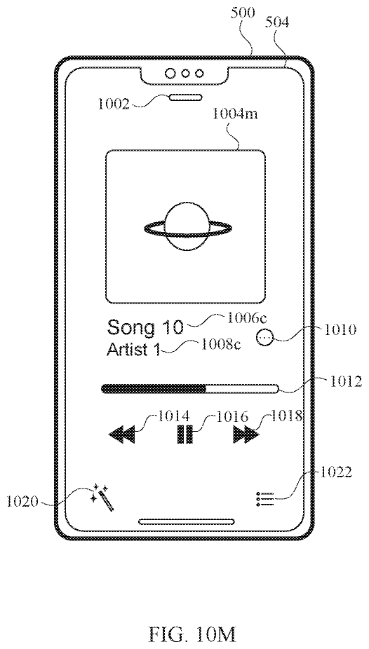

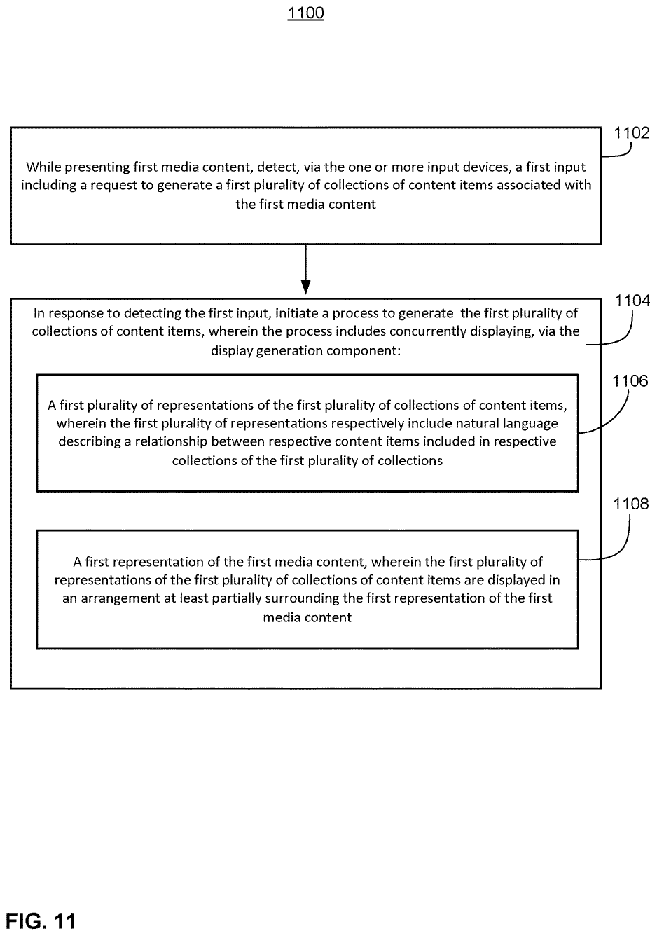

FIGS. 10A-10M illustrate exemplary ways in which an electronic device generates collections of content items and presents representations of generated collections of content items in accordance with some embodiments. The embodiments in these figures are used to illustrate the processes described below, including the processes described with reference to FIG. 11. Although FIGS. 10A-10M illustrate various examples of ways an electronic device is able to perform the processes described below with respect to FIG. 11, it should be understood that these examples are not meant to be limiting, and the electronic device is able to perform one or more processes described below with reference to FIG. 11 in ways not expressly described with reference to FIGS. 10A-10M.

In some embodiments, an electronic device generates collections of content items having one or more characteristics in common as described herein. Characteristics of content items optionally include metadata relating to the content and/or characteristics of the content itself. Examples of metadata include artist(s), producer(s), genre, release year, BPM, and/or duration. Examples of characteristics of the content itself include instrumentation, tempo, key signature, meaning/theme of lyrics or other language-based content, and/or a mood evoked by the content item. For example, a prompt requesting to “play some of artist 1's electric guitar songs,” as shown in FIG. 10J would cause the electronic device to generate a collection of content items by Artist 1 that feature the electric guitar.

In some embodiments, the electronic device includes a content application. The content application optionally provides ways of presenting, saving, sharing, and/or browsing content items. In some embodiments, the content application includes a library function that includes maintaining a library of saved content items for presenting and/or browsing. In some embodiments, the content application includes a content collection function integrated with or separate from the library function. For example, a playlist is a type of content collection. In some embodiments, content collections include a plurality of content items not necessarily published together as a collection, as would be the case with an album. The content application optionally includes user-curated content collections made by the user of the electronic device or made by another user (and received at the electronic device), editorial-curated content collections provided by an entity that manages the content application, and/or generative content collections.

In some embodiments, generative content collections are content collections generated using artificial intelligence and/or machine learning. In some embodiments, a generative content collection includes content items having one or more characteristics in common. For example, the characteristics are based on a prompt included in a user input detected by the electronic device. In some embodiments, a prompt includes a description, such as a natural language description, of metadata and/or characteristics that should be included in the generative content collection. In some embodiments, the prompt identifies respective media content, and the generative content collections include one or more characteristics in common with the respective media content.

Some examples are described herein with respect to audio content, such as music. The techniques described herein can be applied to other types of content, such as spoken word audio content (e.g., audiobooks and/or podcasts) and/or video content (e.g., series of episodic content, movies, clips) analogously without departing from the scope of the disclosure.

FIGS. 10A-10C illustrate examples of the electronic device generating collections of content items based on respective media content. FIG. 10A illustrates an example of a content presentation user interface. For example, the electronic device 500 displays the content presentation user interface while presenting respective media content, such as a song. The content presentation user interface in FIG. 10A includes a grabber bar 1002, artwork 1004a corresponding to the first media content, the title 1006a of the first media content, the artist 1008a of the first media content, a menu option 1010, a scrubber bar 1012, a skip back option 1014, a pause option 1016, a skip forward option 1018, a content collection generation option 1020, and a queue option 1022.

In some embodiments, in response to detecting input directed to grabber bar 1002, the electronic device 500 ceases displaying the content presentation user interface.

In some embodiments, the artwork 1004a, title 1006a, and artist 1008a correspond to the first media content. In some embodiments, if the electronic device 500 were presenting a different content item, the artwork 1004a, title 1006a, and artist 1008a would correspond to the content item the electronic device 500 was presenting instead.

In some embodiments, in response to detecting an input directed to the menu option 1010, the electronic device 500 would present a menu of selectable options that, when selected, cause the electronic device 500 to perform various actions with respect to the first media content. If a different item of media content were playing while displaying the content presentation user interface, then the menu optionally would include selectable options that, when selected, cause the electronic device 500 to perform the various actions with respect to the media content the electronic device 500 is presenting.

In some embodiments, scrubber bar 1012, skip back option 1014, pause option 1016, and/or skip ahead option 1018, when selected, cause the electronic device 500 to modify playback of the first media content. If the electronic device was presenting different media content while displaying the content presentation user interface, then input directed to these options would modify playback of the media content the electronic device was presenting.

In some embodiments, the content presentation user interface includes a queue option 1022. In some embodiments, in response to detecting selection of the queue option 1022, the electronic device 500 presents an ordered list of representations of content items that are queued for playback after the first media content. In some embodiments, the content items in the queue are from a respective collection of content items.

In some embodiments, the content collection generation option 1020, when selected, causes the electronic device 500 to generate a plurality of collections of content items based on the first media content. If the electronic device were presenting different media content while displaying the content presentation user interface, then selection of the content collection generation option 1020 would cause the electronic device 500 to generate a plurality of collections of content items based on the media content the electronic device 500 is presenting. In some embodiments, the collections of content items based on the first media content include content items having a respective characteristic in common with the first media content.

As shown in FIG. 10A, the electronic device 500 detects an input selecting the content collection generation option 1020. In response to detecting the input in FIG. 10A, the electronic device 500 generates a plurality of collections of content items based on the first media content the electronic device 500 is presenting while receiving the input in FIG. 10A. In some embodiments, while generating the collections of content items, the electronic device 500 presents the animation described with respect to FIG. 10B. In some embodiments, after generating the collections of content items, the electronic device 500 displays the user interface shown in FIG. 10C.

FIG. 10B illustrates an example of the electronic device 500 presenting an indication of generating collections of content items based on an item of media content. In some embodiments, the electronic device 500 presents the animation described with reference to FIG. 10B in response to detecting the input illustrated in FIG. 10A. In some embodiments, the electronic device 500 continues presenting the media content while displaying the animation. In some embodiments, the animation includes gradually reducing the size of the artwork 1004acorresponding to the media content. In some embodiments, the animation includes changing colors (e.g., within artwork 1004a or in the background). In some embodiments, while presenting the animation, the electronic device 500 presents a message 1024 confirming that the electronic device 500 is generating collections of content items based on the media content.

FIG. 10C illustrates an example of the electronic device presenting a user interface including representations of a plurality of collections of content items based on the respective media content. In some embodiments, the electronic device 500 presents the user interface shown in FIG. 10C in response to detecting the input described above with reference to FIG. 10A. In some embodiments, the electronic device 500 continues presenting the first media content while displaying the user interface in FIG. 10C.

As shown in FIG. 10C, the user interface includes artwork 1004a representing the first media content and representations 1004b through 1004g of collections of content items based on the first media content. In some embodiments, the electronic device 500 displays artwork 1004a and representations 1004b through 1004g on a background 1005a that is based on the artwork 1004a as described in more detail below with reference to method 1100. As shown in FIG. 10C, representations 1004b through 1004g include respective natural language describing the characteristic the content items in the respective content collections have in common with the first media content.

The user interface in FIG. 10C further includes an option 1026 to generate a collection of content items based on a natural language prompt. FIGS. 10I-10L illustrate an example of generating a collection of content items based on a natural language prompt in response to detecting a sequence of inputs including an input selection option 1026.

In some embodiments, if the electronic device 500 had been presenting different media content when detecting input requesting to generate collections of content items based on the media content the electronic device 500 was currently presenting, then the electronic device 500 would generate collections of media content based on the media content being played and display representations of those content collections. In some embodiments, generating the collections of media content is non-deterministic; in response to detecting another input requesting generation of content collections based on the first media content, the electronic device 500 would optionally generate different content collections.

As shown in FIG. 10C, the electronic device 500 detects an input directed to the user interface that corresponds to a request to navigate to a representation 1004e of one of the content collections based on the first media content. For example, the navigation input is a swipe input. Other inputs are possible as described below with reference to method 1100. In some embodiments, in response to detecting the input in FIG. 10C, the electronic device 500 updates the user interface as shown in FIG. 10D.

FIG. 10D illustrates an example of the electronic device 500 updating the content collection user interface to include representation 1004e at a position in the user interface at which artwork 1004a had been displayed in FIG. 10C. In some embodiments, the electronic device 500 updates the user interface as shown in FIG. 10D in response to detecting the input shown in FIG. 10C. As shown in FIG. 10D, the electronic device 500 displays the representation 1004e at a location in the user interface near (or, in some embodiments, the same as) the location at which the electronic device 500 had displayed artwork 1004a in FIG. 10C, such as in or towards the middle of the user interface. Additionally, as shown in FIG. 10D, the electronic device 500 maintains display of representations 1004c and 1004f of respective content collections based on the first media content and representations 1004h through 1004j of additional content collections based on the first media content. In some embodiments, the electronic device 500 updates the background 1005b of the user interface based on the collection of content items corresponding to representation 1004e, such as including colors included in artwork associated with a content item included in the content collection and/or colors that evoke a similar mood as the mood evoked by the content collection. In some embodiments, while displaying the updated user interface shown in FIG. 10D, the electronic device 500 continues presenting the first media content. In some embodiments, while displaying the user interface shown in FIG. 10D, the electronic device 500 presents a content item from the content collection corresponding to representation 1004e. In some embodiments, if the electronic device 500 detected another input navigating to a different representation 1004c, 1004f, or 1004h through 1004j, then the electronic device 500 would update the user interface similarly to the way the electronic device 500 updated the user interface in FIG. 10D with respect to the representation navigated to by the input.

In FIG. 10D, the electronic device 500 detects an input optionally including contact 1003d selecting another representation 1004i of another content collection. For example, the input is a tap touch gesture. Other inputs described with reference to method 1100 are possible. In response to detecting the input shown in FIG. 10D (or another selection input), the electronic device 500 initiates playback of a content item included in the selected content collection and displays the content presentation user interface, as described below with reference to FIG. 10E.

In some embodiments, if the input was a secondary selection input, such as a long tap touch gesture described in more detail with reference to method 1100, or another secondary selection input described below with reference to method 1100, then the electronic device 500 would generate content collections based on the content collection selected by the secondary selection input and present a user interface with representations of the generative content collections similar to the user interface illustrated in FIG. 10C.

FIG. 10E illustrates the electronic device 500 presenting the content presentation user interface while presenting a content item from the content collection corresponding to the representation 1004i selected in FIG. 10D. In some embodiments, the electronic device 500 presents the user interface in FIG. 10E in response to detecting the input illustrated in FIG. 10D. In some embodiments, the electronic device 500 presents a content item from the content collection corresponding to the representation selected in FIG. 10D while displaying the user interface shown in FIG. 10E.

The content presentation user interface in FIG. 10E includes many elements similar to the elements of the content presentation user interface illustrated in FIG. 10A, except elements that cause the electronic device 500 to perform actions with respect to the content item being presented in FIG. 10A cause the electronic device 500 to perform actions with respect to the content item being presented in FIG. 10E. Additionally, the user interface in FIG. 10E includes artwork 1004, a title 1006b, and an artist 1008b corresponding to the content item playing while the electronic device 500 displays the user interface illustrated in FIG. 10E.

As shown in FIG. 10E, the electronic device 500 detects an input directed to grabber bar 1002. For example, the input is a touch swipe gesture input. Other input types described with reference to method 1100 are possible. In some embodiments, in response to detecting the input directed to the grabber bar 1002 shown in FIG. 10E, the electronic device 500 ceases displaying the content presentation user interface and displays a different user interface of the content application. In some embodiments, the electronic device 500 additionally or alternatively detects one or more additional inputs navigating to the user interface shown in FIG. 10F.

FIG. 10F illustrates the electronic device 500 displaying a user interface that includes representations 1030a through 1030d of content items the electronic device 500 previously presented. In some embodiments, the electronic device 500 displays the user interface illustrated in FIG. 10F in response to detecting a sequence of inputs including the input illustrated in FIG. 10E. As shown in FIG. 10F, the user interface includes a search user interface element 1028, representations 1030a through 1030d of previously-presented collections of content items, and navigation options 1032a through 1032d.

In some embodiments, in response to receiving a sequence of inputs directed to the search user interface element 1028, the electronic device 500 initiates a process to search for content items through the content application. Some examples of search functionality are described in more detail below with reference to method 900.

In some embodiments, in response to detecting selection of one of the navigation options 1032a through 1032d, the electronic device 500 presents a user interface of the content application corresponding to the selected navigation option. In response to detection selection of navigation option 1032a, the electronic device 500 optionally navigates to a “home” user interface of the content application. In response to detection selection of navigation option 1032b, the electronic device 500 optionally navigates to a content browsing user interface of the content application. In response to detection selection of navigation option 1032c, the electronic device 500 optionally navigates to a radio user interface of the content application. In response to detection selection of navigation option 1032d, the electronic device 500 optionally navigates to a content library user interface of the content application. In response to detection selection of navigation option 1032e, the electronic device 500 optionally navigates to a search user interface of the content application.

In some embodiments, representations 1030a through 1030d correspond to various content collections from which the electronic device 500 recently presented content items. For example, representation 1030a corresponds to a collection of content items published as a collection (e.g., an album). Representations 1030c and 1030d optionally correspond to content collections with content items published from a mix of published collections (e.g., playlists). In some embodiments, representations 1030c and 1030d correspond to user-generated content collections, editorial content collections, and/or generative content collections. Representation 1030b optionally corresponds to a generative content collection the electronic device 500 presented while displaying the user interface illustrated in FIG. 10E. For example, representation 1030b in FIG. 10F and representation 1004e correspond to the same content collection and optionally include the same image.

In some embodiments, the electronic device 500 detects an input optionally including contact 1003f selecting representation 1030b. Other selection inputs described with reference to method 1000 are possible. In some embodiments, in response to detecting the input shown in FIG. 10F, the electronic device 500 presents a user interface including representations of content items included in the content collection as shown in FIG. 10G.

FIG. 10G illustrates an example user interface including representations 1042a through 1042c of content items included in a collection of content items. In some embodiments, the electronic device 500 displays the user interface illustrated in FIG. 10G in response to detecting the input shown in FIG. 10F. In some embodiments, the content collection corresponding to the use interface in FIG. 10G is a generative content collection. In some embodiments, the electronic device 500 displays similar user interfaces corresponding to user-created content collections and/or editorial content collections.

In some embodiments, representation 1042a includes artwork 1044a and title 1044b corresponding to a respective content item included in the content collection. In some embodiments, representation 1042a further includes an option 1044c to download the respective content item and an option 1044d to display a menu of further options to perform respective operations with respect to the respective content item. For example, the menu includes options to view credits associated with the content item, add or remove the respective content item from a content library, add the respective content item to a different content collection, add the respective content item to content presentation queue, share the respective content item, create a radio station corresponding to the respective content item, favorite the respective content item, and/or indicate a dislike for the respective content item. In some embodiments, representations 1042b and 1042c include similar elements as the elements of representation 1042a, but with respect to the respective content items corresponding to the respective representation. In some embodiments, in response to detecting an input to scroll the content collection user interface, the electronic device 500 reveals additional representations of additional content items included in the content collection.

In some embodiments, the user interface in FIG. 10G further includes representation 1030b corresponding to the collection of content items and an indication of the name 1038 of the content collection. In some embodiments, the user interface includes an option 1040a that, when selected, causes the electronic device 500 to present the content collection in a predefined order and an option 1040b that, when selected, causes the electronic device 500 to present the content collection in a randomized order. In some embodiments, the user interface includes an option 1034a to add the content collection to the content library and an option 1036 to view a menu of further options for performing respective actions with respect to the content collection. For example, the menu includes options to change the sorting order of content items included in the collection, an option to add or remove the content collection from the content library, an option to add the content collection to another content collection, an option to add the content collection to a content presentation queue, an option to share the content collection with another user, an option to favorite the content collection, and an option to suggest playback of the content collection less often. In some embodiments, the user interface includes the navigation options 1032a through 1032d previously described with reference to FIG. 10F.

In FIG. 10G, the electronic device 500 detects an input optionally including contact 1003g selecting the option 1034a to add the content collection to the content library. In some embodiments, other selection inputs described below with respect to method 1100 are possible. In some embodiments, in response to detecting the input shown in FIG. 10G, the electronic device 500 adds the content collection to the content library and updates the user interface as shown in FIG. 10H.

FIG. 10H illustrates an example of the user interface including representations of the content items included in the collection of content items updated after adding the collection to the user's content library. In some embodiments, the electronic device 500 displays the user interface as shown in FIG. 10H in response to detecting the input shown in FIG. 10G.

In some embodiments, the content library is a list of content items saved by the user of the electronic device 500. In some embodiments, the content application includes various user interfaces for browsing content items, including individual content items and/or content collections. Thus, the content library is a convenient way for the user to present certain content items multiple times. In some embodiments, the electronic device 500 stores one or more content items included in the content library in memory of the electronic device 500 for presentation while electronic device 500 is not connected to the internet or another network storing content items.

The user interface in FIG. 10H is similar to the user interface shown in FIG. 10G, except in FIG. 10H, option 1034a is updated to indicate that the content collection is included in the content library and stored in a memory of the electronic device 500. Optionally, if content collection was included in the library but not downloaded, the user interface would include a selectable option that, when selected, causes the electronic device 500 to save the content collection to memory of the electronic device 500.

FIGS. 10I-10M illustrate an example of the electronic device generating a collection of content items from a natural language prompt provided by the user. In some embodiments, the electronic device 500 generates collections of content items based on a natural language prompt according to one or more steps of method 900 described above.

FIG. 10I illustrates the example user interface including representations of collections of content items generated based on respective media content. For example, the user interface in FIG. 10I is the same as the user interface in FIG. 10C. Optionally, the electronic device 500 displays the user interface in FIG. 10I in response to detecting the input illustrated in FIG. 10A. For brevity, the details of the user interface shown in FIG. 10I and FIG. 10C will not be repeated here.

As shown in FIG. 10I, the electronic device 500 detects an input optionally including contact 1003i directed to option 1026. Other selection inputs described with reference to method 1100 are possible. In response to detecting the input in FIG. 10I, the electronic device 500 updates the user interface to accept an input providing a natural language prompt for generating a content collection, as shown in FIG. 10J.

FIG. 10J illustrates an example user interface for providing a natural language prompt for generating collections of content items. In some embodiments, the user interface includes text entry field 1046. In some embodiments, in response to receiving the input shown in FIG. 10I and prior to receiving further inputs providing a prompt, the electronic device 500 displays the text entry field 1046 without a prompt, such as with placeholder text or no text. In some embodiments, the user interface further includes a soft keyboard 1048 that enables the user to type a prompt for generating a content collection. In some embodiments, the electronic device 500 accepts other inputs defining the prompt, such as hardware input device inputs, handwritten input, and/or voice inputs. In some embodiments, the background of the user interface in FIG. 10J includes an animation that updates as the electronic device 500 detects entry of the prompt, responding to updates to the prompt based on the inputs. For example, as the electronic device 500 detects text entry inputs adding to text in the text entry field 1046, the electronic device 500 updates and/or changes the animated background responsive to the additions to the text.

In some embodiments, the prompt includes natural language describing the content that should be included in an automatically-generated content collection. For example, in response to the prompt in FIG. 10J requesting to “play some of artist 1's electric guitar songs,” the electronic device generates a collection of content items that feature artist 1 and the electric guitar. In some embodiments, generating the collections of content items corresponding to the prompt includes natural language processing, semantic understanding, and/or other machine learning and/or artificial intelligence techniques that extend beyond a metadata search of content items. In some embodiments, the electronic device 500 continues playing the first media content (or the next content item in a playback queue of the electronic device 500) while displaying the user interface in FIG. 10J and receiving the prompt to generate new representations of music content.

In some embodiments, as shown in FIG. 10J, the electronic device 500 detects an input (e.g., including contact 1003j) selecting a soft “enter” key in the soft keyboard 1048. Alternatively, the electronic device 500 detects a different input corresponding to a request to initiate generation of the collection of content items based on the prompt shown in the text box 1046. In response to receiving the input, such as the input shown in FIG. 10J, the electronic device 500 displays an animation shown in FIG. 10K while generating a collection of content items corresponding to the prompt, generates a collection of content items corresponding to the prompt, and initiates presentation of the collection of content items, as shown in FIG. 10L.

FIG. 10K illustrates an example animation presented while generating a collection of content items corresponding to a prompt. In some embodiments, the electronic device 500 presents the animation in FIG. 10K in response to detecting the input described above with reference to FIG. 10J. In some embodiments, the animation includes colors, shapes, and/or movement based on the prompt. For example, the animation corresponds to a mood evoked by the prompt. As another example, the animation uses colors and/or shapes based on artwork associated with a content item that will be included in the collection of content items.

Additionally or alternatively, while the electronic device 500 generates the collection of content items based on the prompt shown in FIG. 10J, the electronic device 500 displays a summary 1050 of the prompt. As shown in FIG. 10K, the summary 1050 of the prompt includes emphasizing certain portions of the prompt that are central to the meaning of the prompt. In some embodiments, while presenting the animation and/or summary 1050 shown in FIG. 10K, the electronic device 500 continues playing the media content that was playing while the electronic device 500 displayed the user interface in FIG. 10J, or the next media content in the content playback queue.

FIG. 10L illustrates the electronic device 500 presenting media content included in a generated collection of content items corresponding to the prompt shown in FIG. 10J. In some embodiments, the electronic device 500 presents the user interface in FIG. 10L once it finishes generating the collection of content items corresponding to the prompt in response to detecting the input described with reference to FIG. 10J. In some embodiments, the user interface in FIG. 10L is the same as the user interface in FIG. 10A, except for the following differences. The user interface in FIG. 10L includes artwork 1004m, a title 1006a, and an artist 1008c corresponding to the content item that is currently playing on the electronic device 500. Additionally or alternatively, the user interface in FIG. 10L includes information 1054 corresponding to the collection of content items. For example, the information 1054 includes text and/or images related to the collection of content items based on the user-provided prompt. In some embodiments, the electronic device 500 displays the information 1054 for a predetermined amount of time before ceasing to display the information 1054.

FIG. 10M illustrates the electronic device 500 continuing to present the playback user interface while presenting the content item included in the collection of content items based on the prompt. As shown in FIG. 10M, the electronic device 500 no longer displays information 1054 that the electronic device 500 displayed in FIG. 10N. Instead, as shown in FIG. 10M, the electronic device 500 displays skip back option 1014, pause option 1016, skip ahead option 1018, content collection generation option 1020, and queue option 1022, described above with reference to FIG. 10A. In some embodiments, once the electronic device 500 finishes playing the content item playing in FIG. 10M (or in response to detecting an input directed to skip ahead option 1018), the electronic device 500 starts playing the next content item in the collection of content items.

FIG. 11 illustrates a flow diagram illustrating a method in which an electronic device generates collections of content items and presents representations of generated collections of content items in accordance with some embodiments. The method 1100 is optionally performed at an electronic device and/or electronic devices such as device 100, device 300, or device 500 as described above with reference to FIGS. 1A-1B, 2-3, 4A-4B and 5A-5H. Some operations in method 1100 are, optionally combined and/or order of some operations is, optionally, changed.

In some embodiments, method 1100 is performed at an electronic device in communication with one or more input devices and a display generation component. For example, the electronic device, the one or more input devices, and/or the display generation component optionally have one or more characteristics of the electronic device(s), the one or more input devices, and/or the display generation components described with reference to methods 700 and/or 900.

In some embodiments, while presenting (e.g., playing audio and/or displaying image(s) and/or video) first media content, the electronic device presents, via the one or more input devices, a first input including a request to generate a first plurality of collections of content items associated with (e.g., related to) the first media content, such as in the input including contact 1003a shown in FIG. 10A. For example, the first media content optionally is and/or optionally includes audio, an image, an animation, and/or video that is presented by an application such as a media player application stored in memory of the electronic device. For example, the first media content is optionally an audio track including a song, spoken words, ambient sounds, and/or some combination thereof. In some embodiments, the first input is detected via the one or more input devices. In some embodiments, the first input has one or more characteristics similar to or the same as described with reference to method 700 and/or 900. In some embodiments, the first input includes a selection input, such as touch on a touchscreen directed to a selectable option displayed by the touchscreen that includes a button, an icon, one or more images and/or animations, text, and/or some combination thereof. In some embodiments, the selectable option is selectable to initiate display of a prompt such as a search field and/or a user interface for soliciting further input specifying a query related to media content that is potentially of interest to the user. In some embodiments, in response to detecting selection of the selectable option, the electronic device initiates generation of one or more collections of content that relate to the first media content (e.g., without displaying a user interface, and/or without displaying a prompt for additional information), as described above with reference to method 900.

In some embodiments, in response to detecting the first input, the electronic device initiates a process to generate (and/or generating) the first plurality of collections of content items, such presenting the animation as in FIG. 10B and/or presenting the representations 1004b through 1004g of collections of content items in FIG. 10C. In some embodiments, the electronic device initiates the process and/or displays representation of content item(s) in response to detecting the first input, without detecting one or more additional or alternative inputs. In some embodiments, the process includes soliciting a user of the electronic device to provide information that will inform what content is associated with collection(s) of content related to the first media content. In some embodiments, the process includes using one or more artificial intelligence algorithms (e.g., large language models, neural networks, decisions trees, clustering algorithms, and/or some combination thereof) to select the content items included in respective collections of the first plurality of collections of content items. In some embodiments, the respective collections included in the first plurality of collections of content respectively include content items associated with a unifying theme associated with the first media content. For example, the theme of a respective collection is optionally based upon and/or corresponds to a qualitative characteristic(s) of the first media content and/or the respective content items included in the respective collection. In some embodiments, the collection of content items includes an ordered or unordered list of content items, such as a playlist and/or a grouping videos and/or songs. As an example, the respective content items and/or the first media content are optionally associated with a mood that is optionally engendered by listening to the first media content and/or respective content items included in the respective collection, optionally correspond to an event-driven context in which the respective content items and/or the first media content are optionally suitable (e.g., music for a day at the beach, podcasts for a commute home, background dinner music, pre-wedding preparations, and/or bedtime lullabies), and/or optionally are associated with a theme that is associated with characteristics of the first media content (e.g., a subgenre of music recorded by an artist such as country music content items recorded by Taylor swift, renditions of classic songs such as “Georgia on my Mind,” and/or artists that are located from and/or are popularly associated with a geographic region that is the birthplace of an artist that created the first media content). In some embodiments, respective collections of the first plurality of collections are respectively associated with different themes related to the first media content. In some embodiments, the first media content has a plurality of characteristics and the respective collections of content items in the first plurality of collections of content items are associated with one or more respective characteristics of the first media content. For example, a first collection optionally includes content items recorded by an artist during an identified era of their artistic evolution (e.g., songs released by Brittany Spears from 2000-2004, songs from Andre 3000's rap or flute-centric albums, and/or songs recorded by Jay-Z while signed to Def Jam Records or while signed to Roc Nation), and a second collection optionally includes content items corresponding to a planned activity (e.g., white noise to assist sleep, podcasts for a road trip, and/or audiobooks for a morning walk). In some embodiments, the electronic device initiates display of representations of such collections of content items to indicate a rationale for presenting the collections to the user of the electronic device and/or to facilitate browsing of the collections of content items.

In some embodiments the process includes concurrently displaying, via the display generation component a first plurality of representations of the first plurality of collections of content items, wherein the first plurality of representations respectively include natural language describing a relationship between respective content items included in respective collections of the first plurality of collections, such as representations 1004b through 1004g in FIG. 10C. In some embodiments, the first plurality of representations of the first plurality of collections of content items include one or more buttons, images, text, graphics, animated images, video, and/or some combination thereof. In some embodiments, the first plurality of representations respectively describe one or more characteristics and/or include a natural language descriptions or titles that indicates a unifying theme related to respective content items included in a respective collection of the first plurality of collections. For example, the first plurality of representations optionally include a first representation of a first collection, such as describing a genre and/or subgenre of music that is related to the first media content. As an example, the first representation of the first collection optionally includes information such as “90's RnB” in accordance with a determination that the first media was optionally released in a related period of time (e.g., the 1990's), in accordance with a determination the first media content is optionally of a similar or a same genre as content items included in the first collection (e.g., the first collection and/or the first media content belong to a rap, R&B, and/or blues genre), and/or in accordance with a determination that an artist that recorded the first media content optionally released music related to the genre or subgenre associated with the first collection. In some embodiments, respective representations of the first plurality of representation of the first plurality of collections of content items include natural language. For example, the above-described first information optionally describes an artist, an era of music, a genre, a particular album, a qualitative descriptor (e.g., a feeling, a mood, a context in which the user is likely to enjoy consuming the collection of content items (e.g., weather-related, event-related, time-of-day-related, activity-related, and/or some combination thereof), and/or additional or alternative information presenting one or more characteristics associated with the corresponding collection of content items, as described further with reference to the first plurality of collections of content items.

In some embodiments the process includes concurrently displaying, via the display generation component a first representation of the first media content, wherein the first plurality of representations of the first plurality of collections of content items are displayed in an arrangement at least partially surrounding the first representation of the first media content, such as artwork 1004a in FIG. 10C. For example, the first representation of the first media content optionally includes information, such as an image, video, a graphic, an animation, text and/or some combination thereof. As an example, the first representation optionally is an album cover art or looping video representative of an album that includes the first media content and/or that corresponds to the first media content (e.g., and not the album). In some embodiments, the electronic device displays one or more images included in the first representation of the first media content and/or concurrently does not display one or more images included in the first plurality of representation of the first collections of content items, thus drawing visual emphasis toward the first representation of the first media content. In other embodiments, the electronic device concurrently displays one or more images in respective representations of the first plurality of representation of the first plurality of collections of content items. In some embodiments, the first representation of the first media content is displayed with first visual characteristics relative to the user interface, the user interface including the first representation of the first media content and/or the first plurality of representations of the first plurality of collections of content items. In such embodiments, one or more representations included in the first plurality of representations are displayed with second visual characteristics, different from the first visual characteristics. For example, the first representation of the first media content is optionally displayed with a border, a simulated glowing effect mimicking a light source shining from behind the first representation, a color, a level of opacity, a scale, and/or some combination thereof, while the first plurality of representation of the first plurality of collections of content items are optionally displays without, or with a different border, simulated glowing effect, color, level of opacity, scale, and/or some combination thereof. As a further example, the first representation of the first media content is optionally displayed with 100% opacity, with a first size relative to the user interface, and/or without a blurring effect and/or a color fill overlaying an album art image corresponding to the first media content. Optionally, the electronic device concurrently displays the first plurality of representation of the first plurality of collections of content items with 80% opacity, with second respective sizes relative to the user interface (e.g., less than the first size), with a blurring effect, with a color fill overlaying the respective representations, and/or with text in place of album art or a representative image related to the content items included in respective collections. In some embodiments, the first representation of the first media content and the first plurality of representations of the first plurality of collections of content item share one or more visual characteristics. For example, both the first representation of the first media content and the first plurality of representations of the first plurality of collections of content item optionally are displayed with a similar or same shape (e.g., rectangles, circles, ellipses, stars, and/or a composite or rounded version of the aforementioned shapes), a similar or same color border, and/or a similar or same orientation relative to the user interface. In some embodiments, the first representation of the first media content and the first plurality of representations of the first plurality of collections of content items are displayed in a grid-like or tile arrangement, with the first representation displayed at a relative center of the arrangement. In some embodiments, respective representations of the first plurality of representations of the first plurality of collections of content items are displayed adjacent to (e.g., above, below, to the left, and/or to the right) of the first representation of the first media content. In some embodiments, the arrangement is annular with the first representation located at a center of the ring. In some embodiments, the arrangement includes a plurality of rows and/or columns of the first plurality of representations of the first plurality of collections of content items, such that the first representation of the first media content is included in a center of a central row and/or column of the arrangement. In some embodiments, the electronic device continues to play the first media content while displaying the plurality of representations of the first plurality of collections of content items. In some embodiments, the electronic device presents a plurality of representations of single items of content in a manner similar to the manner of presenting the first plurality of representations of the first plurality of collections of content items, including representations of single items of content that have one or more visual characteristics in common with the representations of the collections of content items. Displaying a first representation of first media content and a first plurality of representations of the first plurality of collections of content items allows a user of the electronic device to browse prospective, related content items for their consumption while preserving visibility of the currently presented first media content, thus reducing visual clutter in a user interface and reducing power required to browse for and display representations of related content items.

In some embodiments, the process to generate the first plurality of collections of content items includes using artificial intelligence and/or machine learning to generate the first plurality of collections of content items, such as the collections of content items represented by representations 1004b through 1004g in FIG. 10C. In some embodiments, the electronic device uses artificial intelligence (AI) and/or machine learning (ML) to identify one or more characteristics of the first media content, then generate collection of content items that include content items sharing respective characteristics of the first media content. Example characteristics include genre, mood, tempo, instrumentation, release date being within a predefined range, and/or artist. In some embodiments, the electronic device uses other information, such as content consumption history of the electronic device and/or of a user account of the electronic device to influence the characteristics of content items in the collections of content items. In some embodiments, the electronic device forgoes generating the first plurality of collections of content items unless and/or until the electronic device receives the first input including the request to generate the first plurality of collections of content items associated with the first media content. Using AI and/or ML to generate the first plurality of collections of content items enhances user interactions with the electronic device by reducing the inputs needed to generate a plurality of collections of content items with characteristics similar to the first media content, thereby reducing inputs, time, and user errors and preserving energy and/or battery life of the electronic device.

In some embodiments, while presenting (e.g., playing audio and/or displaying image(s) and/or video) the first media content (e.g., before generating the first plurality of collections of content items and/or before detecting the first input including the request to generate the first plurality of collections of content items associated with the first media content), the electronic device concurrently displays, via the display generation component a first selectable option that, when selected, causes the electronic device to modify presentation of the first media content, such as one of options 1014, 1016, and/or 1018 in FIG. 10A. In some embodiments, the electronic device presents a content playback user interface while presenting the first media content. The content playback user interface optionally includes information about the first media content, one or more selectable options for controlling playback of the first media content including the first selectable option, and/or one or more selectable options for performing other actions related to the first media content. In some embodiments, the information about the first media content includes an image associated with the first media content, an indication of the name of the media content and/or other metadata of the first media content. In some embodiments, the one or more selectable options for controlling playback of the first media content include options that, when selected, cause the electronic device to play/pause the first media content, scrub the playback position of the first media content, change the playback volume of the first media content, restart the first media content, and/or skip to the end of the first media content. In some embodiments, the one or more options for performing other actions related to the first media content include options that, when selected, cause the electronic device to save the first media content to a content library, to download the first media content to storage of the electronic device, share the first media content with another user account, and/or to initiate the process to generate he first plurality of collections of content items, described in more detail below.

In some embodiments, while presenting (e.g., playing audio and/or displaying image(s) and/or video) the first media content (e.g., before generating the first plurality of collections of content items and/or before detecting the first input including the request to generate the first plurality of collections of content items associated with the first media content), the electronic device concurrently displays, via the display generation component a second selectable option that, when selected, causes the electronic device to initiate the process to generate the first plurality of collections of content items, such as option 1020 in FIG. 10A. In some embodiments, the first input includes selection of the second selectable option, such as a touch input, a direct or indirect air gesture input, a gesture input, a gaze input, an input detected using a hardware input device, and/or a voice input. In some embodiments, the first input is a voice or other input not directed to the second selectable option that includes a request to initiate the process to generate the first plurality of collections of content items. Displaying the option that, when selected, causes the electronic device to initiate the process to generate the first plurality of collections of content items concurrently with a selectable option that, when selected, causes the electronic device to modify presentation of the first media content enhances user interactions with the electronic device by revealing the feature to generate collections of content items to the user, thereby reducing time, inputs, and user error to generate the collections of content items, thereby reducing energy consumption and/or preserving battery life.

In some embodiments, detecting the first input includes detecting a natural language input, and initiating the process to generate the first plurality of collections of content items includes performing natural language processing, such as the natural language input in text entry field 1046 in FIG. 10J. In some embodiments, the first input includes natural language. For example, the electronic device detects typed, handwritten, or spoken natural language. The electronic device optionally processes the natural language input to identify one or more characteristics of content items that should be included in the one or more collections of content items. In some embodiments, the input includes (e.g., written or spoken) words requesting the electronic device generate the plurality of collections of content items based on a respective content item (e.g., the first media content or other media content) and/or having one or more other specified characteristics. In some embodiments, the electronic device uses AI and/or ML techniques to perform natural language processing. Using natural language processing to generate the first plurality of collections of content items enhances user interactions with the electronic device by processing natural language inputs provided by the user, which reduces time needed to generate the desired collections of content items and/or user errors, thereby reducing power consumption and/or preserving battery life of the electronic device.

In some embodiments, the first plurality of collections of content items have more characteristics in common with the first media content than with second media content, such as the first media content playing in FIG. 10A.

In some embodiments, while presenting (e.g., playing audio and/or displaying image(s) and/or video) the second media content, the electronic device detects, via the one or more input devices, a second input including a request to generate a second plurality of collections of content items associated with (e.g., related to) the second media content, such as an input similar to the input including contact 1003a in FIG. 10A, but while presenting different media content than the media content being presented in FIG. 10A. In some embodiments, the second input has one or more characteristics of the first input described herein, except the electronic device detects the second input while presenting the second media content. In some embodiments, the first input designates the first content item. In some embodiments, the second input designates the second content item. In some embodiments, the electronic device generates collections of content items based on a third content item in response to detecting a third input that designates the third content item. In some embodiments, the third input designates the third content item based on including an indication of third content item, such as being directed to an option associated with the third content item and/or including text designating the third content item, including typed, handwritten, and/or spoken text.

In some embodiments, in response to detecting the second input, the electronic device a process to generate (and/or generating) the second plurality of collections of content items, wherein the second plurality of collections of content items have more characteristics in common with the second media content than with the first media content, such as presenting representations of collections of content items that have more characteristics in common with the second media content than with the first media content similarly to the presentation of representations 1004a through 1004g in FIG. 10C. Example characteristics include genre, mood, tempo, instrumentation, release date being within a predefined range, and/or artist. In some embodiments, the characteristics of the first plurality of collections of content items are different from the characteristics of the second plurality of collections of content items. In some embodiments, the first plurality of collections of content items include a collection with the same characteristic as a collection included in the second plurality of collections of content items. Optionally, the collection in the first plurality of collections of content items includes different content items than the collection in the second plurality of collections of content items even if the collections of content items (and the first and second media content) share a characteristic. Generating the plurality of collections of content items based on characteristics of a particular media content items enhances user interactions with the electronic device by reducing the inputs and user errors of generating collections of content items with desired characteristics, thereby preserving battery life and/or reducing power consumption.

In some embodiments, while displaying, via the display generation component, the first representation of the first media content and the first plurality of representations of the first plurality of collections of content items, including a second representation of a second collection of content items that includes second natural language describing a relationship between content items included in the second collection of content items and the first media content (e.g., and while presenting (e.g., outputting audio and/or displaying image(s) and/or video of) the first media content), such as in FIG. 10C, the electronic device receives, via the one or more input devices, a second input navigating to the second representation, such as the input including contact 1003c in FIG. 10C. In some embodiments, the second input includes motion that positions the second representation in a predefined location of within the displayed user interface. For example, the second input includes a swipe gesture (e.g., a touch gesture or air gesture). Other example inputs include hardware input device inputs and/or voice inputs. In some embodiments, the second input is a selection input directed to the second representation such as a tap gesture (e.g., a touch gesture or air gesture), a gaze input, a voice input, and/or an input detected using a hardware input device.

In some embodiments, while displaying, via the display generation component, the first representation of the first media content and the first plurality of representations of the first plurality of collections of content items, including a second representation of a second collection of content items that includes second natural language describing a relationship between content items included in the second collection of content items and the first media content (e.g., and while presenting (e.g., outputting audio and/or displaying image(s) and/or video of) the first media content), such as in FIG. 10C, in response to receiving the second input, the electronic device updates the second representation to no longer include the second natural language and to include a representation of a content item included in the second collection of content items, such as representation 1004e in FIG. 10D. In some embodiments, the natural language describes a common characteristic of the content items included in the second collection of content items. In some embodiments, the common characteristic is also a characteristic of the first media content. In some embodiments, the representation of the content item is an image associated with the content item, such as album, series, and/or content item artwork. In some embodiments, the second collection of content items includes content items other than the content item in addition to the content item. In some embodiments, the content items other than the content item are associated with different representations from the representation of the content item. In some embodiments, in response to receiving the second input, the electronic device displays the second representation at a location in the user interface at which the electronic device had displayed the representation of the first media content when the second input was received, as described in further detail below.

In some embodiments, while displaying, via the display generation component, the first representation of the first media content and the first plurality of representations of the first plurality of collections of content items, including a second representation of a second collection of content items that includes second natural language describing a relationship between content items included in the second collection of content items and the first media content (e.g., and while presenting (e.g., outputting audio and/or displaying image(s) and/or video of) the first media content), such as in FIG. 10C, in response to receiving the second input, the electronic device maintaining display of the first plurality of representations of the first plurality of collections of content items, such as representation 1004c and/or representation 1004f in FIG. 10D. In some embodiments, the electronic device continues to display the other representations of the first plurality of representations of the first plurality of collections of content items with natural language descriptions of the collections of content items. In some embodiments, the electronic device updates the locations at which it displays the first plurality of representations of the first plurality of collections of content items. Updating the second representation to include the representation of the content item enhances user interactions with the electronic device by allowing the user to preview a content item included in the second collection of content items while continuing to browse the representations of the first plurality of collections of content items, which reduces time and/or inputs, thereby reducing energy consumption and/or preserving battery life.

In some embodiments, while displaying, via the display generation component, the first representation of the first media content and the first plurality of representations of the first plurality of collections of content items, including a second representation of a second collection of content items (e.g., and while presenting (e.g., outputting audio and/or displaying image(s) and/or video of) the first media content), such as in FIG. 10C, the electronic device receives, via the one or more input devices, a second input navigating to the second representation, optionally the same as or similar to the second input navigating to the second representation described above, such as the input including contact 1003c in FIG. 10C.

In some embodiments, while displaying, via the display generation component, the first representation of the first media content and the first plurality of representations of the first plurality of collections of content items, including a second representation of a second collection of content items (e.g., and while presenting (e.g., outputting audio and/or displaying image(s) and/or video of) the first media content), such as in FIG. 10C, in response to receiving the second input, the electronic device presents a content item (e.g., outputting audio of and/or display video of the content item) from the second collection of content items, such as presenting a content item corresponding to representation 1004e in FIG. 10D. In some embodiments, while presenting the content item from the second collection of content items, the electronic device maintains display of the first plurality of representations of the first plurality of collections of content items as described above, including displaying the second representation of the second collection of content items at a predefined location in the user interface at which the electronic device displays a representation of a collection of content items to which the user interface is navigated. For example, the electronic device displays the representation of the first media content at the predefined location in the user interface in response to detecting the first input before receiving other inputs requesting to change locations at which the electronic device displays various representations of various content items. In some embodiments, the content item is the first content item of the second collection of content items at the beginning of an ordered list of content items included in the second collection of content items. In some embodiments, the electronic device ceases presenting the first media content. In some embodiments, once the electronic device finishes presenting the content item from the second collection of content items, the electronic device presents another content item from the second collection of content items. In some embodiments, the electronic device presents a predefined portion of the content item from the second collection of content items other than the beginning of the content item. For example, the electronic device presents an interesting or well-known portion of the content items, such as a portion of the content item including vocal content, such as a beginning of a verse or a beginning of a chorus of a song that is not necessarily at the beginning of the song. Presenting the content item from the second collection of content items in response to receiving the second input navigating to the second representation enhances user interactions with the electronic device by reducing the number of inputs needed to present content from the second collection of content items while continuing to browse the plurality of collections of content items, which reduces power consumption and/or preserves battery life of the electronic device.

In some embodiments, while displaying, via the display generation component, the first representation of the first media content at a first location in a user interface and the first plurality of representations of the first plurality of collections of content items, including a second representation of a second collection of content items at a second location in the user interface (e.g., and while presenting the first media content), the electronic device receives, via the one or more input devices, a second input navigating to the second representation, such as the input in FIG. 10C including contact 1003c and/or the input in FIG. 10D including contact 1003d. In some embodiments, the electronic device displays the plurality of representations at locations in the user interface other than the first location. In some embodiments, the second input is the same as or similar to the second input navigating to the second representation described above. In some embodiments, the second input is a different input from the second input described above. In some embodiments, one input is navigation and/or selection and another input is secondary selection. Example secondary selection inputs include an input detected with one or more hardware input devices such as a right mouse click or a click concurrently with detecting an input with a respective key of a keyboard (e.g., the Control or command key) and/or touch or air gesture inputs, such as a two-finger touch and/or a “long” touch (e.g., a touch input where the time between touchdown and liftoff exceeds a threshold such as 0.5, 1, 2, 3, or 5 seconds) and/or gaze inputs such as the gaze or attention of the user being directed to a respective location for more than a threshold time (e.g., 0.5, 1, 2, 3, 5, or 10 seconds).

In some embodiments, while displaying, via the display generation component, the first representation of the first media content at a first location in a user interface and the first plurality of representations of the first plurality of collections of content items, including a second representation of a second collection of content items at a second location in the user interface (e.g., and while presenting the first media content), in response to receiving the second input, the electronic device displays, via the display generation component, the second representation at the first location in the user interface, such as displaying representation 1004eat the location shown in FIG. 10D. In some embodiments, the electronic device ceases displaying the first representation. In some embodiments, the electronic device displays the first representation at a location other than the first location.

In some embodiments, while displaying, via the display generation component, the first representation of the first media content at a first location in a user interface and the first plurality of representations of the first plurality of collections of content items, including a second representation of a second collection of content items at a second location in the user interface (e.g., and while presenting the first media content), in response to receiving the second input, the electronic device displays, via the display generation component, a second plurality of representations of a second plurality of collections of content items based on the second collection of content items, optionally similar to the display of representations 1004a, 1004c, 1004f, 1004i and/or 1004j in FIG. 10D. In some embodiments, the second plurality of representations of collections of content items include respective natural language describing a relationship between respective content items included in respective collections of the second plurality of collections. In some embodiments, the second plurality of collections of content items have characteristics, such as the characteristics described above, in common with characteristics of the collection of content items corresponding to the second representation. In some embodiments, in response to detecting the second input navigating to a third representation of a third collection of content items different from the second representation, the electronic device would display the third representation at the first location and display a third plurality of representations of a third plurality of collections of content items based on the third collection of content items. In some embodiments, in response to receiving the second input, the electronic device ceases displaying representations of other collections of content items included in the first plurality of collections of content items. In some embodiments, in response to receiving the second input, the electronic device displays the second plurality of representations of the second plurality of collections of content items in a manner similar to the manner in which the electronic device displayed the first plurality of representations of the first plurality of collections of content items. In some embodiments, in response to receiving the second input, the electronic device presents (e.g., plays audio and/or displays image(s) and/or video) a predefined portion of a content item from the second content collection that is not necessarily at the beginning of the content item. Displaying the second plurality of representations of a second plurality of collections of content items based on the second collection of content items in response to detecting the input navigating to the second representation enhances user interactions with the electronic device by providing an efficient way of generating collections of content items of interest to the user, which reduces inputs and user error and reduces power consumption and/or preserves battery life of the electronic device.

In some embodiments, in response to detecting the first input (and/or while generating the first plurality of collections of content items associated with the first media content), the electronic device displays an animation, such as in FIG. 10B.

In some embodiments, in accordance with a determination that the first input includes a first prompt, the animation includes a first characteristic based on the first prompt, such as the animation in FIG. 10B being based on the first media content in response to detecting the input shown in FIG. 10A. In some embodiments, the first prompt is the association of the input with the first media content. In some embodiments, the first prompt is a natural language prompt included in the input. In some embodiments, the characteristic based on the first prompt is a visual characteristic associated with an image (e.g., album, series, and/or content artwork) associated with the first media content, such as colors, shapes, and/or patterns included in the image. In some embodiments, the characteristic based on the first prompt is a visual characteristic that would be described by one or more parts of the first prompt. For example, if the first prompt includes adjectives, the animation includes visual characteristics that would be described by or associated with the adjectives. As another example, if the first prompt includes nouns, the animation includes images of the nouns.

In some embodiments, in accordance with a determination that the first input includes a second prompt different from the first prompt, the animation includes a second characteristic based on the second prompt and different from the first characteristic, such as the animation in FIG. 10K being based on the input provided in FIG. 10J. In some embodiments, the second prompt is the association of the input with respective media content. In some embodiments, the second prompt is a natural language prompt included in the input. In some embodiments, the characteristic based on the second prompt is one of the characteristics described above with reference to the first prompt. Displaying an animation based on a prompt included in the first input in response to receiving the first input enhances user interactions with the electronic device by providing improved feedback to the user, thereby reducing user errors and inputs needed to correct those errors, and reducing power usage and preserving battery life of the electronic device.

In some embodiments, while displaying, via the display generation component, the first representation of the first media content at a first location in a user interface, as optionally described in more detail above, and the first plurality of representations of the first plurality of collections of content items, including a second representation of a second collection of content items at a second location in the user interface, the electronic device receives, via the one or more input devices, a second input directed to the second representation, such as the input including contact 1003c in FIG. 10C and/or the input including contact 1003d in FIG. 10D. In some embodiments, the second input is a navigational input, such as a swipe or other example navigational input listed above, described in more detail above. In some embodiments, the second input is a selection input, such as a tap or other example selection input listed above, described in more detail above. As described below, in some embodiments, the electronic device performs different operations depending on whether the second input is a selection input or a navigation input.

In some embodiments, while displaying, via the display generation component, the first representation of the first media content at a first location in a user interface, as optionally described in more detail above, and the first plurality of representations of the first plurality of collections of content items, including a second representation of a second collection of content items at a second location in the user interface, in response to receiving the second input, in accordance with a determination that the second input is an input navigating to the second representation in the user interface (e.g., the input is a navigation input), such as the input in FIG. 10C including contact 1003c, the electronic device displays, via the display generation component, the second representation at the first location in the user interface, such as artwork 1004a in FIG. 10C. In some embodiments, the electronic device maintains display of the second representation with the natural language describing the relationship between the respective content items included in the second collection of content items. In some embodiments, the electronic device updates the second representation to include content (e.g., an image) associated with a content item included in the second collection of content items (e.g., collection, album, item, and/or series artwork).

In some embodiments, while displaying, via the display generation component, the first representation of the first media content at a first location in a user interface, as optionally described in more detail above, and the first plurality of representations of the first plurality of collections of content items, including a second representation of a second collection of content items at a second location in the user interface, in response to receiving the second input, in accordance with a determination that the second input is an input navigating to the second representation in the user interface (e.g., the input is a navigation input), such as the input in FIG. 10C including contact 1003c, the electronic device displays, via the display generation component, a second plurality of representations of a second plurality of collections of content items based on the second collection of content items, such as representations similar to representations 1004a, 1004c, 1004f, and/or 1004h through 1004j representing collections of content items based on the second collection of content items. In some embodiments, the electronic device displays the second plurality of representations and generates the second plurality of collections of content items based on the second collection of content items as described in more detail above with respect to displaying the second plurality of representations and generating the second plurality of collections of content items based on the second collection of content items in response to detecting the secondary selection input directed to the second representation. In some embodiments, in response to detecting the second input, the electronic device presents second media content included in the second collection of content items. In some embodiments, the electronic device continues to present the first media content in response to receiving the navigation input. In some embodiments, in response to receiving the second input and in accordance with the determination that the second input is the input navigating to the second representation in the user interface, the electronic device displays the second representation at the location in the user interface at which the electronic device had displayed the first representation when the input was received and displays the second plurality of representations of the second plurality of collections of content items based on the second collection of content items as described in more detail above. In some embodiments, in response to receiving the second input and in accordance with the determination that the second input is the input navigating to the second representation in the user interface, the electronic device presents a predefined portion of a content item included in the second collection of content items that is not necessarily at the beginning of the content item. and

In some embodiments, while displaying, via the display generation component, the first representation of the first media content at a first location in a user interface, as optionally described in more detail above, and the first plurality of representations of the first plurality of collections of content items, including a second representation of a second collection of content items at a second location in the user interface, in response to receiving the second input, in accordance with a determination that the second input is an input selecting the second representation (e.g., the second input is a selection input), such as the input shown in FIG. 10D including contact 1003d, the electronic device presents (e.g., outputting audio and/or displaying image(s) and/or video of respective media content) second media content included in the second collection of content items, such as presenting the media content corresponding to the user interface shown in FIG. 10E. In some embodiments, the electronic device ceases presenting the first media content to present the second media content. In some embodiments, in response to detecting the second input and in accordance with the determination that the second input is an input selecting the second representation, the electronic device presents the second media content from the beginning of the second media content.

In some embodiments, while displaying, via the display generation component, the first representation of the first media content at a first location in a user interface, as optionally described in more detail above, and the first plurality of representations of the first plurality of collections of content items, including a second representation of a second collection of content items at a second location in the user interface, in response to receiving the second input, in accordance with a determination that the second input is an input selecting the second representation (e.g., the second input is a selection input), such as the input shown in FIG. 10D including contact 1003d, the electronic device ceases displaying, via the display generation component, the first plurality of representations of the first plurality of collections of content items, such as not displaying representations 1004a, 1004c, 100f, and/or 1004h through 1004j from FIG. 10D in FIG. 10E. In some embodiments, the electronic device ceases displaying the generative content collections user interface in response to detecting the second input.

In some embodiments, while displaying, via the display generation component, the first representation of the first media content at a first location in a user interface, as optionally described in more detail above, and the first plurality of representations of the first plurality of collections of content items, including a second representation of a second collection of content items at a second location in the user interface, in response to receiving the second input, in accordance with a determination that the second input is an input selecting the second representation (e.g., the second input is a selection input), such as the input shown in FIG. 10D including contact 1003d, the electronic device displays, via the display generation component, a user interface (e.g., a content playback user interface as described above) including one or more selectable options that, when selected, cause the electronic device to modify playback of the second media content, such as selectable options 1014, 1016, and/or 1018 in FIG. 10E. In some embodiments, the selectable options that, when selected, cause the electronic device to modify playback of the second media content includes options to play, pause, skip ahead, skip back, and/or adjust the playback volume of the second media content. In some embodiments, the user interface further includes one or more selectable options for performing other operations with respect to the second media content, such as options to share the second media content with another user account, to generate collections of content items based on the second media content, to save the second media content to a content library, and/or to add the second media content to a user-generated collection of content items. In some embodiments, the user interface further includes metadata associated with the second media content, such as an image, a title, an artist, and/or a release year of the second media content. In some embodiments, at the conclusion of presenting the second media content, the electronic device presents another content item from the second collection of content items. Providing efficient ways of generating collections of content items based on the second collection of content items or playing media content from the second collection of content items while displaying a user interface with options to modify playback of the second media content enhances user interactions with the electronic device by reducing the inputs needed to either browse additional collections of content items or to modify playback of the second media content, which reduces user inputs and/or user errors, and additionally reduces power consumption and/or increases battery life of the electronic device.

In some embodiments, detecting the first input and initiating the process to generate the first plurality of collections of content items occurs during a first period of time, such as presenting representations 10043b through 1004g in FIG. 10C.

In some embodiments, during a second period of time different from the first period of time (and before or after detecting the first input), while presenting (e.g., playing audio and/or displaying image(s) and/or video) the first media content, the electronic device, via the one or more input devices, a second input including a request to generate a second plurality of collections of content items associated with the first media content, such as an input similar to the input including contact 1003a in FIG. 10A. In some embodiments, the second input has one or more characteristics of the first input. In some embodiments, the second input is the same as the first input but received at a different time.

In some embodiments, during a second period of time different from the first period of time (and before or after detecting the first input), in response to detecting the second input, the electronic device a process to generate the second plurality of collections of content items, the second plurality of collections of content items different from the first plurality of collections of content items, such as in a manner similar to other manners of generating collections of content items described herein with reference to method 1100, such as presenting representations similar to representations 1004b through 1004g in FIG. 10C. In some embodiments, the second plurality of collections of content items have characteristics in common with the first media content. In some embodiments, the characteristics of the second plurality of collections of content items are the same as the characteristics of the first plurality of collections of content items. In some embodiments, the characteristics of the second plurality of collections of content items are different from the characteristics of the first plurality of collections of content items. In some embodiments, the content items included in the second plurality of collections of content items are different from the content items included in the first plurality of content items. In some embodiments, the generation of the collections of content items based on the first media content is not deterministic. Generating a different plurality of collections of content items in response to receiving the second input enhances user interactions with the electronic device by providing an efficient way of generating additional collections of content items based on the first media content, which reduces the number of user inputs, reduces power consumption and/or preserves battery life of the electronic device.

In some embodiments, in response to detecting the first input, while displaying the first plurality of representations of the first plurality of collections of content items and the first representation of the first media content, the electronic device displays, via the display generation component, a selectable option, such as selectable option 1026 in FIG. 10C. In some embodiments, the selectable option is an option to generate a plurality of collections of content items based on a user-provided prompt, as described in more detail below. In some embodiments, the selectable option includes text and/or an image that indicates that selection of the selectable option will cause the electronic device to initiate a process to generate collections of content items based on a user-provided prompt, such as displaying a user interface for providing the prompt.

In some embodiments, in response to detecting the first input, while displaying the first plurality of representations of the first plurality of collections of content items and the first representation of the first media content, while displaying the selectable option, the electronic device detects a second input directed to the selectable option and one or more inputs providing a prompt, such as the input including contact 1003i in FIG. 10I and/or the input including contact 1003j in FIG. 10J. In some embodiments, the second input is an input selecting the selectable option. In some embodiments, the second input includes touch gestures, air gestures, gaze input, voice input, and/or an input detected using hardware input device(s). In some embodiments, the one or more inputs providing the prompt include text entry inputs, such as typed text (e.g., detected with a hardware keyboard or soft keyboard), handwritten text (e.g., detected with a stylus, touch gesture, and/or air gesture), and/or voice input. In some embodiments, in response to detecting the second input, the electronic device presents a user interface for receiving the prompt, such as a user interface that includes a content entry region and/or a soft keyboard to which the one or more inputs providing the prompt are directed.

In some embodiments, in response to detecting the second input and the one or more inputs providing the prompt, generating a second collection of content items based on the prompt, optionally such as in a manner similar to the manner(s) of generating collection(s) of content items described herein with reference to method 1100, such as shown in FIG. 10L. In some embodiments, generating the second collection of content items includes processing natural language included in the prompt. In some embodiments, the second collection has one or more characteristics included in and/or described by the prompt. In some embodiments, in response to receiving a first prompt, the electronic device generates the second collection of content items. In some embodiments, in response to receiving a second prompt different from the first prompt, the electronic device generates a third collection of content items different from the second collection of content items. Generating a collection of content items based on a user-provided prompt enhances user interactions with the electronic device by reducing the inputs needed to customize a collection of content items, which reduces power consumption and improves battery life of the electronic device.

In some embodiments, in response to (and/or while) detecting the second input and the one or more inputs providing the prompt, the electronic device displays, via the display generation component, an animation having one or more characteristics based on the prompt while generating the second collection of content items, such as a displaying an animation responsive to user inputs in the user interface of FIG. 10J. In some embodiments, the animation having the one or more characteristics associated with the prompt is the same as or similar to the animation based on a content collection generation input described in more detail above. In some embodiments, in response to receiving a first prompt, the electronic device presents a first animation based on the first prompt. In some embodiments, in response to receiving a second prompt different from the first prompt, the electronic device presents a second animation based on the second prompt and different from the first animation. In some embodiments, the electronic device presents portions of the animation while receiving the input including the prompt and changes the animation as the electronic device detects more portions of the prompt. In some embodiments, the electronic device updates the animation to correspond to portions of the prompt as the electronic device detects those portions of the prompt. For example, in response to detecting a first portion of the prompt, the electronic device presents an animation corresponding to the first portion of the prompt and in response to detecting a second portion of the prompt after the first portion, the electronic device updates the animation to correspond to the second portion of the prompt, or to a combination of the first and second portions of the prompt. Presenting the animation based on the prompt provides improved feedback to the user, which reduces user errors and user inputs to correct those errors, thereby reducing power consumption and/or improving battery life of the electronic device.

In some embodiments, in response to detecting the second input and the one or more inputs providing the prompt, the electronic device displays, via the display generation component, a summary of the prompt while generating the second collection of content items, such as summary 1050 in FIG. 10K. In some embodiments, the summary includes paraphrasing the prompt. In some embodiments, the summary includes presenting some portions of the prompt while omitting other portions of the prompt. In some embodiments, in response to receiving a first prompt, the electronic device presents a first summary based on the first prompt. In some embodiments, in response to receiving a second prompt different from the first prompt, the electronic device presents a summary animation based on the second prompt and different from the first summary. In some embodiments, the electronic device generates the summary of the prompt using AI and/or ML techniques. Presenting the summary of the prompt provides improved feedback to the user, which reduces user errors and user inputs to correct those errors, thereby reducing power consumption and/or improving battery life of the electronic device.

In some embodiments, in response to detecting the second input and the one or more inputs providing the prompt, the electronic device concurrently presents (e.g., playing audio and/or displaying image(s) and/or video) a respective content item included in the second collection of content items and displays, via the display generation component, content including information related to the prompt, such as presenting the content item in FIG. 10L and displaying information 1054 in FIG. 10L. In some embodiments, the electronic device displays the content including the information related to the prompt in a user interface for controlling presentation of media content that includes one or more options for modifying playback of the media content, information about the media content, and/or one or more options for performing other actions related to the media content, as described above. In some embodiments, the information related to the prompt is the same as the summary of the prompt. In some embodiments, the information related to the prompt is different from the summary of the prompt. In some embodiments, the information related to the prompt is factual information about one or more portions of the prompt. In some embodiments, the electronic device presents the information related to the prompt and the content item included in the second collection after presenting the animation described above. In some embodiments, the electronic device presents a predefined portion of the respective content item that is not necessarily at the beginning of the respective content item, as described above. Presenting the content item from the second collection and the information about the second collection enhances user interactions with the electronic device by reducing the inputs needed to play the generated collection of content items and view information about the prompt, thereby reducing power consumption and/or improving battery life of the electronic device.

In some embodiments, the content including information related to the prompt includes information about the respective content item included in the second collection of content items, such as information 1054 in FIG. 10L. In some embodiments, the information includes metadata of the respective content item, such as artist, album and/or year of release. In some embodiments, the information includes the generated name of the second collection of content items. In some embodiments, the information explains why the respective content item relates to the prompt. In some embodiments, the information includes an image corresponding to the collection of content items. In some embodiments, in response to detecting selection of the information, the electronic device displays a user interface including representations of content items included in the collection of content items and one or more selectable options that, when selected, causes the electronic device to perform respective action(s) with respect to the collection of content items. Presenting the information about the respective content item enhances user interactions with the electronic device by reducing the inputs needed to view information about the respective content item, thereby reducing power consumption and/or improving battery life of the electronic device.

In some embodiments, while displaying the first plurality of representations of the first plurality of collections of content items, the electronic device detects, via the one or more input devices, a second input corresponding to a request to present content from a respective collection of content items included in the first plurality of collections of content items, such as the input with contact 1003d in FIG. 10D. In some embodiments, the second input is a selection input or a navigation input as described in more detail above.

In some embodiments, in response to detecting the second input, the electronic device presents (e.g., playing audio and/or displaying image(s) and/or video) content from the respective collection of content items, such as presenting the content shown in FIG. 10E. In some embodiments, in response to detecting the second input, the electronic device updates the display in one or more of the ways described above, such as displaying a representation of the respective collection of content items at a location in the user interface at which the representation of the first collection of content items had been displayed, displaying a user interface for modifying playback of the media content being played, and/or updating the generative content item collections user interface to include representations of collections of content items based on the respective collection of content items.

In some embodiments, after presenting (e.g., playing audio and/or displaying image(s) and/or video) content from the respective collection of content items, the electronic device displays, via the display generation component, a user interface of a content application associated with the first media content and the respective collection of content items that includes representations of previously-presented content items including a representation of the respective collection of content items, such as representations 1030a through 1030d in FIG. 10F. In some embodiments, the electronic device displays the user interface of the content application in response to receiving a sequence of one or more inputs navigating to the user interface, including inputs selecting navigation options included in other user interfaces of the content application. In some embodiments, the representations of previously-presented content items include representations of individual content items and/or representations of collections of content items (e.g., albums, series, user-generated playlists, and/or generative playlists). In some embodiments, in response to detecting selection of the representation of the respective collection of content items, the electronic device presents a user interface including representations of the content items included in the respective collection of content items. In some embodiments, if the respective collection of content items is not currently in the content library, the user interface includes a selectable option that, when selected, causes the electronic device to add the respective collection of content items to the content library. In some embodiments, while the respective collection of content items is included in the content library, a user interface including representations of collections of content items included in the content library includes a representation of the respective collection of content items. In some embodiments, the electronic device does not display a representation of the respective collection of content items (or representations of other generative playlists) in the user interface of the content application with representations of recently-played media content unless and until the electronic device plays the respective collection of content items, such as in response to detecting an input requesting playback of the respective collection of content items. Presenting a representation of the respective collection of content items in the user interface for the content application after playing a content item from the respective collection of content items enhances user interactions with the electronic device by reducing the inputs needed to play the respective collection of content items again, which improves power consumption and/or battery life of the electronic device.

It should be understood that the particular order in which the operations in FIG. 11 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method(s) 700 and/or 900) are also applicable in an analogous manner to method 1100 described above with respect to FIG. 11. For example, the operation of generating collections of content items described above with reference to method 1100 optionally has one or more of the characteristics of presenting transition effects and/or displaying search user interfaces described herein with reference to other methods described herein (e.g., method(s) 700 and/or 900). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 11 are, optionally, implemented by components depicted in FIGS. 1A-1B. For example, detecting operation 1102 and displaying operation 1104 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is tracking and displaying content. The present disclosure contemplates that in some instances, the data utilized may include personal information data that uniquely identifies or can be used to contact or locate a specific person. Such personal information data can include demographic data, event data, content consumption activity, location-based data, telephone numbers, email addresses, twitter ID's, home addresses, data relating to a person's likeness, name, date of birth, or any other identifying or personal information.

The present disclosure recognizes that the use of such personal information data, in the present technology, can be used to the benefit of users. For example, using information based upon interaction patterns with a media player. Accordingly, use of such personal information data enables users to use electronic devices to perform enhanced operations with viewing items corresponding to their content libraries. Further, other uses for personal information data that benefit the user are also contemplated by the present disclosure. For instance, presenting customized collections of content items based upon the user's preferences.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device optionally collections of content items without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with one or more input devices and a display:
playing first media content;
while playing the first media content, and in accordance with a determination that a playhead position that corresponds to the first media content is within a threshold amount of time of an end of the first media content, initiating presenting of a transition effect from the first media content to second media content, different from the first media content, wherein:
in accordance with a determination that the second media content has one or more first characteristics, a duration of the transition effect is a first amount of time; and
in accordance with a determination that the second media content has one or more second characteristics, different from the one or more first characteristics, the duration is a second amount of time, different from the first amount of time.

2. The method of claim 1, wherein the transition effect is initiated before the playhead position passes a pivot point in the first media content, wherein the pivot point corresponds to a position relative to the first media content that is after the transition effect is scheduled to begin and before the end of the first media content.

3. The method of claim 1, further comprising:
displaying, via the display, a scrubber bar for controlling playback of respective media content, wherein the scrubber bar is displayed while presenting the transition effect;
while presenting the transition effect and while presenting the first media content, detecting, via the one or more input devices, input directed to the scrubber bar for changing the playhead position; and
in response to detecting the input directed to the scrubber bar, in accordance with a determination that the scrubber bar corresponds to the second media content, presenting the second media content, wherein the playhead position relative to the second media content is based on the input directed to the scrubber bar.

4. The method of claim 1, wherein the second media content is selected for the transition effect based on respective characteristics of the first media content and the second media content.

5. The method of claim 1, wherein a time that presentation of the transition effect is initiated relative to the duration of the second media content is based on the duration of the first media content or the duration of the second media content.

6. The method of claim 1, further comprising:
displaying, via the display, lyrics corresponding to the first media content, wherein the lyrics are displayed when the transition effect is initiated, and wherein,
presenting the second media content includes displaying, via the display, a representation of artwork associated with the second media content.

7. The method of claim 6, wherein a scale of the lyrics corresponding to the first media content is maintained during the transition effect.

8. The method of claim 1, the method further comprising:
while presenting the media content, displaying, via the display, a selectable option that is selectable to enable a shuffle mode of an order of queued media content, wherein the transition effect is associated with a transition effect mode associated with an auditory transition between respective first media content and respective second media content that is different from the order of the queued media content determine based on the shuffle mode.

9. The method of claim 1, wherein the threshold amount of time is based on respective characteristics of the first media content and the second media content.

10. A non-transitory computer readable storage medium storing one or more programs, the one or more programs comprising instructions, which when executed by one or more processors of an electronic device that is in communication with one or more input devices and a display, cause the electronic device to perform a method comprising:
playing first media content;
while playing the first media content, and in accordance with a determination that a playhead position that corresponds to the first media content is within a threshold amount of time of an end of the first media content, initiating presenting of a transition effect from the first media content to second media content, different from the first media content, wherein:
in accordance with a determination that the second media content has one or more first characteristics, a duration of the transition effect is a first amount of time; and
in accordance with a determination that the second media content has one or more second characteristics, different from the one or more first characteristics, the duration is a second amount of time, different from the first amount of time.

11. An electronic device that is in communication with a display and one or more input devices, the electronic device comprising:
one or more processors;
memory; and
one or more programs, wherein the one or more programs are stored in the memory and configured to be executed by the one or more processors, the one or more programs including instructions for:
playing first media content;
while playing the first media content, and in accordance with a determination that a playhead position that corresponds to the first media content is within a threshold amount of time of an end of the first media content, initiating presenting of a transition effect from the first media content to second media content, different from the first media content, wherein:
in accordance with a determination that the second media content has one or more first characteristics, a duration of the transition effect is a first amount of time; and
in accordance with a determination that the second media content has one or more second characteristics, different from the one or more first characteristics, the duration is a second amount of time, different from the first amount of time.
